(19) United States
(12) Patent Application Publication
(10) Pub. No.: US 2025/0278814 A1
(43) Pub. Date: Sep. 4, 2025

(54) Methods and Systems for Super-Resolution Imaging Using Point Spread Function Modulation

(71) Applicant: The University of Toledo, Toledo, OH (US)

(72) Inventor: Jian-Yu Lu, Toledo, OH (US)

(73) Assignee: The University of Toledo, Toledo, OH (US)

(21) Appl. No.: 19/066,291

(22) Filed: Feb. 28, 2025

Related U.S. Application Data
(60) Provisional application No. 63/560,033, filed on Mar. 1, 2024.

(51) Int. Cl. G06T 3/4053

(52) U.S. Cl. CPC G06T 3/4053

(57) ABSTRACT

Methods and system for obtaining super-resolution images involving point spread function (PSF) modulation are described.

### RELATED APPLICATIONS

This application claims priority to U.S. Provisional Application No. 63/560,033 filed under 35 U.S.C. § 111(b) on Mar. 1, 2024, the disclosure of which is incorporated herein by reference in its entirety.

### STATEMENT REGARDING FEDERALLY SPONSORED RESEARCH

This invention was made with no government support. The government has no rights in this invention.

### BACKGROUND

High spatial image resolution is desired in many wave-related areas such as ultrasound, acoustics, optics, and electromagnetics. However, the spatial resolution of a linear shift invariant (LSI) imaging system is limited by the highest spatial frequency of the point spread function (PSF) of the system due to wave diffraction. Methods for increasing image resolutions beyond the diffraction limit, i.e., super-resolution, have been studied in various areas such as astronomy, electromagnetics (radar and time reversal imaging), underwater acoustics (sonar), acoustics, optics, and ultrasound.

In optics, many methods have been developed to improve image resolutions. To improve image axial resolution (along the optical axis), confocal imaging (both illumination and detection are focused on the same spot), 4 pi imaging (an object is illuminated by focused lights from opposite directions and also detected from these directions), spatially modulated illumination (SMI) microscopy (creating a standing wave between two objectives to measure the positions of isolated point objects at a resolution better than a half wavelength), and spectral precision distance microscopy (SPDM) (a variant of SMI by adding spectral information) can be used. To obtain a super-resolution in the lateral direction (perpendicular to the optical axis), a number of techniques have been developed. Near-field scanning optical microscopy (NSOM) is a technique where the detector is placed close to the object to catch the evanescent waves. Metamaterials such as a hyperlens are used to capture the evanescent waves by placing the object to be imaged close to the materials. Structured illumination microscopy (SIM) uses different patterns of the light to illuminate an object either in far field (increase resolution by 2 folds) or near field (can increase the resolution much more). The SIM can also be applied to thermal imaging. Stimulated emission depletion (STED) is a fluorescent imaging technique that uses a probing beam to excite the molecules to fluoresce and then a STED beam is applied to deplete the out ring of the fluorescence, leaving a very small center part of the fluorescence to form a super-resolution image. A similar method is called ground state depletion (GSD), which lowers light intensity and thus has less photo bleaching effects to the objects to be imaged. Another method that is an inverse of the STED uses photobleaching to suppress the center area of the heating of the optical beam and then uses subtraction to get an equivalent localized heating that is detected by a high-frequency ultrasound (40 MHz) (photoacoustics) without resorting to fluorescence to get super-resolution in both lateral and axial directions (the resolution improvement depends on the photobleaching characteristics of the object to be imaged). Single molecule localization microscopy (SMLM) represents a group of techniques using different ways to induce a stochastic emission of the fluorophores so that images can be formed by accumulating different sets of localized molecules obtained at a different time. This includes photoactivated localization microscopy (PALM) (using proteins that are photoactivatable, photoconvertible, or photoswitchable), points accumulation for imaging in nanoscale topography (PAINT) (using reversibly-binding fluorescent agents), and stochastic optical reconstruction microscopy (STORM) (using fluorescent organic dyes with a specific buffer). Another way to localize molecules is to use the super-resolution optical fluctuation imaging (SOFI), where the image is obtained by analyzing the statistics of the temporal fluctuations of a series of images. The principle of SMLM can also be applied to imaging that does not need fluorescence.

In ultrasound and acoustics, there is a long history for improving image resolutions, such as obtaining super-resolution images in the axial direction and increasing image resolutions using a high frequency. In addition to some ultrasound-specific methods, many of the techniques developed in optics above for super-resolution imaging have been adapted to ultrasound. This includes near-field imaging; metamaterials (superlens and time reversal); vortex beams; SIM in photoacoustics and acoustics; nonlinear processing, multiple scattering imaging; and ultrasound localization microscopy (ULM) that is similar to the PALM but using microbubbles, using lasers for photothermal imaging, and using phase-change perfluorocarbon nanodroplets for cell imaging.

There remains a need in the art for new and improved systems and methods for obtaining super-resolution images.

### SUMMARY

Further provided is a method of obtaining a super-resolution image of an object, the method comprising increasing bandwidth of the point spread function by multiplying the point spread function by a modulation function that has a wider bandwidth than the point spread function, wherein the modulation function is created by modulating amplitude or phase, or both amplitude and phase of a source wave used to image the object so as to obtain a super-resolution image of the object.

Further provided is a method of obtaining a super-resolution image of an object, the method comprising modulating characteristics of a wave from an imaging system so as to influence the point spread function of the imaging system, obtaining images of an object with the wave and with a non-modulated wave from the imaging system, and processing the obtained images to obtain a super-resolution image of the object.

Further provided is a method for obtaining an image of an object, the method comprising obtaining a first image of an object with waves; obtaining a second image of the object with waves while the point spread function is modulated relative to the first image through either amplitude modulation or phase modulation or both; and subtracting elements of the first image from elements of the second image to obtain a third image of the object, wherein the third image has a higher resolution than either of the first image or the second image. In certain embodiments, the waves are ultrasound waves.

Further provided is a method for obtaining a super-resolution image of an object, the method comprising capturing a first image of an object without modulating the point spread function (PSF); capturing a second image of the object with modulation of the PSF; and subtracting features of the second image from the first image to obtain a super-resolution image of the object.

Further provided is a method of producing super-resolution imaging using a pulse-echo system, the method comprising using a transducer to produce and send a first beam toward an object; receiving the beam through the transducer providing a first set of data regarding the object; using the transducer to produce and send a second beam toward the object with a modulator in a position relative to the object; receiving the second beam through the transducer providing a second set of data regarding the object; then the first set of data are subtracted from the second set of data, wherein reflections or backscattering of the modulator are removed from the resulting set of data.

Further provided is a method of producing super-resolution imaging using a wave source/field imaging system, the method comprising using a transducer to produce a wave source/field that is received by another transducer to provide a first set of data regarding the object; using the first transducer to produce another wave source/field with a modulator in a position relative to the transducer; receiving the second wave source/field with the second transducer to provide a second set of data; then the first set of data are subtracted from the second set of data, wherein reflections or scattering of the modulator, if there are any, are removed from the resulting set of data.

Further provided is an imaging system comprising a camera, an illumination wave source, and a point spread function (PSF) modulator on or inside the object, wherein the PSF modulator is configured to scan over an object while the camera and the object are fixed in space. In certain embodiments, the PSF modulator comprises a photoacoustic generator, an optical radiation pressure generator, an ultrasound radiation pressure generator, a wave attenuating and/or phase shifting material, a wave absorbing and/or phase shifting material with a small area that allows wave to pass, a quantum dot, a vesicle that producing bursting sound, a fluorescent light, a spatial light modulator (SLM), or a diffractive optical element (DOE). In certain embodiments, the PSF modulator is configured to move by a mechanical force, electrical force, magnetic force, electromagnetic force, or by a radiation force. In certain embodiments, the PSF modulator is movable with the spherically focused wave. In certain embodiments, multiple sparsely distributed modulators are used to speed up the imaging process, wherein the sparse means the distance between any two modulators is larger than the dimension of the resolution cell of the imaging system. In certain embodiments, the multiple modulators are randomly distributed.

Further provided is an imaging system that is linear shift invariant (LSI), where the image is a convolution of the PSF with the object; the first image is reconstructed from the first set of data; the second image is reconstructed from the second set of data where the modulators are introduced into the object; and the super-resolution image is produced by subtracting the second image from the first. In certain embodiments, the LSI system is a magnetic resonance imaging (MRI) system. In certain embodiments, the center positions of the sparsely-distributed modulators are located from the subtracted image and the value at the center position of each modulator is obtained by integrating the values of the subtracted image over the area of the resolution cell of the imaging system (reducing noise) or by directly assigning the value of the subtracted image without an integration. The values at the center positions of the modulators are a subset of pixels of the super-resolution image. A complete set of pixels of the super-resolution image can be obtained by moving the sparsely-distributed modulators over, around, or inside the object to be imaged multiple times to form the final super-resolution image.

In short, a super-resolution image of a passive object or a wave source/field is produced by introducing modulator(s) that can change the amplitude, the phase, or both the amplitude and phase of the original PSF of an imaging system that uses a beam scanning to form an image (such as ultrasound B-mode imaging and scanning optical microscopy), or that is a camera to produce an image (such as photographic camera or bright-field optical microscope), or that is a holographic imaging system to form an image (such as lensless in-line digital holographic imaging), or that uses a fixed illumination wave in space (such as the PSF-weighted super-resolution imaging method) to form an image, or that is a linear shift invariant system that may or may not use a wave (such as MRI) to form an image.

Further provided is a method for obtaining a super-resolution image of an object that is either a passive physical object or a wave object, the method comprising capturing a first image of an object with an imaging system without modulating a point spread function (PSF) of the imaging system unless all signals captured for the first image are zero; capturing a second image of the object with the imaging system while the PSF of the imaging system is modulated relative to the first image through amplitude modulation, phase modulation, or both amplitude and phase modulations; subtracting elements of the second image from elements of the first image to obtain one or more pixels of a third image of the object by localizing a center of a modulator from the subtracted image if the modulator positions are not already known, and obtaining values of the pixels of the third image with or without an integration of the subtracted image over a PSF-defined resolution cell of the imaging system corresponding to the position of the modulator, wherein the third image has a higher resolution than the first image, the second image, or both the first and second images; and moving the modulator over, around, or inside the object to different positions, and repeating the capturing and subtracting steps after each movement to obtain all pixels of the third image of the object.

In certain embodiments, the imaging system is a linear shift-invariant (LSI) system or an approximate LSI system, wherein the imaging system may or may not involve a wave.

In certain embodiments, the imaging system is a photographic camera, a cellular phone camera, a laboratory microscope, a mobile microscope, a holographic imaging system, an in-line lens-less digital holographic imaging system, a capsule endoscopic camera, an endoscope, an optical coherence tomography (OCT), an optical wave mapping system, an acoustical imaging system, an ultrasound imaging system, an acoustical camera, a photoacoustic imaging system, an imaging system based on electromagnetic wave heating, a thermal imaging system, an acoustical or ultrasound wave mapping system, a non-destructive evaluation (NDE) imaging system, a sonar system, an X-ray radiography system, an X-ray fluoroscopy system, an X-ray CT system, a nuclear medicine imaging system, a gamma camera, a single-photon emission computerized tomography (SPECT) system, a positron emission tomography (PET) system, a magnetic resonance imaging (MRI) system, a terahertz imaging system, a radar system, a lidar system, an electromagnetic wave mapping system, a scanning electron microscope, a transmission electron microscope, or a PSF-weighted imaging system.

In certain embodiments, the third image is a two-dimensional (2D), three-dimensional (3D), or four-dimensional (4D) image, wherein the fourth dimension is time.

In certain embodiments, the method comprises multiplying the PSF with a modulation function that has a wider bandwidth or a higher spatial frequency than the PSF.

In certain embodiments, the PSF is modulated with a modulator having a high spatial frequency. In particular embodiments, the modulator is a shear wave, a phase shifter, a physical particle, or a small object. In particular embodiments, the modulator comprises a nanoparticle with a polymer coating.

In certain embodiments, the method comprises multiplying the PSF with a modulation function that has a wider bandwidth or a higher spatial frequency than the PSF. In particular embodiments, the modulator is a shear wave, a phase shifter, or a physical particle. In particular embodiments, the modulator comprises a shear wave, a phase shifter, a metal bead, a lead bead, a tungsten bead, a gold bead, a glass bead, an encapsulated iodine bead, a polymer bead, a magnetic particle, a nanoparticle, a nanoparticle with a polymer coating, a perfluorocarbon (PFC) nanodroplet, a microbubble, a nanobubble, a quantum dot, a gas vesicle that produces a bursting sound, a fluorophore that produces a fluorescent light, a spatial light modulator (SLM), a diffractive optical element (DOE), a molecule, an atom, an ion, an electron, a semiconductor P-N junction, or a particle or small object, wherein the modulator is configured to move by a mechanical force, electrical force, magnetic force, electromagnetic force, or a radiation force. In particular embodiments, multiple modulators are sparsely distributed with a distance between any two modulators larger than the PSF-defined resolution cell of the imaging system.

Further provided is a method of producing super-resolution imaging using a pulse-echo system, the method comprising using a transducer, a sound wave source, a mechanical wave source, an electromagnetic antenna, an optical pulse source, or an optical wave source of a short optical coherence length to produce and send a first beam toward an object; receiving the beam through the transducer, electromagnetic antenna, or an optical detector, where a reference beam may or may not be used, providing a first set of data regarding the object; using the transducer, sound wave source, mechanical wave source, electromagnetic antenna, optical pulse source, or optical wave source of a short optical coherence length to produce and send a second beam toward the object, and the second beam is modified by a modulator; receiving the second beam through the transducer, electromagnetic antenna, or optical detector, where the reference beam may or may not be used, providing a second set of data regarding the object, and the received second beam also is modified by the modulator; subtracting the second set of data from the first set of data to produce a pixel of a super-resolution image, and moving (scanning) the first beam and the second beam along with the modulator point-by-point over, around, or inside the object to different position(s), and repeating the process above after each movement to obtain a 2D, 3D, or 4D super-resolution image of the object.

In certain embodiments, the modulator produces amplitude modulation, phase modulation, or both phase and amplitude modulations to the point spread function (PSF).

In certain embodiments, the modulator is a shear wave, a phase shifter, a physical particle, a microbubble, a nanobubble, or a small object. In certain embodiments, the modulator comprises a nanoparticle with a polymer coating.

In certain embodiments, the pulse-echo system is an acoustical imaging system, ultrasound imaging system, a non-destructive evaluation (NDE) imaging system, a sonar system, a terahertz imaging system, a radar system, a lidar system, or an optical coherence tomography (OCT).

In certain embodiments, the transducer, sound wave source, mechanical wave source, electromagnetic antenna, the optical pulse source, optical wave source of a short optical coherence length, or optical detector comprises multiple elements.

In certain embodiments, the beams and the modulator are moved, scanned, or steered electronically, electromagnetically, magnetically, mechanically, or by a radiation force.

Further provided is system for obtaining a super-resolution image of a wave field, the system comprising a transducer, a sound wave source, a mechanical wave source, an electromagnetic wave source, or an optical wave source configured to emit waves or configured to illuminate an object; a camera or a wave receiver configured to produce a first signal by collecting the waves emitted, and/or the waves scattered or reflected from the object unless the signal obtained is zero; and a point spread function (PSF) modulator configured to modulate a PSF of the wave receiver to produce a second signal; wherein subtracting the second signal from the first signal can produce a pixel of a super-resolution image of the emitted wave, and/or the scattered or reflected waves of the object; and wherein moving or scanning the beam of the wave receiver along with the modulator point-by-point over, around, or inside the object, or inside the wave emitted, and repeating the process after each movement can produce a 2D, 3D, or 4D super-resolution image of the emitted wave, and/or the scattered or reflected waves of the object.

In certain embodiments, the modulator produces amplitude change to the PSF, phase change to the PSF, or both amplitude and phase changes to the PSF.

In certain embodiments, the modulator is a phase shifter, a physical particle, a microbubble, a nanobubble, or a small object.

In certain embodiments, the modulator is configured to move by a mechanical force, electrical force, magnetic force, electromagnetic force, or a radiation force.

In certain embodiments, the system comprises multiple modulators to speed up the imaging process.

In certain embodiments, the system is an ultrasound wave generator, a scanning ultrasound imaging system, an acoustical wave generator, a scanning acoustic wave imaging system, a photoacoustic imaging system, an imaging system based on electromagnetic wave heating, a thermal imaging system, an electromagnetic wave generator, a scanning electromagnetic wave imaging system, an optical wave generator, a scanning optical imaging system, or a scanning electron microscope.

In certain embodiments, the wave source and/or wave receiver comprises single or multiple elements.

In certain embodiments, the receiver beam and the modulator are configured to be moved, scanned, or steered electronically, electromagnetically, magnetically, mechanically, or by a radiation force.

In certain embodiments, the modulator comprises a metal bead or nanoparticle. In certain embodiments, the modulator comprises a magnetic nanoparticle. In certain embodiments, the modulator comprises a nanoparticle with a polymer coating.

In certain embodiments, the system further comprises an electromagnetic agitator configured to manipulate movement of magnetic nanoparticles.

Further provided is the use of PSF modulation to obtain a super-resolution image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: Imaging systems with modulation of the point spread function (PSF). On the left is shown modulation of the PSF of an imaging system that uses a spherically focused wave (such as an ultrasound, optical, or electromagnetic wave) for four-dimensional (4D) super-resolution imaging. The modulation is on the wave propagation axis, z, and is centered at the focal distance F. On the right is shown a camera imaging system with a modulator on the object plane. The image A′B′ is formed on the image plane with an object AB (arrow) on the object plane. The camera and object are fixed in space while the modulator is scanned over the object plane to obtain a super-resolution image.

FIG. 2: Block diagram of the experiments. On the left is a photo of the water tank, a transducer, a modulator, and an object. The transducer and the modulator were mounted on one axis, and the object was on another that can be moved in the x-y plane by motors. On the right is a block diagram of the imaging system. One cycle (pulse) of a 1-MHz sine-wave signal from the power amplifier was used to drive either the transducer (pulse-echo imaging) or a wave source (one-way imaging). The received signals were filtered by a band-pass filter of 1-MHz center frequency and a −6 dB fractional bandwidth of 33% before being digitized at 20 MegaSamples/s and a 12-bit resolution.

FIG. 3: Two-way (pulse-echo) C-mode imaging of a point object. (a) shows a photo of the modulator (a piece of copper wire of 0.5 mm in diameter and about 1 mm in length) glued on the cross of two perpendicular copper wires (about 85 μm in diameter) that were mounted on a copper ring of 38.1-mm inner diameter. (b) and (c) are simulated images of the point object with and without the modulator, respectively. In the simulations, the point object was a geometric point without a physical dimension, the transducer was driven by a 1-MHz continuous wave (CW) signal, and the modulator was an infinitely-thin 0.5-mm diameter disc at the center of the focal plane of the transducer and had a 100% amplitude modulation. Other parameters of the simulations are in the figure. (d) shows a super-resolution image reconstructed from (b) and (c). (e) shows a photo of the 1-MHz transducer focused with an acoustic lens, the modulator, and a point object. (f), (g), and (h) are images corresponding to (b), (c), and (d), respectively, and were obtained using the experiment system in FIG. 2. In the experiments, the point object was a stainless steel wire of about 250 m in diameter and 6 mm in length, and the distance between the modulator and the point object was about 0.5 mm. The grayscale bar represents the normalized magnitude of sound pressure received.

FIG. 4: Horizontal line plots through the center of the images in FIG. 3, (c)-(d) and (g)-(h). The solid (black) and the dotted (blue) lines are through the center of the experimentally-obtained images in FIG. 3, (h) (super-resolution) and FIG. 3, (g) (diffraction-limited), respectively. The dash-dotted (red) and the dashed (pink) lines are through the center of the simulated images in FIG. 3, (d) (super-resolution) and FIG. 3, (c) (diffraction-limited), respectively. The full-width-at-half-maximum (FWHM) resolutions measured from the line plots are given in the figure.

FIG. 5: These images are the same as in FIG. 3, (a)-(h), except that an L-shaped object consisting of 11 points was imaged. FIG. 5, (a) shows dimensions of the L-shaped object. FIG. 5, (b)-(d) show simulated images corresponding to FIG. 3, (b)-(d), respectively. FIG. 5, (e) shows a photo of the L-shaped object used in the experiments. FIG. 5, (f)-(h) show experimental results corresponding to FIG. 5, (b)-(d), respectively.

FIG. 6: Experimentally obtained one-way C-mode images of a wave source/field produced by a 48-element ultrasound linear array transducer that was driven by the 1-cycle sine wave (pulse) of 1 MHz in alternating phases (180° phase difference) for every two elements (i.e., ++−−++−− . . . ++−−++−−). The modulator was about 0.5 mm away from the surface of the array and the array does not have a front matching layer. The spherically focused transducer in FIG. 2 was used as a receiver. FIG. 6, (a) shows a photo of the linear array (indicated by the arrow) mounted on a clamp. FIG. 6, (b) shows the dimensions of the array. FIG. 6, (c) shows a photo of the front surface of the array. FIG. 6, (d)-(e) are C-mode images of the ultrasound wave produced by the array with and without the modulator, respectively. FIG. 6, (f) shows a super-resolution image reconstructed from FIG. 6, (d), and FIG. 6, (e). The grayscale bar represents the normalized magnitude of sound pressure.

FIG. 7: These images are the same as FIG. 6, (a)-(f), except that a patterned transducer was used. FIG. 7, (a) shows a photo of the patterned transducer mounted on a clamp. FIG. 7, (b) shows dimensions of the pattern of the back electrode of the transducer. FIG. 7, (c) shows dimensions of the pattern of the front electrode. The outer ring in FIG. 7, (b), and the front electrode were connected to the ground (GND), which reduced the effective aperture of the transducer to 22.2 mm. The line spacing (between inner edges of adjacent lines) of the pattern in FIG. 7, (c), in both horizontal and vertical groups were 4, 2, 1, 0.5, and 0.25 mm, respectively, and the line width of each line was 0.25 mm. FIG. 7, (d), and FIG. 7, (e), are images obtained with and without the modulator, and FIG. 7, (f), is the super-resolution image reconstructed from FIG. 7, (d), and FIG. 7, (e). The lines separated by 0.5 mm can be clearly seen in FIG. 7, (f), indicating that the resolution was about 0.5 mm.

FIG. 8: These images are the same as the simulation portion of FIGS. 3 and 5 except that the phase modulation in Eq. (19) was used, where ϕ₀=π/10 and α=0.25 mm. FIG. 8, (a)-(c), are images corresponding to those in FIG. 3, (b)-(d), respectively. The small inserts in both FIG. 8, (a), and FIG. 8, (b), are real (left) and imaginary (right) parts of the images. FIG. 8, (d)-(f), are images corresponding to those in FIG. 5, (b)-(d), respectively.

FIG. 9: This figure is the same as FIG. 1 (left) except that the modulator will produce a phase modulation. A cylindrical ring of shear wave can be produced by a radiation force that is produced by a focused Bessel beam or X wave. The shear wave can focus on the z axis to modulate the phase of the PSF of the imaging system to produce a 2D or 3D super-resolution image.

FIG. 10: Images demonstrating ultrasound super-resolution C-mode imaging.

FIG. 11: Setups for mapping pulse ultrasound wave fields (the transmitter was scanned along the x-axis) experimentally in water (speed of sound c=1500 m/s) across the center of the focus of an ultrasound transmitter (the TX transducer with 25.4-mm diameter aperture, 2.25-MHz center frequency, about 61%−6 dB relative pulse-echo bandwidth, and an f-number of 1.3) using the PSF-modulation super-resolution imaging method. The modulator (see FIG. 12, (a)) was a small glass bead (0.7 mm diameter) attached to a holder and was fixed with and placed at the focal point of the receiver (the RX transducer that has the same parameters as the transmitter, except that f-number=1.93). An object can be placed at the focal point of the transmitter. In addition to the wire object in FIG. 12, (b), other objects such as biological soft tissues can be used. The setups were also used to map a pulse Bessel beam using the super-resolution method, where the focused transmitter was replaced with a Bessel transducer that was placed about 0.5 mm from the modulator. (a) in FIG. 11 shows an experiment setup where the axial axis of the receiver (the RX transducer on the left) was in parallel with that of the transmitter (the RX transducer on the right), i.e., θ=0°. (b) shows a photo of the setup corresponding to (a) in a water tank. (c) and (d) are the same as (a) and (b), respectively, except that the receiver was rotated by θ=450 from the axial axis of the transmitter while the modulator was in parallel.

FIG. 12: Photos of (a) a glass bead and (b) a wire object. The glass bead had a diameter of 0.7 mm. It was attached to one end of a glass rod of about 0.127 mm in diameter and about 10 mm in length. The other end of the glass rod was glued to the tip of a tapered steel bar that had a diameter of about 5.08 mm (the steel bar was coated with white epoxy to be water resistant). The wire object contained 4 nylon wires of about 0.28 mm in diameter. The distances between the four wires were about 0.508 mm, 1.016 mm, and 1.524 mm, respectively, as shown in the figure. This wire object was used to introduce high spatial frequency components in the ultrasound wave field to be mapped.

FIG. 13: Black diagram of the experiments described in Example II herein. A focused transmitter (TX transducer on the right-hand side of the water tank with a focal length of F1) produced a pulse ultrasound wave field in water. The wave field at the focal distance of the transmitter was received by a focused receiver with a focal length of F2 (the receiver or the RX transducer on the left-hand side of the water tank). To map the wave field at the focal distance of the transmitter, the transmitter was moved (scanned) along the x axis in multiple equal-distance steps across the center of transmitter focus. At each step, an unsynchronized trigger signal was produced from the motor unit and sent to the digitizer unit that produced another trigger signal synchronized to the clock of the digitizer. The synchronized trigger was used to trigger the pulse generator to produce a 1-cycle electrical sine signal that was amplified to drive the transmitter to produce an ultrasound signal. The ultrasound signal was received to produce an electrical signal that was amplified, filtered, digitized, and then stored on a hard disk. To obtain a super-resolution mapping of the pulse ultrasound wave field at the focal distance of the transmitter, a modulator consisting of a small glass bead was placed at the focal point of the receiver. To show the versatility of the method for a super-resolution mapping of pulse ultrasound wave field, a wire object was placed at the focus of the transmitter to disturb the wave field (in addition to the wire object in FIG. 12, (b), other objects such as a biological soft tissue can be used).

FIG. 14: Super-resolution mapping of a pulse ultrasound wave field without an object (FIG. 11, (a)). (a) shows a focused pulse ultrasound wave field mapped experimentally in water without a modulator using a broadband focused PZT transducer (the RX transducer in FIG. 11). The pulse ultrasound wave field was produced by another PZT transducer (the TX transducer in FIG. 11) that was electrically driven by a 1-cycle sine signal. The pulse wave field at the transmit focal distance was mapped by scanning the TX transducer along the x-axis for 25 mm and the signals received were digitized for 10.24 μs. The analytic envelope of the pulse wave field was obtained and normalized to its maximum. The color bar on the right indicates normalized magnitude. (b) is the same as (a) except that the modulator was added (see in FIG. 11, (a)). (c) shows the resulting super-resolution mapping of the pulse ultrasound wave field by subtracting (b) from (a). (d), (e), and (f) are the same as (a), (b), and (c), respectively, except that the RX transducer and the modulator were rotated θ=45° from the axial axis of the TX transducer (see FIG. 11, (c)). Notice that (d) contains mainly noise because of the directivity of the transmit wave.

FIG. 15: This figure is the same as FIG. 14 except that a wire object in FIG. 12, (b), was placed at the focal distance of the TX transducer (see FIG. 11). The third wire from the left of the wire object was approximately aligned with the focal point of the TX transducer. The wire object was fixed and scanned with the TX transducer to map the pulse ultrasound wave field. Compared to FIG. 14, it is seen that high spatial frequency components were produced in the pulse wave field due to the wire object (see (c) and (f)).

FIG. 16: This figure is the same as FIG. 14 except that a Bessel transducer was used to replace the TX transducer in FIG. 11 and the scanning distance along the x axis was 50 mm. The Bessel transducer had a center frequency of 2.5 MHz and the pulse Bessel beam was produced by a 1-cycle 2.5-MHz electrical sine signal. The Bessel transducer was placed at about 0.5-mm away from the focal distance of the RX transducer that was the same 2.25-MHz transducer used in FIG. 14.

FIG. 17: Line plots of the pulse Bessel beams mapped across the center of the Bessel transducer along the x-axis (lateral distance). The solid (black), dash-dotted (blue), dotted (pink), and dashed (green) lines correspond to FIG. 16, (c) (super-resolution with RX transducer at θ=0°), FIG. 16, (f) (super-resolution with RX transducer at θ=45°), FIG. 16, (a) (without super-resolution), and FIG. 18, (f) (mapped with a PVDF needle hydrophone), respectively. The vertical and horizontal axes represent the normalized magnitude of the pulse Bessel beams and the lateral distance along the x-axis, respectively. The line plots were normalized to their respective maxima, and they were obtained by taking the maximum from each row of FIG. 16, (c), FIG. 16, (f), FIG. 16, (a), and FIG. 18, (f), respectively, which represents the maximum sidelobes of the beams.

FIG. 18: Focused pulse ultrasound wave fields mapped with a broadband PVDF needle hydrophone at the focal distance of the TX transducer with ((b) and (e)) and without ((a) and (d)) the wire object in FIG. 12, (b), and a pulse Bessel beam mapped by the hydrophone at 0.5 mm away from the surface of the Bessel transducer ((c) and (f)). (a), (b), and (c) are photos of the experiment setups corresponding to (d), (e), and (f), respectively. The wave fields in (d), (e), and (f) are the same as those in FIG. 14, (a), FIG. 15, (a), and FIG. 16, (a), respectively, except that the hydrophone was used to map the wave fields.

FIG. 19: Overview of remote super-resolution mapping of a pulse ultrasound wave field, as demonstrated in Example II herein.

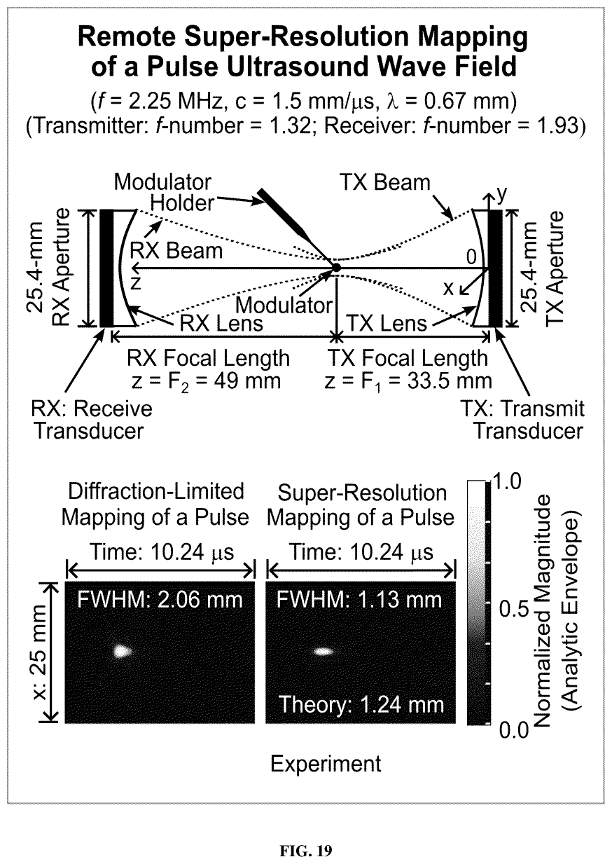

FIG. 20: An illustration showing how the general PSF modulation super-resolution imaging method works with a single modulator. The modulator is fixed on the object to the imaged. (a1) shows an original object. (a2) shows a modulator (black dot) added to the object. (b) shows an LSI imaging system. (c1) shows an image of (a1). (c2) shows an image of (a2). (d) shows an image obtained by subtracting (c2) from (c1). (e) shows a reconstructed super-resolution image obtained by scanning the modulator over the entire object.

FIG. 21: This figure is the same as FIG. 20 except that multiple modulators are used to speed up the imaging process.

FIG. 22: This is another approach to implement the universal PSF-modulation super-resolution imaging method using an LSI imaging system in (b) for an object in (a). A modulator is placed at the center of the PSF in (c1) to obtain a modified PSF in (c2) that contains high-spatial frequency components. Subtracting the image in (d2) obtained with the modulator from the conventional image in (d1) that is obtained without the modulator, a super-resolution image can be produced in (e).

FIG. 23: Steps for a 1D high-resolution X-ray radiographic imaging of a line-pair (lp) phantom. (a) shows an X-ray radiographic imaging system and the lp phantom. (b), (c), and (d) are the same as (a) except that a lead modulator is added from Position 1 to N, respectively. (a1) is a reference projection image. (b1), (c1), and (d1) are the projection images obtained with the modulator scanning from Positions 1 to N, respectively, where N is an integer. (b2), (c2), and (d2) are images obtained by subtracting the respective projection images from the reference image. (b3), (c3), and (d3) are images with the centers of the images in (b2), (c2), and (d2), localized respectively. The center values of these images are obtained by integrating the images in (b2), (c2), and (d2), respectively. (e) is a top-view of the original lp phantom. (f) is a high-resolution image obtained by combining images from (b3), (c3), and (d3).

FIG. 24: Illustration of construction of modulator arrays and tissue phantoms. (a) shows a lead film on plexiglass substrate. (a1) shows an assembled 1D modulator array. (b) shows lead strips on plexiglass substrate. (b1) shows lead strips cut from (b). (b2) shows an assembled 2D modulator array. (c) shows tissue phantoms to mimic bone with micro cracks and micro calcifications. (Parameters indicated are for examples only.)

FIG. 25: A mobile super-resolution imaging system. The system, as indicated in the figure, is composed of a light source, an object immersed in a fluid media in a petridish and to be imaged, a lens attachment, modulator(s), electromagnets, and a cell phone.

FIG. 26: Steps for reconstruction of super-resolution images using a single small light-opaque modulator. (a) and (c) are object to be imaged and its image obtained at the diffraction-limited resolution of the imaging system respectively. (b) and (d) are the same as (a) and (c), respectively, except that a modulator is placed on the object. (e) is an image obtained by subtracting (d) from (c). Localizing the center of the image in (e), integrating the light intensity over the resolution cell of the image, and then assigning the integrated value to the center, a pixel of super-resolution image is reconstructed. Moving the modulator to different positions and repeating the process for each position, the super-resolution image in (f) is obtained.

FIG. 27: This figure is the same as FIG. 26 except that more than one modulator is used to speed up the image reconstruction, where the modulators are randomly and sparsely distributed (the sparsity ensures that the images of the modulators do not overlap).

### DETAILED DESCRIPTION

The disclosures of any publications, patents, and published patent specifications referenced herein are hereby incorporated by reference into the present disclosure in their entirety to more fully describe the state of the art to which this invention pertains.

Imaging is an important fundamental tool to advance science, engineering, and medicine, and is indispensable in daily life. Some examples include: acoustical and optical microscopes, which have helped to advance biology, ultrasound imaging, X-ray radiography, X-ray computerized tomography (X-ray CT), magnetic resonance imaging (MRI), gamma camera, single-photon emission computerized tomography (SPECT), and positron emission tomography (PET), which have been routinely used for medical diagnoses. Electron and scanning tunneling microscopes have revealed structures in nanometer or atomic scale, where one nanometer is one billionth of a meter. And photography, including the cameras in cell phones, is in nearly everyone's everyday life.

Despite the importance of imaging, it was first recognized by Ernest Abbe in 1873 that there is a fundamental limit known as the diffraction limit for resolution in wave-based imaging systems due to the diffraction of waves. This affects acoustical, optical, and electromagnetic waves, and so on. However, in accordance with the present disclosure, it is possible to overcome such long-standing diffraction limit. The method described herein is not only applicable to wave-based imaging systems such as ultrasound, optical, electromagnetic, radar, and sonar, but is also applicable to other linear shift-invariant (LSI) imaging systems such as X-ray radiography, X-ray CT, MRI, gamma camera, SPECT, and PET, since it increases image resolution by introducing high spatial frequencies through modulating the point-spread function (PSF) of an LSI imaging system. The modulation can be induced remotely from outside of an object to be imaged or can be from small particles introduced into or on the surface of the object and manipulated remotely. The LSI system can be understood with a geometric distortion corrected optical camera in the photography, where the photo of a person is the same or invariant in terms of the size and shape if the person only shifts his/her position in the direction that is perpendicular to the camera optical axis within the camera field of view.

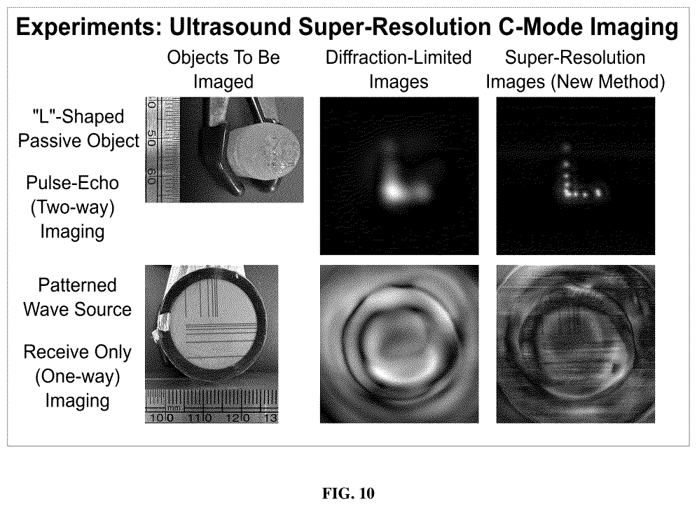

FIG. 10 illustrates the efficacy of the method described herein using an acoustical wave. The method was used to image a passive object (in the first row) through a pulse-echo imaging or to image wave source distributions (in the second row) with a receiver. The best images obtainable under the Abbe's diffraction limit are in the second column, and the super-resolution (better than the diffraction limit) images obtained with the method described herein are in the last column. The super-resolution images had a resolution that was close to ⅓ of the wavelength used from a distance with an f-number (focal distance divided by the diameter of the transducer) close to 2.

Because the method is based on the convolution theory of an LSI system and many practical imaging systems are LSI, the method opens an avenue for various new applications in science, engineering, and medicine. With a proper choice of a modulator and imaging system, nanoscale imaging with resolution similar to that of a scanning electron microscope (SEM) is possible even with visible or infrared light.

In accordance with the present disclosure, a point spread function (PSF) modulation method has been developed for super-resolution imaging. The PSF is a concept that describes the response of an imaging system to a point source of light or a point object. PSF represents how light spreads or is distributed across an image when it originates from a single point. In optics and microscopy, PSF characterizes the blurring or spreading of light caused by imperfections and limitations in the optical system. A perfect imaging system would produce a sharp image for a point source, but real-world systems introduce aberrations and other factors that result in a spread of blur. PSF is important for deconvolution techniques in image processing, as deconvolution is used to enhance or restore an image by reversing the effects of blurring introduced by the imaging system. PSF allows for the application of appropriate deblurring algorithms.

The spatial resolution of an imaging system using waves is limited by the spatial bandwidth of the PSF of the system, which is related to the wavelength. However, when the PSF is modulated either in amplitude or phase or both, the resulting spatial bandwidth of the PSF is increased. In accordance with the present disclosure, PSF modulation can be used to obtain super-resolution imaging of objects and to distinguish wave sources that are closely located in space and are not normally separable due to diffraction limits. In imaging using waves, such as ultrasound, acoustics, optics, electromagnetics, radar, and sonar, the PSF can be modulated in their respective fields. For example, in ultrasound, shear wave in biological soft tissues has a low wave speed and thus has a small wavelength. A ring-shaped shear wave can be generated locally (remotely) deep in the tissue by the radiation force of a focused Bessel beam, X wave, or other limited-diffraction beam at their focuses to produce a sharp peak at the center of the ring (due to shear wave focusing with a small wavelength). This sharp peak of the shear wave modulates the center of a conventional focused beam transmitted after the shear wave ring is produced. The modulated focused beam can then be used to scan through an object to obtain a super-resolution image after removing the contribution of the original beam.

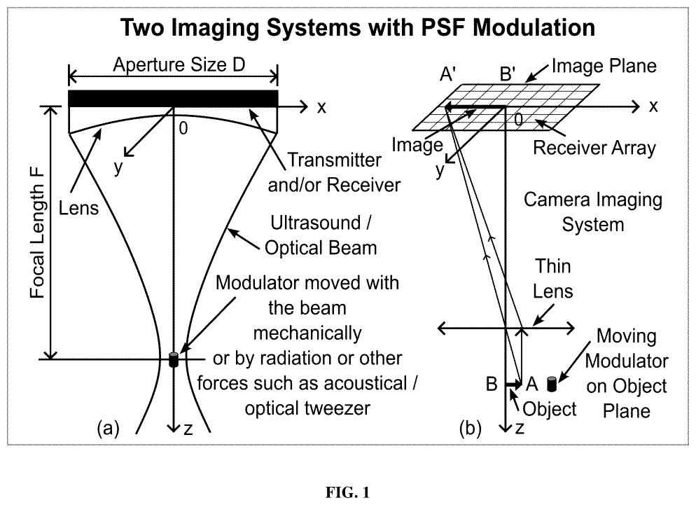

In the method, the PSF of an imaging system is modulated so that the resulting PSF has a higher spatial frequency. The modulated PSF is then scanned through an object (see FIG. 1, left) or is processed with a camera (see FIG. 1, right) or a holographic imaging system to get a super-resolution image. In addition, a variant of this method called PSF-weighted super-resolution imaging was developed where, like in the camera or the holographic imaging system, the modulator itself is scanned or moved through an object to form an image.

PSF spatial frequency components are governed by the angular spectrum limitation of the wave equation. Confocal imaging provides a better image resolution than one-way imaging. Thus, confocal imaging is a good place to start. Confocal image is given by a convolution of PSF and object function. PSF is a bandwidth-limited function. To increase the bandwidth, the PSF function can be multiplied by a modulation function that has a wider bandwidth than that of the PSF function. The PSF bandwidth can be increased by amplitude or phase modulation or both. Modulating the PSF involves intentionally altering its shape or characteristics, and can be achieved through various techniques. The modulation can take many forms, and can be generated by various means. The modulation function can be a point function, circular concentric rings, or tapered vertical bars, or the like. The modulation function can be generated by, for example, shear wave sources, non-linear effects, high-energy pulsing, or the like. Since the modulation is very close to the object to be imaged, it is not very significant if it attenuates shortly after leaving the image site. A photoacoustic effect can be used as a modulation source. Alternatively, optical radiation pressure or ultrasound radiation pressure can be used as a modulation source.

As one non-limiting example, adaptive optics can be used to dynamically adjust optical elements in real-time to correct for distortions or other aberrations. By changing the shape of deformable mirrors or other optical elements, adaptive optics can effectively modulate the PSF to improve image quality. As another non-limiting example, quantum dots, gas vesicle that produces bursting sound, or fluorescent light may be used as modulators. As another non-limiting example, spatial light modulators (SLMs) can be used to modulate the phase or amplitude of light in different regions of an optical wavefront. These devices can be used to intentionally modify the PSF by manipulating the incoming light before it reaches the imaging system so as to control changes in the PSF. As another non-limiting example, diffractive optical elements (DOEs) can manipulate the phase or amplitude of light, often using diffraction patterns, so as to intentionally shape the PSF for specific applications.

In sum, PSF modulation can obtain super-resolution imaging when the modulation has a high spatial frequency. Both amplitude and phase modulation can be used, and a mix of the two may also be used. Phase modulation can be achieved by a local shift of object position. For example, shear wave induced by radiation force can be used as a source of phase modulation. A focused Bessel beam (i.e., a wave which does not diffract) can produce a ring source of radiation force to focus the shear wave for phase modulation. Also, a linear, phased, or curved array transducer used in conventional medical ultrasound imaging systems can be apodized in its aperture with drive signals of an opposite phase on both edges of the transducer from the center segment of the transducer to produce focused shear wave to modulate the phase of imaging wave for super-resolution imaging. For modulators that are outside the object to be imaged, the resolution can be increased when the distance between the object and the modulator is reduced.

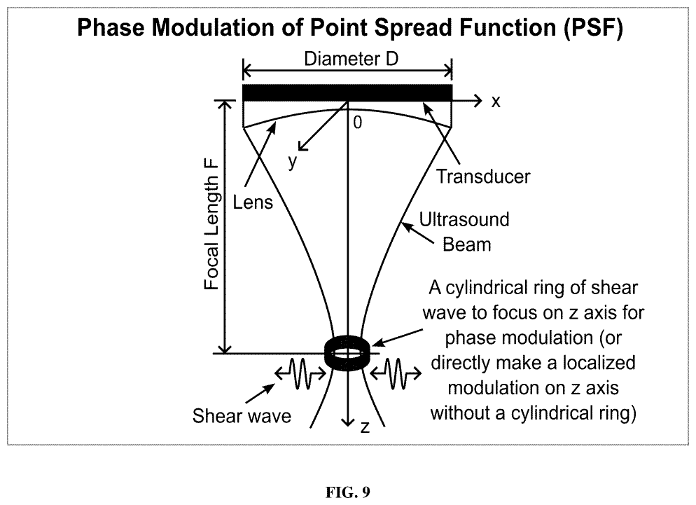

Non-limiting example imaging systems are illustrated in FIG. 1 and FIG. 9. An imaging system which can be used in the methods for obtaining super-resolution images described herein may include a source of a spherically focused wave, and a modulator on a wave propagation axis of the spherically focused wave, where the modulator is configured to scan over an object to produce a super-resolution image. Alternatively, the imaging system may include a camera imaging system and a modulator on an object plane, where the modulator is configured to scan over the object plane while the camera imaging system is fixed in place so as to obtain a super-resolution image of an object in the object plane. Many other imaging systems such as lensless in-line digital holographic system and PSF-weighted super-resolution imaging system are possible and encompassed within the scope of the present disclosure.

The methods and imaging systems described herein may be useful in a wide variety of imaging applications, including ultrasound imaging, acoustical imaging (including microscopy), nondestructive evaluation (NDE) of materials, underwater acoustical imaging, optical imaging (including optical coherent microscopy or OCT), electromagnetic imaging, and magnetic resonance imaging (MRI). The achievable image resolution from the methods and imaging systems is primarily constrained by image noise.

The PSF-modulation method described herein can be applied to various disciplines of science and engineering since the method is based on a solid LSI convolution theory and many imaging systems are operated based on the LSI theory. The PSF-modulation method is attacking the root problem that limits the image resolution in various imaging systems through an introduction of a modulator that has a very high spatial frequency and can be practically produced in the imaging systems (such as by a shear wave or by a physical particle).

### EXAMPLES

These examples describe modulating the PSF in amplitude, phase, or both to increase the spatial frequency to reconstruct super-resolution images of objects or wave sources/fields, where the modulator can be a focused shear wave produced remotely by, for example, a radiation force from a focused Bessel beam or X wave, or can be a small particle manipulated remotely by a radiation-force (such as acoustic and optical tweezers) or electrical and magnetic forces. The theory behind this, as well as computer simulations and experiments, are described in these examples.

### Example I

The result of an ultrasound experiment shows that a pulse-echo (two-way) image reconstructed has a super-resolution (0.65 mm) as compared to the diffraction limit (2.65 mm) using a 0.5-mm diameter modulator at 1.483-mm wavelength, and the signal-to-noise ratio (SNR) of the image was about 31 dB. If the minimal SNR of a “visible” image is 3, the resolution can be further increased to about 0.19 mm by decreasing the size of the modulator. Another ultrasound experiment shows that a wave source was imaged (one-way) at about 30-dB SNR using the same modulator size and wavelength above. The image clearly separated two 0.5-mm spaced lines, which gives a 7.26 folds higher resolution than that of the diffraction limit (3.63 mm). Although in theory the method has no limit on the highest achievable image resolution, in practice, the resolution is limited by noises. Also, a PSF-weighted super-resolution imaging method based on the PSF modulation method was developed. This method is easier to implement but may have some limitations. The methods above can be applied to imaging systems of an arbitrary PSF and can produce 4D super-resolution images. With a proper choice of a modulator (such as quantum dots) and imaging system, nanoscale (a few nanometers) imaging is possible.

### Theoretical Preliminaries

Consider a wave field Φ^{T} (r̅; t) (such as ultrasound, acoustics, electromagnetic, and light wave) that is produced by a wave generator (such as an ultrasound transducer, loudspeaker, electromagnetic antenna, and optical light source) (see FIG. 1, left), where r̅=(x, y, z) is a point in space, t is the time, the superscript “T” means “transmit”, and Φ^{T} (r̅; t) is a convolution of a drive signal s(t) and the impulse response h(r̅; t) of the wave generator in terms of time in a linear time invariant (LTI) system. If the wave generator is also used as a receiver (notice that the receiver can be a separate device), the receiver response can be written as Φ^{R} (r̅; t), where the superscript “R” represents “receive”.

At each given time t, in an LSI imaging system (note that many practical imaging systems in various areas of science and engineering such as ultrasound and optics can be described or approximately described by an LSI system), the received signal from an object f(r̅) that represents wave scattering coefficients or other properties of the object is given by the following convolution:

$${R}^{PE} ( \vec{r} ; t ) = {\int }_{{\vec{r}}^{′}} {Φ}^{PE} ( \vec{r} - {\vec{r}}^{′} ; t ) f ( {\vec{r}}^{′} ) d {\vec{r}}^{′} = {Φ}^{PE} ( \vec{r} ; t ) {\vec{r}}_{} f ( \vec{r} ) \qquad ( 1 )$$

where the superscript “PE” means “pulse-echo” or “two-way”, r̅′ is an integration variable over the space, [symbol] represents a convolution in terms of r̅, and at each fixed spatial position r̅ there is:

$${Φ}^{PE} ( \vec{r} ; t ) = {\int }_{{t}^{′}} {Φ}^{T} ( \vec{r} ; {t}^{′} ) {Φ}^{R} ( \vec{r} ; t - {t}^{′} ) {dt}^{′} = {Φ}^{T} ( \vec{r} ; t ) {t}_{} {Φ}^{R} ( \vec{r} ; t ) \qquad ( 2 )$$

where *t represents a convolution in terms of time t. If f(r̅) is a point object, i.e., f(r̅)=δ(r̅), where δ(r̅) is the Dirac-Delta function, from Eq. (1), one obtains the PSF of the imaging system at each given time t:

$${PSF}^{PE} ( \vec{r} ; t ) = {\int }_{{\vec{r}}^{′}} {Φ}^{PE} ( \vec{r} - {\vec{r}}^{′} ; t ) δ ( {\vec{r}}^{′} ) d {\vec{r}}^{′} = {Φ}^{PE} ( \vec{r} ; t ) \qquad ( 3 )$$

Using Eq. (3), Eq. (1) can be written as:

$${R}^{PE} ( \vec{r} ; t ) = {PSF}^{PE} ( \vec{r} ; t ) {\vec{r}}_{} f ( \vec{r} ) \qquad ( 4 )$$

Taking a spatial Fourier transform on both sides of Eq. (4), one obtains:

$${\tilde{R}}^{PE} ( \vec{k} ; t ) = {}^{PE} ( \vec{k} ; t ) \tilde{f} ( \vec{k} ) \qquad ( 5 )$$

where \tilde{R}^{PE} (k̅; t), [symbol] ^{PE} (k̅;t) and \tilde{f}(k̅) are the spatial Fourier transform of R^{PE} (r̅; t), PSF^{PE} (r̅; t), and f(r̅), respectively, and k=(kₓ, k_{y}, k_{z}) is a vector wave number. From Eq. (5), it is clear that the maximum spatial frequency of the image R^{PE} (r̅; t) is limited by that of PSF^{PE} (r̅; t) due to wave diffraction, which is a fundamental limit to the spatial resolution of an imaging system.

To increase the bandwidth of the imaging system, the PSF function can be multiplied by a complex modulation function m(r̅) (the physical meaning of m(r̅) is to introduce a disturbance to an existing PSF of the imaging system by amplitude, phase, or both). The resulting image is given by:

$${R}^{{PE}_{m}} ( \vec{r} ; t ) = [ {PSF}^{PE} ( \vec{r} ; t ) m ( \vec{r} ) ] {\vec{r}}_{} f ( \vec{r} ) + {C}^{PE} ( t ) \qquad ( 6 )$$

where the subscript “in” of “PE” means “modulation”, and C^{PE}(t) is independent of the spatial variable r̅ and is a constant at any given time t because the relative position between the modulator and the PSF is fixed (see FIG. 1, left):

$${C}^{PE} ( t ) = {\int }_{\vec{r}} {PSF}^{PE} ( \vec{r} ; t ) {γ}_{m}^{PE} ( \vec{r} ) d \vec{r} \qquad ( 7 )$$

where γₘ^{PE}(r̅) represents the scattering or reflection coefficient of the modulator m(r̅) in the pulse-echo system. Taking a spatial Fourier transform on both sides of Eq. (6) gives:

$${\tilde{R}}^{{PE}_{m}} ( \vec{k} ; t ) = [ {PE}^{} ( \vec{k} ; t ) {\vec{k}}_{} \tilde{m} ( \vec{k} ) ] \tilde{f} ( \vec{k} ) + {\tilde{C}}^{PE} ( \vec{k} ; t ) \qquad ( 8 )$$

where \tilde{R}^{PE}^{ₘ} (k̅;t), [symbol] ^{PE} (k̅;t), \tilde{m}(k̅), \tilde{f}(k̅), \tilde{C}^{PE} (k̅;t) are the spatial Fourier transform of R^{PE}^{ₘ} (r̅;t), PSF^{PE} (r̅;t), m(r̅), f(r̅), and C^{PE} (t), respectively, and *k̅ represents a convolution with respect to k̅. Since C^{PE} (t) is not a function of position r̅, its spatial Fourier transform is a delta function, i.e., C^{PE} (t) is a DC (direct current) component of the image R^{PE}^{ₘ} (r̅;t) at any given time t. Because the convolution in Eq. (8) is performed in the spatial frequency domain k̅, the maximum spatial frequency of the modulated PSF in Eq. (6), PSF^{PE}^{ₘ} (r̅;t)=PSF^{PE} (r̅;t)m(r̅), of the imaging system is increased, making it feasible to reconstruct super-resolution images with methods that are suitable for specific applications in different areas of science and engineering.

If f(r̅;t) represents the spatial field (a distribution of the wave in space r̅ in a media, for example, the acoustical waves produced by light or electromagnetic heating in photoacoustic imaging, waves transmitted through the object, and the waves used to illuminate and then scattered or reflected from the object, of a wave source at any given time t, a super-resolution image of the spatial field also can be reconstructed. In this case, only a receiver is needed and the imaging is a one-way process. Similar to Eqs. (4) and (6), images without and with a modulator can be obtained respectively as follows:

$${R}^{R} ( \vec{r} ; t ) = {\int }_{{t}^{′}} {\int }_{{\vec{r}}^{′}} {Φ}^{R} ( \vec{r} - {\vec{r}}^{′} ; t - {t}^{′} ) f ( {\vec{r}}^{′} ; {t}^{′} ) d {\vec{r}}^{′} {dt}^{′} = {Φ}^{R} ( \vec{r} ; t ) {\vec{r} , t}_{} f ( \vec{r} ; t ) = {PSF}^{R} ( \vec{r} ; t ) {\vec{r} , t}_{} f ( \vec{r} ; t ) \qquad ( 9 )$$

$$and$$

$${R}^{{R}_{m}} ( \vec{r} ; t ) = [ {PSF}^{R} ( \vec{r} ; t ) m ( \vec{r} ) ] {\vec{r} , t}_{} f ( \vec{r} ; t ) + {C}^{R} ( \vec{r} ; t ) \qquad ( 10 )$$

where [symbol] ,t represents a convolution with respect to both r̅ and t, and

$${C}^{R} ( \vec{r} ; t ) = {\int }_{{t}^{′}} {\int }_{{\vec{r}}^{′}} [ {PSF}^{R} ( {\vec{r}}^{′} ; {t}^{′} ) {γ}_{m}^{R} ( {\vec{r}}^{′} ) ] f ( \vec{r} - {\vec{r}}^{′} ; t - {t}^{′} ) d {\vec{r}}^{′} {dt}^{′} = [ {PSF}^{R} ( \vec{r} ; t ) {γ}_{m}^{R} ( \vec{r} ) ] {\vec{r} , t}_{} f ( \vec{r} ; t ) \qquad ( 11 )$$

where γₘ^{R}(r̅) represents the scattering or reflection coefficient of the modulator m(r̅). From Eqs. (10) and (11), it is clear that γₘ^{R} (r̅) can be viewed as a part of the modulator. Similar to Eq. (3), the PSF of the receiver can be obtained:

$${PSF}^{R} ( \vec{r} ; t ) = {\int }_{{t}^{′}} {\int }_{{\vec{r}}^{′}} {Φ}^{R} ( \vec{r} - {\vec{r}}^{′} ; t - {t}^{′} ) δ ( {\vec{r}}^{′} ; {t}^{′} ) d {\vec{r}}^{′} {dt}^{′} = {Φ}^{R} ( \vec{r} ; t ) \qquad ( 12 )$$

Notably, Eqs. (4), (6), (9), and (10) work for the camera imaging system in FIG. 1 (left), too if the LSI condition is met. Also, the position of the modulator m(r̅) is assumed to be fixed relative to the PSF in both Eqs. (6) and (10). However, this condition may not be met in some applications. For example, when a modulator such as a charged or magnetic nanoparticle is moved by an electrical or magnetic force to pass through a cell via cellular pores or around cells in an extracellular matrix along different paths for super-resolution imaging, the position of the modulator relative to the PSF may change. Similarly, when a charged particle is used as a modulator to get a super-resolution image of the topological structure of the gel or materials embedded in the gel in electrophoresis, the position of the modulator relative to the PSF may also change as the modulator moves through the gel at a certain speed. Although the PSF can change rapidly with time at the temporal frequency of the imaging wave, the magnitude of the PSF does not change quickly over both time (due to a limited temporal bandwidth) and space (due to a poor diffraction-limited resolution). Thus, if the shifts of the modulator are within the range where the magnitude of the PSF does not change significantly, both Eqs. (6) and (10) can still be used since in most cases, the magnitude-related quantities such as averaged absolute values and analytic envelope, instead of the radio frequency (RF) carrier wave that fluctuates quickly at the temporal frequency of the imaging wave, are of interest in imaging. To ensure that C^{PE} in Eq. (6) is independent of r̅ and thus can be removed, it is important to shift the image pixels along the time direction to compensate for the shifts of the modulator in the z (axial) direction (see FIG. 1) temporally. Notably, the position of the modulator can be tracked in both time and space as it is normally done for microbubbles in the ULM. After removing C^{PE} (t), the positions of the pixels should be shifted back to where the modulator was. Or, if the “I” (in phase) and “Q” (quadrature) components of the RF signal are available, they can be used directly to remove C^{PE} (t) without the need for the shifts above. The procedure above can produce a super-resolution image on a curved surface that represents the trajectories of the nanoparticle passing through the cell, the extracellular matrix around the cells, the gel, or the materials embedded in the gel.

Eqs. (6) and (10) are the basis for four-dimensional (4D) (x, y, z; t) super-resolution imaging with PSF modulation. In general, the modulation function m(r̅) is complex and can produce both amplitude and phase modulations to the imaging wave, and one is free to choose as long as corresponding image reconstruction methods can be developed. However, some choices of m(r̅) can simplify the implementation of the PSF modulation method and image reconstructions. Below are given two m(r̅) examples that are relatively simple.

### Amplitude Modulation

The first example is to assume that m(r̅) is a real function that produces an amplitude modulation to the imaging wave:

$$m ( {\vec{r}}_{1} ) = \{ \begin{matrix}0 , & \vert {\vec{r}}_{1} - {\vec{r}}_{F} \vert \leq a \\ 1 , & Otherwise ( including z \neq F )\end{matrix} , \qquad ( 13 )$$

where r̅₁=(x, y, z=F), r̅_{F}=(0,0,F), F is the focal length, and α is the radius of the modulator (see FIG. 1, left). Inserting Eq. (13) into Eq. (6), and then subtracting the result from Eq. (4), a two-dimensional (2D) super-resolution C-mode image (in the x-y plane at z=F) can be reconstructed by:

$${R}^{{PE}_{sub}} ( {\vec{r}}_{1} ; t ) = {R}^{PE} ( {\vec{r}}_{1} ; t ) - {R}^{{PE}_{m}} ( {\vec{r}}_{1} ; t ) = {PSF}^{{PE}_{sub}} ( \vec{r} ; t ) {\vec{r}}_{} f ( \vec{r} ) - {C}^{PE} ( t ) \qquad ( 14 )$$

$$where$$

$${PSF}^{{PE}_{sub}} ( \vec{r} ; t ) = {PSF}^{PE} ( \vec{r} ; t ) [ 1 - m ( {\vec{r}}_{1} ) ] = \{ \begin{matrix}{PSF}^{PE} ( \vec{r} ; t ) , & \vert {\vec{r}}_{1} - {\vec{r}}_{F} \vert \leq a \\ 0 , & Otherwise ( including z \neq F )\end{matrix} \qquad ( 15 )$$

the subscript “sub” on “PE” means “subtracted”, and C^{PE}(t) is due to the reflections from the modulator m(r̅₁) (with γₘ^{PE} (r̅₁)=1−m(r̅₁)) and is given by (see Eq. (7)):

$${C}^{PE} ( t ) = {\int }_{\vec{{r}_{1}}} {PSF}^{PE} ( {\vec{r}}_{1} ; t ) [ 1 - m ( {\vec{r}}_{1} ) ] d {\vec{r}}_{1} = {\int }_{\vert {\vec{r}}_{1} - {\vec{r}}_{F} \vert \leq a} {PSF}^{PE} ( {\vec{r}}_{1} ; t ) d {\vec{r}}_{1} \qquad ( 16 )$$

As mentioned above, the DC component C^{PE} (t) at each given time t can be removed from the image R^{PE}^{ₘ} (r̅₁;t) in Eq. (14).

Similarly, 2D super-resolution C-mode images of the field of a wave source (one-way imaging) using the modulator in Eq. (13) can be reconstructed by inserting Eq. (13) into Eq. (10) and then subtracting the result from Eq. (9):

$${R}^{{R}_{sub}} ( {\vec{r}}_{1} ; t ) = {R}^{R} ( {\vec{r}}_{1} ; t ) - {R}^{{R}_{m}} ( {\vec{r}}_{1} ; t ) = {PSF}^{{R}_{sub}} ( \vec{r} ; t ) {\vec{r} , t}_{} f ( \vec{r} ; t ) - {C}^{R} ( {\vec{r}}_{1} ; t ) \qquad ( 17 )$$

$$where$$

$${PSF}^{{R}_{sub}} ( \vec{r} ; t ) = {PSF}^{R} ( \vec{r} ; t ) [ 1 - m ( {\vec{r}}_{1} ) ] = \{ \begin{matrix}{PSF}^{R} ( \vec{r} ; t ) , & \vert {\vec{r}}_{1} - {\vec{r}}_{F} \vert \leq a \\ 0 , & Otherwise ( including z \neq F )\end{matrix} \qquad ( 18 )$$

and C^{R} (r̅₁;t) is given by Eq. (11) and is part of the reconstructed image of the wave source/field.

### Phase Modulation

The second example is a modulator for phase modulation:

$$m ( {\vec{r}}_{1} ) = \{ \begin{matrix}{e}^{i {ϕ}_{0}} , & \vert {\vec{r}}_{1} - {\vec{r}}_{F} \vert \leq a \\ 1 , & Otherwise ( including z \neq F )\end{matrix} \qquad ( 19 )$$

where i=\sqrt{−1} and 0<ϕ₀<2π is a constant. As in the amplitude modulation, 2D super-resolution C-mode pulse-echo images can be reconstructed by Eq. (14) with (see Eq. (15)):

$$PS \text{?} ( \vec{r} ; t ) = \{ \begin{matrix}{PSF}^{PE} ( \vec{r} ; t ) ( 1 - {e}^{i {ϕ}_{0}} ) , & \vert {\vec{r}}_{1} - {\vec{r}}_{F} \vert \leq a \\ 0 , & Otherwise ( also z \neq F )\end{matrix} \qquad ( 20 )$$

$$\text{?} \text{indicates text missing or illegible when filed}$$

For 2D C-mode one-way super-resolution imaging of the field of a wave source, Eq. (17) can be used (see Eq. (18)):

$${PSF}^{{R}_{sub}} ( \vec{r} ; t ) = \{ \begin{matrix}{PSF}^{R} ( \vec{r} ; t ) ( 1 - {e}^{i {ϕ}_{0}} ) , & \vert {\vec{r}}_{1} - {\vec{r}}_{F} \vert \leq a \\ 0 , & Otherwise ( also z \neq F )\end{matrix} \qquad ( 21 )$$

### Computer Simulation and Experiment Procedures

The computer simulations were based on the limited-diffraction array beam method previously developed to obtain both Φ^{T} (r̅;t) and Φ^{R} (r̅;t), and were implemented using the C programming language on a Linux operating system. Using the modulators given in Eqs. (13) and (19), 2D super-resolution C-mode images can be reconstructed with Eqs. (14) or (17), depending on pulse-echo or wave source/field imaging. In the simulations, the following parameters were assumed: the modulator radius α=0.25 mm; temporal frequency f=1 MHz (continuous wave, i.e., CW); the speed of sound c=1500 m/s; wavelength λ=1.5 mm; transducer diameter D=25.4 mm with a focal length of F=50 mm; f-number=F/D=1.97; phase shift ϕ=π/10; and infinite signal-to-noise ratio (SNR) (i.e., no noise).

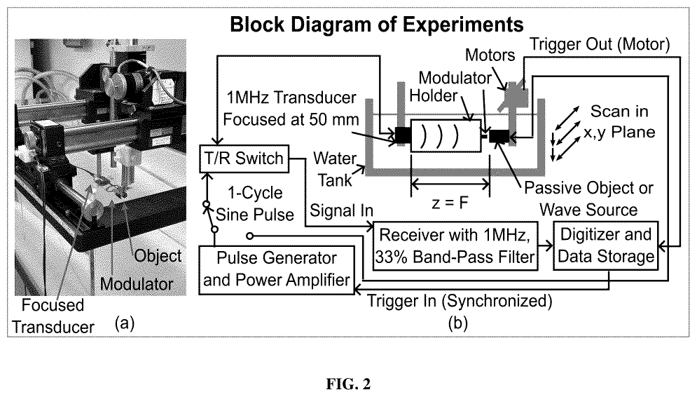

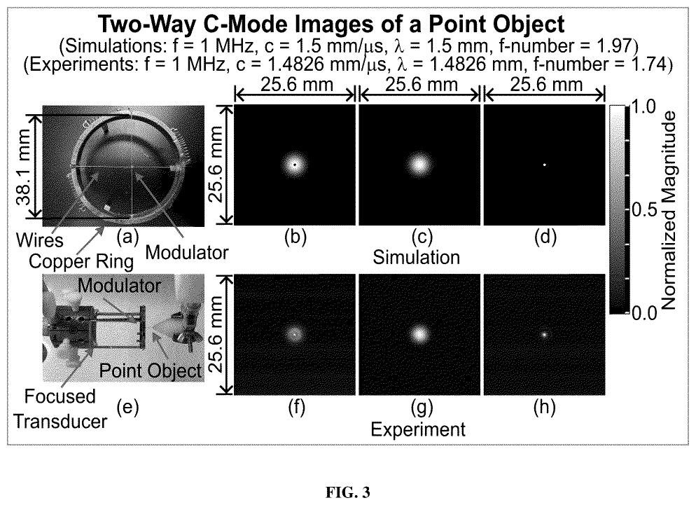

The experiments were performed according to the block diagram in FIG. 2. In the experiments, a 1-cycle sine wave (pulse) of 1 MHz and about 0.5 Vpp (“pp” means “peak-to-peak”) amplitude was produced by a function generator (HP81116A, Hewlett-Packard Company, CA, USA) and then amplified by an RF power amplifier (ENI2100L, Electronics and Innovation, Ltd., NY, USA) or two home-made RF power amplifiers of opposite polarities (for linear array experiment only). The amplified signal was used to drive a transducer (V302, Panametrics, MA, USA) that had 1-MHz center frequency, about 65% one-way relative bandwidth, and a 25.4-mm diameter for pulse-echo imaging, or drive another transducer for wave source/field imaging. To focus the waves, an acoustical lens that was made of acrylic and had a focal length F of about 50 mm (the measured F was about 44.12 mm) was attached to the front surface of the 1-MHz Panametrics transducer. Echoes from an object or the sound emitted from a wave source were received by the Panametrics transducer. The received signals were amplified by a 40-dB preamplifier and then filtered by a home-made 6-pole, constant-k, and 1-MHz center frequency band-pass filter of about 33% relative bandwidth before being digitized by a 12-bit digitizer at 20 MegaSamples/s for 512 samples after a fixed time delay. After each signal was received, the motors moved the object or the wave source to be imaged to the next position in the x-y plane at a fixed axial distance z=F with a step size of 0.1 mm along both x and y axes. At each (x, y) position, an unsynchronized trigger signal was generated from the motors and was synchronized to the clock of the digitizer before being sent to the function generator to produce the 1-cycle pulse. The process was repeated until all data were collected for each image with and without a modulator (a photo of the modulator used in the experiment is given in FIG. 3, (a), and the modulator can be approximately represented by Eq. (13) with the radius of the modulator equal to 0.25 mm).

2D C-mode super-resolution images were reconstructed with Eqs. (14) (pulse-echo imaging) or (17) (wave source/field imaging) from the experiment data collected with and without the modulator. In the image reconstructions, the DC component C(t) of the images at each temporal sample point was removed, and the final images were obtained by summing the absolute values of the images incoherently over 11 sample points (i.e., over a duration of about a half cycle of the 1-MHz signal). In the simulations, the incoherent summation was not necessary since a CW signal was assumed, the digital objects were infinitely thin, and the modulator and the objects were at the same distance from the transducer. However, in the experiments, the incoherent summation was needed to average out the variations of the images obtained at different temporal sample points since a short pulse was used, the objects were a few millimeters thick, different parts of the objects had a slightly different distance from the transducer, the modulator on the supporting wires (FIG. 3, (a)) vibrated randomly in the z direction when the water was disturbed by the scanning of the objects or wave sources, and the modulator was about 0.5 mm away from the objects. Despite of the deviations from ideal (theoretical) conditions, good super-resolution images with a high SNR were reconstructed in experiments (see results below).

### Methods and Results

FIG. 3, (a), shows a photo of the modulator that can be approximated with Eq. (13) for amplitude modulation. The modulator was made of a 0.5-mm diameter and 1-mm long copper wire. It was glued to the center of a cross of a pair of 85-μm diameter copper supporting wires that were mounted on a copper ring of 38.1-mm inner diameter and were tensioned via two pairs of small springs. The copper ring had three small clips for mounting and removing the modulator without affecting the transducer alignment. FIG. 3, (b) and (c) are simulated pulse-echo (two-way) C-mode images of a point object (a geometrical point without a physical dimension) with (see Eq. (6)) and without (see Eq. (4)) the modulator (see Eq. (13) with α=0.25 mm) respectively. FIG. 3, (d) is the super-resolution image reconstructed with Eq. (14). FIG. 3, (e) is a photo of a physical point object and the 1-MHz center frequency and 25.4-mm diameter focused broadband transducer mounted in a copper tube of 38.1-mm inner diameter. The point object was made of a 0.25-mm diameter and 6-mm long stainless steel wire mounted on a corn-shaped wax rod. An acoustical lens made of acrylic was attached to the front surface of the transducer and the modulator was placed in the focal area of the transducer. FIG. 3, (f), (g), and (h) are experimental results corresponding to FIG. 3, (b), (c), and (d), respectively. The distance between the modulator and the point object was about 0.5 mm in the experiments.

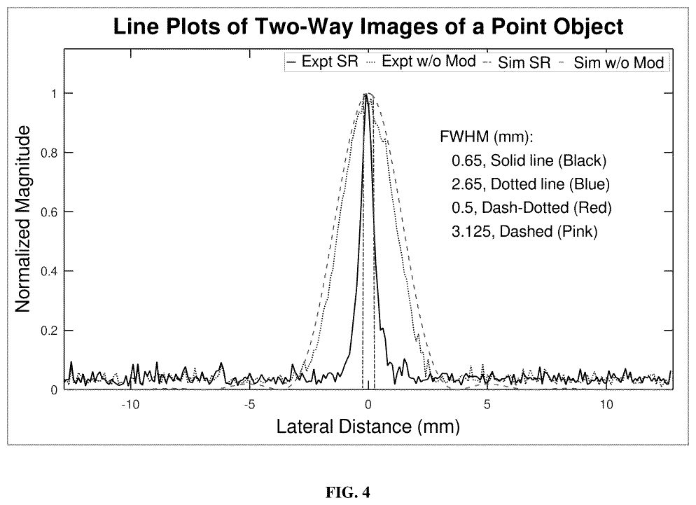

FIG. 4 shows the horizontal line plots through the center of the images in FIG. 3, (c) (dashed line, pink), FIG. 3, (d) (dash-dotted line, red), FIG. 3, (g) (dotted line, blue), and FIG. 3, (h) (solid line, black), respectively. The full-width-at-half-maximum (FWHM) resolutions estimated from the line plots were 3.125 mm, 0.5 mm, 2.65 mm, and 0.65 mm for FIG. 3, (c), FIG. 3, (d), FIG. 3, (g), and FIG. 3, (h), respectively. The best pulse-echo diffraction-limited FWHM resolution of a conventional C-mode image can be obtained from the following equation:

$${PR}_{FWHM}^{2} = 1.029 λ F / D \qquad ( 22 )$$

where PR_{FWHM}² represents two-way (superscript “2”) FWHM resolution (“R_{FWHM}”) of a planar aperture weighting (“P”), λ=c/f is the wavelength, c is the speed of sound (1500 m/s for the simulations and 1482.6 m/s at 20.6° C. in the experiments), F is the focal length of the transducer (50 mm in the simulations and about 44.12 mm in the experiments), and D=25.4 mm is the diameter of the transducer. Using these parameters, the diffraction-limited resolutions calculated with Eq. (22) are about 3.0384 mm and 2.65 mm for the simulations and the experiments, respectively. Note that the 44.12-mm focal length of the experiments was estimated from Eq. (22) using the measured diffraction-limited resolution (2.65 mm).

Comparing the images in FIG. 3, (d), and FIG. 3, (h), with the diffraction-limited images in FIG. 3, (c), and FIG. 3, (g), as well as from FIG. 4, it is clear that super-resolution images were reconstructed with the PSF modulation at an SNR of about 31 dB.

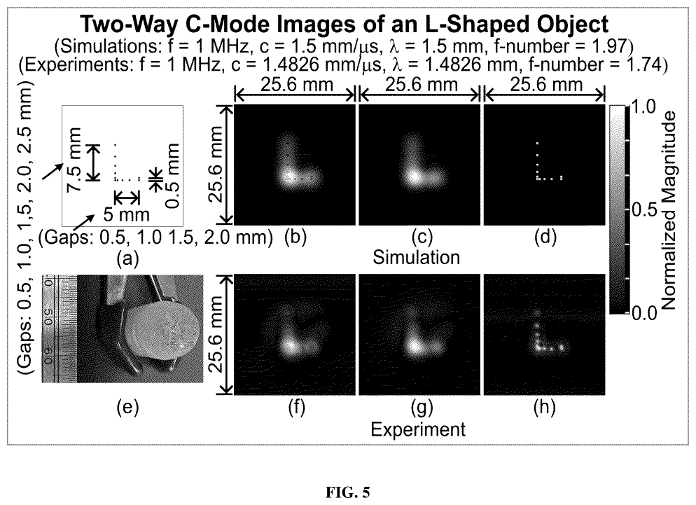

FIG. 5, (a)-(h) shows pulse-echo imaging of an “L”-shaped object that was composed of 11 point objects. FIG. 5, (a), shows the dimensions of the object. On the left in the vertical direction, there were 6 point objects with spacing of 2.5, 2.0, 1.5, 1.0, and 0.5 mm, respectively, from top to bottom. In the horizontal direction, there were 5 point objects with spacing of 0.5, 1.0, 1.5, and 2.0 mm from left to right, respectively. The vertical distance between the right-most two point objects was 0.5 mm. FIG. 5, (b)-(d) are the same as FIG. 3, (b)-(d), respectively, except that the “L”-shaped object in FIG. 5, (a) was imaged (the object consisted of geometrical points without a physical dimension). FIG. 5, (e) is a photo of a physical “L”-shaped object that was mounted on a clamp and was consisted of 11 stainless wires of about 0.25 mm in diameter and 6 mm in length. The wires were molded onto an epoxy resin base. FIG. 5, (f)-(h) are the same as FIG. 3, (f)-(h), respectively, except that the object in FIG. 5, (e), was imaged. From both FIG. 5, (d), and FIG. 5, (h), the point objects that were separated by 0.5 mm in the “L”-shaped object are visually identifiable (barely in FIG. 5, (h)), although the diffraction-limited resolution without the modulator was 2.65 mm in the experiment.

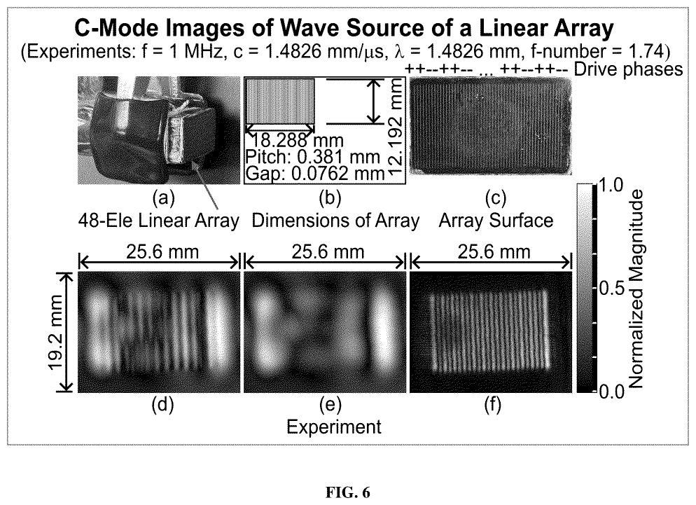

FIG. 6, (d)-(f) show one-way C-mode images of the wave source/field produced experimentally by a 48-element linear array transducer. FIG. 6, (a) is a photo of the linear array transducer mounted on a clamp. FIG. 6, (b) gives the dimensions of the array. FIG. 6, (c) is a close-up photo of the front surface of the array (the array does not have a front matching layer). The array was driven by the 1-cycle sine wave (pulse) of 1 MHz (see FIG. 2) via two home-made RF power amplifiers of opposite polarities (1800 phase difference). The polarities of the drive signals changed every two elements across the entire array, i.e., ++−−++−− . . . ++−−++−−. The waves produced by the array were received by the 1-MHz focused transducer. FIG. 6, (d)-(e) are C-mode images obtained respectively with and without the modulator (the modulator used was the same as that in FIG. 3 and FIG. 5, and was about 0.5 mm away from the surface of the array). FIG. 6, (f) is the super-resolution image reconstructed using Eq. (17).

The one-way diffraction-limited FWHM resolution is given by:

$${PR}_{FWHM} = 1.41 λ F / D \qquad ( 23 )$$

Using the parameters of the experiments (λ=1.4826 mm, F=44.12 mm, and D=25.4 mm), the resolution calculated with Eq. (23) is about 3.63 mm. Since the pitch of the array in FIG. 6, (b) was 0.381 mm and every two elements (0.762 mm) were driven with the same polarity, from FIG. 6, (f), it is clear that the image resolution is at least 0.762 mm. The darker area on the left in FIG. 6F indicates that the array was partially damaged.

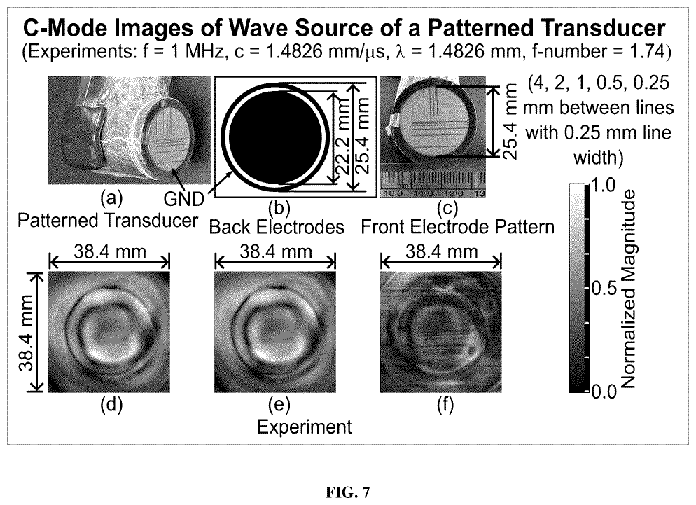

FIG. 7, (a)-(f), are the same as FIG. 6, (a)-(f), except that the wave source/field was produced by a patterned 25.4-mm diameter disk transducer. The transducer was air backed and enclosed in a plastic tube that was wrapped by a copper sheet for electrical shielding. The patterned transducer was driven by the 1-cycle sine wave (pulse) of 1 MHz and the waves produced were received by the 1-MHz focused transducer. FIG. 7, (a), is a photo of the patterned transducer mounted on a clamp. FIG. 7, (b), is the dimension of the pattern of the back electrode. The outer ring of the back electrode was connected to the front electrode that was grounded (GND), which gave an effective transducer diameter of 22.2 mm. FIG. 7, (c), is a photo of the pattern of the front electrode. The pattern contained both horizontal and vertical groups of lines. Each group had 6 lines with a line width of 0.25 mm. The spaces between the inner edges of adjacent lines in each group were 4, 2, 1, 0.5, and 0.25 mm, respectively. FIG. 7, (d)-(f), are the same as FIG. 6, (d)-(f), respectively, except that the patterned transducer was imaged.

In both FIG. 7, (d), and FIG. 7, (e), none of the lines are visible. However, in FIG. 7, (f), even the lines separated by 0.5 mm are visible, which means that the image resolution was about 0.5 mm that was 7.26 folds better than the 3.63-mm diffraction limited resolution calculated by Eq. (23) and also was better than a half of the 1.4826-mm wavelength. In addition to the line patterns, FIG. 7, (f), shows that the transducer had a complicated vibration mode. The SNR estimated from a line plotted across a line pattern of FIG. 7, (f), is greater than 30 dB.

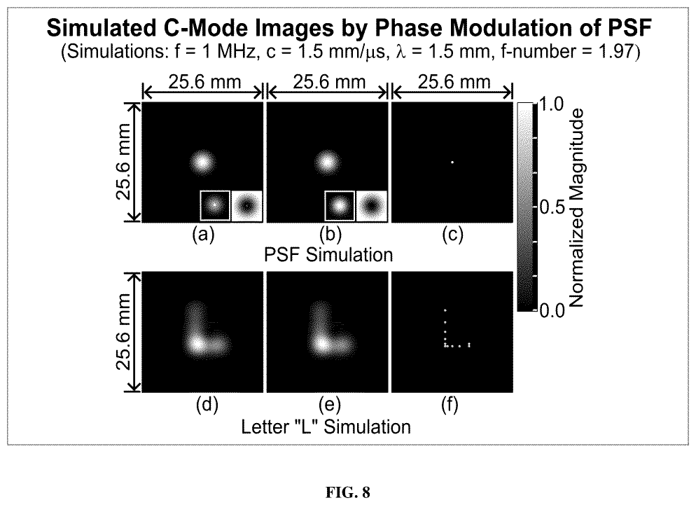

FIG. 8, (a)-(f), show the simulated results of a point object (see FIG. 3) and an “L”-shaped object (see FIG. 5) using the modulator given in Eq. (19) to modulate the phase of the PSF with ϕ₀=π/10 and α=0.25 mm. Other conditions for the simulations were the same as those in FIGS. 3, 5. FIG. 8, (a)-(b), are simulated pulse-echo C-mode images of a point object (a geometric point) with and without the modulator, respectively. The real (left) and imaginary (right) parts of the images in FIG. 8, (a)-(b), are shown as small insets near the bottom. FIG. 8, (c), is the super-resolution image reconstructed with Eqs. (14) and (20). FIG. 8, (d)-(f), are the same as FIG. 8, (a)-(c), respectively, except that an “L”-shaped object was imaged. As in FIG. 5, (a)-(h), all of the 11 points of the “L”-shaped object were geometrical points without a physical dimension. From FIG. 8, (c), and FIG. 8, (f), it is clear that super-resolution images can be reconstructed with a phase modulation. The line plot of FIG. 8, (c), is the same as that of FIG. 3, (d) and is given in FIG. 4 (red dash-dotted line), showing a resolution of 0.5 mm.

Although in these examples there are no experimental results for super-resolution imaging with a phase modulation as in FIG. 8, (a)-(f), it is possible to obtain them with an implementation shown in FIG. 9. Specifically, an annular array or a 2D array transducer can be driven by a long sine wave (RF signal) at the center frequency of the transducer to produce a narrowband focused Bessel beam or X wave. The RF sine wave can be modulated in amplitude by a low-frequency sine wave or square wave of a few cycles (turn the transmitter on and off for a few times to produce the square-wave modulation). Around the focal distance, as has been previously demonstrated, the focused Bessel beam or X wave can remotely produce a cylindrical ring of radiation force that in turn can produce a cylindrical ring of narrowband (centered at the modulation frequency) shear wave, which will propagate both inward and outward from the ring. The inward propagating shear wave will focus around the center of the ring on the z axis to produce a sharp peak and modulate the phase of the short (broadband) imaging wave pulse (a longitudinal wave such as a focused plane wave or Gaussian beam) for 2D or 3D (three-dimensional) super-resolution imaging with Eqs. (14), (19), and (20) if the highest spatial frequency of the PSF is increased due to the shear wave modulation (the width of the peak of the shear wave on the center of the cylindrical ring will be close to a half of the shear-wave wavelength that can be small to produce a high-resolution image if the modulation frequency is high and the shear-wave speed is low). Note that the same annular or 2D array transducer can be used to produce both the imaging wave and the cylindrical ring of radiation force, and the Bessel beam or X wave can be truncated on the transducer aperture to increase the total transmit power to produce a stronger radiation force to increase SNR. Also, a one-dimensional (1D) linear/phased array transducer can be used to produce shear waves for phase modulation to reconstruct super-resolution images.

Notice that unlike physical modulators such as the one used in the experiments (FIGS. 2-7), when shear wave is used as a modulator, there will be sidelobes in imaging. In FIG. 9, although a cylindrical ring of shear wave produced by a focused Bessel beam or X wave can focus on the z axis for phase modulation, high-frequency shear wave will have a high attenuation in materials such as biological soft tissues and thus the magnitude of the mainlobe of the shear wave may be reduced and the sidelobes are relatively increased. To reduce the sidelobes, rotated higher-order Bessel beams or X waves that produce unsymmetrical radiation forces may be used. Or, the images obtained with the shear waves produced by the radiation force of a focused plane wave and a focused zeroth-order Bessel beam or X wave can be subtracted to get an image of lower sidelobes in a way similar to STED while minimizing the attenuation by reducing shear wave propagation distance (also, the focused plane wave can be replaced with a Bessel beam of a small scaling parameter if needed). In addition, two shear waves of low and high frequencies respectively can be used to reduce the sidelobes through a coherent subtraction since the high-frequency shear wave has similar sidelobes as those of the low-frequency but does not have a mainlobe or has a small mainlobe magnitude due to a high attenuation.

### DISCUSSION

### Image Resolution

It is clear from Eqs. (6) (pulse-echo imaging) and (10) (wave source/field or one-way imaging) that the maximum spatial frequency of the modulated signal is increased due to a convolution of the PSF of the original imaging system with the modulation function in the spatial frequency domain. Also, if the maximum spatial frequency of the modulator is much larger than that of the original PSF, the maximum spatial frequency of the modulated PSF will be dominated by the modulator. Thus, if the radius α of the modulators in Eqs. (13) and (19) decreases, the resolution of the super-resolution images reconstructed will increase (see FIGS. 3, 4, and 8, where the resolution of the super-resolution images reconstructed is close to 0.5 mm, the diameter of the modulator). If α→0, at any given time t, the subtracted PSF in Eqs. (15), (18), (20), and (21) will be proportional to a 3D Delta function δ(r̅) that has a very large spatial bandwidth. Since the convolution of a Delta function with an object is the object itself (see Eqs. (14) and (17)), in theory, the maximum resolution that can be achieved with the PSF modulation method is unlimited.

In Eqs. (6) and (10), the modulator m(r̅) for either the amplitude or phase modulation of the PSF should be within f(r̅) or f(r̅;t), which is the case for the simulations in FIGS. 3, 4, 5, and 8, and the example in FIG. 9. However, in the experiments shown in FIGS. 3-7, the modulator was about 0.5 mm away from the objects to be imaged. This reduces the image resolution since the waves diffract after passing the modulator, and as the distance between the modulator and the object increases, the image resolution decreases.

### Noise

Although in theory the resolution of images reconstructed with the PSF modulation method is unlimited, in practice, imaging systems always have noises. From Eqs. (15), (18), (20), and (21), it is clear that as the radius α of the modulator decreases, the modulation area decreases in proportional to α² and thus the signals received (see Eqs. (14) and (17)) will decrease proportionally. If the SNR is too low to distinguish features in the reconstructed images, further reduction of a will not lead to a better image quality. This sets a limit to the maximum image resolution. Fortunately, the experiment results in FIGS. 3-7 have a high SNR, thus there is room to further increase the image resolution by decreasing a from 0.5 mm that was already about ⅓ of the wavelength used.

To increase the SNR of the reconstructed super-resolution images, the magnitude of the PSF should be maximized in the area of the modulator (see Eqs. (15), (18), (20), and (21)), although in principle, the PSF modulation method can work with an arbitrary PSF (see Eqs. (14) and (17)). To increase the PSF magnitude, both of the transmit and receive waves can be focused for pulse-echo imaging, and the receiver can be focused for wave source/field imaging, as were the cases in the experiments in FIGS. 3-7. Also, the modulation functions will affect the received signals. In the amplitude modulation given in Eq. (13), if the modulator is transparent, i.e., m(r̅₁)=m₀ when |r₁−r_{F}|≤α, where 0≤m₀<1 is a constant, the SNR will decrease as m₀→1 (more transparent) (see Eqs. (15) and (18)). For the phase modulation in Eq. (19), as ϕ₀→0, the SNR will decrease because 1−e^{iϕ}^{₀}→0 (see Eqs. (20) and (21)). Another way to increase the SNR is to use a more complicated modulator pattern m(r̅).

### Dynamic Range of the Receiver

In some implementations of the PSF modulation method, there may be a subtraction involved, as is in Eqs. (14) and (17). This means that the subtracted signals may be smaller than those before the subtraction, especially at a higher image resolution, i.e., a smaller a in Eqs. (13) and (19). For other implementations such as the high-pass filtering method, although no subtraction is used, the filtered signals may still be small as compare to those before the filtering. In this case, the receiver and its associated digitizer should have a large enough dynamic range so that the small difference signal will not be buried in the noise or lost in the quantization error. Thus, in addition to the noise, dynamic range of a receiver also may limit the maximum resolution of the reconstructed images. For the experiments in FIGS. 2-7, the digitizer has 12-bit resolution, which gives a dynamic range of about 72 dB.

System PSF and 2D Imaging with 1D Arrays

From Eqs. (2) and (3), it is clear that in principle the PSF modulation method works on an arbitrary transmit and receive beam or wave configuration in different wave-related areas such as ultrasound, electromagnetic, and optics, although some transmit and receive configurations work better than others in terms of the SNR and ease of implementations. This means that the PSF modulation method can be used with many of the current transmit/receive confirmations of the ultrasound and optical imaging systems and other configurations developed in the future. In general, the PSF may rotate and/or change its shape while moving from one place to another. If the PSF changes its shape, such changes may affect the reconstructed images. In these examples, the PSF modulation method has been demonstrated for both pulse-echo (FIGS. 3, 5, and 8) and wave source/field (FIGS. 6-7) imaging.

Since the PSF can be arbitrary, in addition to the imaging systems where a circularly-symmetric focused transducer was used (FIGS. 3, 5-8), the PSF modulation method can be applied to commercial medical ultrasound imaging systems that use 1D linear, phased, and curved array transducers to translate or steer the beams electronically to form 2D B-mode images (B-mode image is formed in an x-z plane, see the coordinates in FIG. 1 (left)). However, the super-resolution images reconstructed with a 1D array may have a lower SNR since its focusing gain may be less than that of a circularly-symmetric focused transducer or a 2D array.

### Curved Image Surface, 3D Imaging, and 4D Imaging

At each given time t, from the 3D convolution over the spatial variable r̅=(x, y, z) in Eqs. (6) and (10), it is clear that the PSF modulation method is not restricted to the 2D C-mode imaging given in the examples in FIGS. 3, 5-8. The image “plane” can be an arbitrarily curved surface, or the image can be a 3D volume. Changing the time, t, a 4D super-resolution image can be reconstructed, although a 4D imaging may take a long time since the modulated PSF must move over the entire 3D volume of the object to be imaged to perform the 3D spatial convolution.

If the spatial convolution is restricted to 2D in the x-y plane at a fixed z in R^{PE}^{ₘ} (r̅;t), 3D images can be reconstructed with a pulse-echo imaging system using the time as the third dimension. In this case, the axial resolution (the resolution along the wave propagation direction z) of the 3D image is not affected by the PSF modulation if the modulator is only a function of the space, i.e., m=m(r̅); rather, it is affected by the temporal bandwidth of the imaging system (in FIGS. 3 and 5, a short 1-cycle sine-wave pulse was used). If the modulator also is a function of time t, i.e., m=m(r̅;t), the axial resolution can be increased. However, in practice, there is always a limit on how much the temporal bandwidth of an imaging system can be increased to get higher axial and lateral resolutions due to factors such as frequency-dependent attenuation.

To keep a super-resolution in the lateral direction over an axial range in the 3D pulse-echo imaging above, the modulator should cover the axial range. In fact, except for a small f-number that is close to 1, a focused beam has a certain depth of field (or depth of focus). When a focused Bessel beam or X wave is used to produce a radiation force in FIG. 9, it will not be a thin ring, but will be a cylindrical ring with the height of the cylinder equals to the depth of field. This cylindrical ring of radiation force will produce a focused shear wave to modulate the phase of the imaging wave to obtain 3D super-resolution images within the depth of field. In this case, data acquisition for 3D C-mode super-resolution imaging will be the same as that for a 2D C-mode imaging since the signals are usually collected along the time direction anyway, as was the case for FIGS. 3 and 5, where 512 samples were acquired for each temporal signal. Similarly, when a 1D array is used, 2D super-resolution images can be obtained.

For wave source/field imaging, the 3D convolution in Eq. (10) will produce a 3D super-resolution image of the wave field in media such as biological soft tissues at a given time t, modified by the receiver impulse response PSF^{R}(r̅;t) due to the convolution in terms of time. As the time changes, a 4D image can be obtained to show an evolution of the 3D wave field over the time. Getting such a complete wave field in space at a high resolution will help to solve inverse scattering problems in imaging. If the convolution is restricted to 2D in the x-y plane at a fixed z in R^{R}^{ₘ}(r̅;t) and use a short pulse to excite the wave generator as was done in FIGS. 6 and 7, a 2D C-mode super-resolution image of the wave field at distance z and its time evolution can be obtained.

### Motion Artifacts

Using Eq. (14) or (17) to reconstruct a super-resolution image, the subtraction can be done either pixel-by-pixel or on the entire image. If the object is stationary, both methods will produce the same result. However, for moving objects such as a human heart, the result may be different. Thus, to minimize the motion artifacts, one should reconstruct the image pixel by pixel. Notice that there is no particular order in choosing a pixel, as long as the pixels cover the entire image. Also, multiple pixels can be reconstructed at once to increase the imaging speed using the camera in FIG. 1 (right).

Another way to reduce motion artifacts is to let α→0 (using a modulator of a small size for a high image resolution) in Eqs. (13) and (19). In this case, 1−m(r̅) will resemble a Delta function δ(r̅). Thus, the modulated PSF in Eq. (6) and (10) will have a very high spatial frequency as compared to the original PSF and super-resolution images can be reconstructed approximately (missing low-frequency components) by a high-pass (HP) filtering of the images to remove the contribution of the original PSF without a subtraction. However, as with the subtraction, since the magnitude of the high-frequency components becomes smaller as α→0, the SNR will reduce. Also, since the low-frequency components are dominated by the original PSF and are almost unchanged as α→0, the imaging system should have a large dynamic range to handle the small high-frequency signals.

Other method to reduce motion artifacts for super-resolution imaging is to use a wave-emitting modulator such as a quantum dot or a small modulator embedded in a wave-absorbing sheet to implement the 1−m(r̅) function with Eq. (18), (28), or (29) without a subtraction. The advantage of the method is that it does not require a very large dynamic range to reconstruct super-resolution images at a high resolution (can be a few nanometers in the case of a quantum dot).

### Super-Resolution Imaging of Flow

The spatial resolution of blood flow imaging is limited by the diffraction limit of imaging systems, except for ULM. Thus, the PSF modulation method will also benefit the blood flow imaging if the super-resolution images can be obtained fast enough so that the changes of speckles or the motion-induced phase change of the received signals can be tracked. As mentioned above, the PSF modulation method can be implemented one or multiple image pixels at a time to reduce the motion artifacts.

### Contrast Mechanism of Images

In medical ultrasound imaging, the contrast mechanism of the reconstructed super-resolution images can be backscattering coefficients (pulse-echo imaging, FIGS. 3 and 5) and ultrasound pressure field distribution (wave source/field imaging, FIGS. 6-7) using an amplitude modulation. In phase modulation using a shear wave (FIGS. 8-9), the image contrast will be related to both the local backscattering coefficients and the mechanical properties of the objects such as biological soft tissues. In general, the image contrast depends on both modulation methods and objects to be imaged. If the modulator changes its shape and value during imaging, the image contrast will include such changes.

### Modulation Methods and Implementations

In this subsection, some examples of practical implementations of the PSF-modulation method for super-resolution imaging will be presented, and theories for camera imaging systems (see FIG. 1 (right)) and optical imaging systems will be given.

### 1) General Implementation

In general, the modulation function m(r̅) in Eqs. (6) and (10) can be an arbitrary complex function, as long as corresponding image reconstruction methods can be developed. However, different m(r̅) can affect the complexity of practical implementations of the method and subsequent image reconstructions. Thus, finding an appropriate method to modulate the PSF of an imaging system of interest is a key to implement the PSF modulation method in practice.

In the present disclosure, two examples of the PSF modulation method were demonstrated: amplitude (Eq. (13)) and phase (Eq. (19)) modulations. These examples are relatively simple to implement. In general, both phase and amplitude modulations can be present at the same time. In fact, in the experiments (FIGS. 3-7), a small piece of copper wire of 0.5 mm in diameter and 1 mm in length was used as a modulator. The copper wire had a higher speed of sound than that of water and thus a phase modulation was introduced in addition to the amplitude modulation. However, the phase modulation was small because only a small amount of ultrasound can penetrate the copper wire due to an impedance mismatch. Also, if m′(r̅)=1−m(r̅) in Eqs. (13), (15), (18), (19), (20), and (21) is used as a modulator, i.e., only allow incident wave to pass through (or reflected from) a small area of radius α and block (or absorb) the wave elsewhere, or the modulator is a small particle that by itself emits waves (such as a fluorophore, a gas-filled vesicle that produces bursting sound, and a quantum dot), the subtraction in Eqs. (14) and (17) is not necessary and the imaging system could be simplified. Since particles such as quantum dots can be very small (around 3 nm for blue light and 8 nm for red light), super-resolution images of objects such as thin films can be reconstructed at a resolution that is close to the size of the quantum dot using the imaging system in either FIG. 1 (left) or FIG. 1 (right).

To understand how the super-resolution imaging works with quantum dots as modulators, assume that a uniform thin film with two small defects separated by a few nanometers apart on one of its surfaces is placed between a quantum dot (the quantum dot is on the surface that contains the defects) and a detector that is tuned to receive the specific emitting wavelength of the quantum dot (assuming that the quantum dot emits light with a constant intensity during imaging, otherwise, the variations of the intensity or the blinking of the quantum dot should be compensated). If the quantum dot is moved on the surface of the thin film by an external force remotely (such as a radiation force, magnetic/electromagnetic force for magnetic quantum dots, or other forces), the light received from the quantum dot will be dimmed twice by the two defects if the defects absorb part of the light when the quantum dot is moved over them (since the quantum dot is very close to the defects, a large portion of the light energy will be absorbed) (here it is assumed that the receiver can track the motion of the quantum dot and keep the relative position between the quantum dot and the receiver unchanged, or the PSF-weighted super-resolution imaging method is used). This will form a super-resolution absorption image of the film showing the two defects at a resolution (a few nanometers) that is similar to that of a scanning electron microscope (SEM) but without needing a vacuum and the expenses of the SEM. If the camera imaging system in FIG. 1 (right) is used (see Eqs. (28) and (29)), multiple sparsely-populated quantum dots can be used to speed up the imaging process as is in the ULM and PALM.)

As is seen above, in a practical implementation of the PSF-modulation method, the modulator can be a physical substance such as a small copper bead (FIG. 3, (a), a microbubble, a magnetic particle, an electrically-changed particle, a nanoparticle (or nanodroplet), a gas vesicle, a quantum dot, and localized fluorescent molecules in STED, or it can be created remotely as in FIG. 9. Also, in addition to moving the modulator directly by motors (FIGS. 3, 5, 6, and 7), the physical particles can be manipulated remotely using techniques based on radiation forces such as acoustical and optical tweezers, or based on electrical and magnetic forces.

To increase the SNR for super-resolution imaging, modulators (see m(T) in Eqs. (6) and (10)) of patterns that cover a larger area and contain stronger high spatial frequency components than those of the point modulators given in Eqs. (13) and (19) can be used. For example, the patterns can be 1D sinusoidal chirp strips or a 2D or 3D shape of a broad spatial bandwidth. Such patterns can be produced remotely by radiation forces or can simply be made by embedding a desired shape in a piece of material. Using such patterns as modulators, signal processing techniques such as the inverse filtering and Wiener filtering can be more effectively performed to obtain super-resolution images since the increased higher spatial frequency components of the PSF will provide additional information in the frequency ranges that would otherwise only contain noise. However, the major drawbacks of using such patterns are that the image reconstruction may be more complicated and sidelobes in the reconstructed images may be higher. For example, depending on the pattern used, tomographic image reconstruction may be needed to obtain super-resolution images.

2) Phase Modulation with a 1D Array

Below is an example of using a broadband 1D linear or phased array transducer of f=2.5-MHz center frequency and D=25-mm aperture for 2D super-resolution B-mode ultrasound imaging in a media of a speed of sound of about c=1500 m/s. If the transducer is electronically focused at a depth of z=F=100 mm, where F is the focal length, the pulse-echo FWHM diffraction-limited resolution of the imaging system can be estimated with Eq. (22) and is about 2.47 mm. If the transducer is apodized on both edges with a phase that is opposite from that on the center segment of the transducer, two focal spots near the transducer axis will be formed to produce two shear waves that will interfere when they meet on the axis. If the amplitude of a 2.5-MHz sine wave is modulated with a low frequency, say, 1 KHz, square wave for a few cycles (realized by turning on and off of the sine-wave transmission), say, 4-10 cycles (each cycle lasts 1 ms), the shear waves produced will have a narrow bandwidth with a center frequency of 1 KHz. If the speed of shear wave in the media is 1 m/s, the wavelength of the shear wave will be 1 mm. This means that the smallest width of the interference pattern of the shear wave around the transducer axis will be about ½ of the shear wave wavelength or 0.5 mm. After the interference pattern of the shear wave is formed, a broadband focused plane wave pulse can be transmitted to get a pulse-echo image. In this case, the phase of the imaging wave will be modulated by the shear wave near the axis. Repeating the shear wave generation and pulse-echo imaging sequence above on different spatial positions by electronic beam steering, a 2D super-resolution B-mode image (one dimension is in the beam steering direction and another is in the time or axial direction) with a lateral resolution close to 0.5 mm can be reconstructed after coherently subtracting the phase-modulated image from the conventional 2D B-mode image (without modulation) using Eq. (14) (the modulator can be described by Eq. (19) except that the modulator is now one dimensional but with a thickness of the depth of field (DOF) of the transducer). Because the DOF of the focused transducer is limited, the height of the 2D super-resolution B-mode image may be small, especially at a small focal distance. Thus, it is important to change the focal distance a few times and then montage a few segments of 2D super-resolution B-mode images to form an image of a larger field of view. The final super-resolution image can be superimposed on top of the conventional B-mode image to provide doctors with additional diagnosis information. Increasing the shear wave frequency from 1 KHz to 2 KHz, the image resolution can be doubled. However, as mentioned before, the ultimate limit on image resolution is the SNR of the imaging system. To reduce the sidelobes of the modulator (shear wave interference pattern), an image produced by shear waves of a very high frequency, say, 10 KHz, can be used to subtract coherently from the image produced by 1 or 2 KHz since the high-frequency shear wave contains similar sidelobes but not the interference pattern around the axis (mainlobe) due to a high attenuation.

### Using Microbubbles or Nanodroplets as Modulators

Microbubbles in the ultrasound localization microscopy (ULM) can be used as modulators to implement the PSF-modulation method to reconstruct a super-resolution image of blood vessel walls and their surrounding soft tissues using Eq. (14) if the microbubbles are immediately above the vessel walls so that ultrasound beam reaches the microbubbles before hitting the vessel walls in a way similar to the experiments in FIGS. 3-5 (if the microbubbles are immediately below the vessel walls, super-resolution images of a different contrast mechanism may be reconstructed in a way similar to the super-resolution imaging with quantum dots above). Because the signals from the blood are much smaller than those from the blood vessel walls and soft tissues if the ultrasound frequency used is not too high, say, 15-25 MHz, the area of blood will appear dark in the reconstructed super-resolution image. The ability to get microscopic images of blood vessel walls and surrounding soft tissues deep in the body will help to distinguish benign tumors from malignant without resorting to invasive biopsy or invasive intravascular ultrasound (IVUS) imaging that does not work in capillaries. To implement the method, after localizing the centers of the sparsely-populated microbubbles in each frame of RF B-mode image, the RF A-lines through the centers of the microbubbles are subtracted with those obtained before the microbubble injection (or with those in the nearby image frames in which these microbubbles have moved to elsewhere). The subtraction can be done within a short time window (say, a half period of the imaging wave) in which the isolated microbubbles are present. Tracking the individual microbubbles over multiple frames of the RF B-mode images acquired at a very high image frame rate and using the technique above to realign the axial positions of each microbubble or to use the “I” and “Q” components of the RF signals without the need of the realignment, the DC component C^{PE}(t) in Eq. (16) can be removed as long as the microbubble and the magnitude of the PSF do not change significantly at the tracked positions of each microbubble (setting a proper time-gain-control (TGC) curve will help to minimize the change of the magnitude of the PSF). The subtracted RF signals that represent the center locations of the microbubble can be superposed incoherently in a way similar to that was done in the experiments in FIGS. 3-7 to get multiple pixels of the final image. Accumulating a large number of pixels processed will result in a super-resolution image of the blood vessel walls and their surrounding soft tissues. When tracking a microbubble, if it starts to move out of the plane in the elevation direction of a 1D array transducer, those positions should be ignored. To avoid microbubbles moving out of plane, a 2D array transducer for 3D B-mode imaging can be used. To increase the SNR, the size of the microbubbles can be increased to, say, 10 μm or larger, or the ultrasound frequency is increased from, say, 25 MHz. Because C^{PE} (t) may be large for microbubbles, the imaging system may need to have a large dynamic range.

Notice that instead of using the microbubbles as in the ULM above, activated phase-change perfluorocarbon nanodroplets can be used as modulators to obtain nanoscale super-resolution images of the interior of the cells using the PSF-modulation method if the perfluorocarbon nanodroplets activated have a similar size (the activations can be controlled by laser or ultrasound). In addition to pulse-echo imaging, the phase-change perfluorocarbon nanodroplets also can be used as modulators in transmission super-resolution imaging (see the camera in FIG. 1 (right)) of the interior of the cells at a nanoscale resolution using Eqs. (28) or (29). The advantage of using transmission imaging is that the received signals due to C^{R}(r̅;t) in Eq. (11) may be much smaller than those of C^{PE} (t) in Eq. (7).

### 4) Camera Imaging System

For the camera in FIG. 1 (right), the PSF-modulation method also can be implemented to get super-resolution images (notice that FIG. 1 (right) can represent many imaging systems such as conventional bright-field optical microscopes, mobile optical microscopes based on cell phones, acoustical cameras, and so on). Assuming that the camera is an LSI system, the image on the receiver array of the camera can be written as (see Eq. (9)):

$$( 24 )$$

$${R}_{c}^{R} ( α \vec{r} ; t ) = \text{?} {PSF}_{c}^{R} ( α \vec{r} - α {\vec{r}}^{′} ; t - {t}^{′} ) f ( {\vec{r}}^{′} ; {t}^{′} ) d {\vec{r}}^{′} {dt}^{′} = {PSF}_{c}^{R} ( α \vec{r} ; t ) \text{?} f ( \vec{r} ; t )$$

$$\text{?} \text{indicates text missing or illegible when filed}$$

where f(r̅;t) is an object function that can represent the spatial wave field on the object plane at any given time, is the PSF_{c}^{R}(αr̅;t) of the camera, the subscript “c” in Eq. (24) means “camera”, α=1/σ>0 is a real number, and σ is the magnification of the imaging system. Multiplying the object function with a modulator m(αr̅″-αr̅), where r̅″ is the amount of the shift of the modulator in the object plane gives:

$$\begin{matrix}\text{?} ( α \vec{r} ; α {\vec{r}}^{″} ; t ) = \text{?} {PSF}_{c}^{R} ( α \vec{r} - α {\vec{r}}^{′} ; t - {t}^{′} ) [ f ( {\vec{r}}^{′} ; {t}^{′} ) m ( α {\vec{r}}^{″} - α {\vec{r}}^{′} ) ] d {\vec{r}}^{′} {dt}^{′} \\ + {C}_{c}^{R} ( α \vec{r} ; α \text{?} ; t ) = {PSF}_{c}^{R} ( α \vec{r} ; t ) \text{?} [ f ( \vec{r} ; t ) m ( α {\vec{r}}^{″} - α \vec{r} ) ] \\ + {C}_{c}^{R} ( α \vec{r} ; α {\vec{r}}^{″} ; t )\end{matrix} \qquad ( 25 )$$

$$where$$

$$\begin{matrix}{C}_{c}^{R} ( α \vec{r} ; α {\vec{r}}^{″} ; t ) = \text{?} {PSF}_{c}^{R} ( α \vec{r} - α {\vec{r}}^{′} ; t - {t}^{′} ) [ f ( {\vec{r}}^{′} ; {t}^{′} ) {γ}_{m}^{R} ( α {\vec{r}}^{″} - α {\vec{r}}^{′} ) ] d {\vec{r}}^{′} {dt}^{′} \\ = {PSF}_{c}^{R} ( α \vec{r} ; t ) \text{?} [ f ( \vec{r} ; t ) {γ}_{m}^{R} ( α {\vec{r}}^{″} - α {\vec{r}}^{′} ) ]\end{matrix} \qquad ( 26 )$$

$$\text{?} \text{indicates text missing or illegible when filed}$$

Setting r̅″=r̅, Eqs. (25) becomes:

$$\text{?} ( α \vec{r} ; t ) = \text{?} [ {PSF}_{c}^{R} ( α \vec{r} - α {\vec{r}}^{′} ; t - {t}^{′} ) m ( α \vec{r} - α {\vec{r}}^{′} ) ] f ( {\vec{r}}^{′} ; {t}^{′} ) d {\vec{r}}^{′} {dt}^{′} + {C}_{c}^{R} ( α \vec{r} ; t ) [ {PSF}_{c}^{R} ( α \vec{r} ; t ) m ( α \vec{r} ) ] \text{?} f ( \vec{r} ; t ) + {C}_{c}^{R} ( α \vec{r} ; t ) \qquad ( 27 )$$

$$\text{?} \text{indicates text missing or illegible when filed}$$

where C_{c}^{R}(αr̅;t)=[PSF_{c}^{R}(αr̅;t)γₘ^{R}(αr̅)] [symbol] _{γ̅,t} f(r̅;t). Eq. (27) is the same as Eq. (10) except that it has a constant spatial scaling factor α and γₘ^{R}(αr̅) is a part of the modulator as explained above around Eq. (11). Subtracting Eq. (27) from Eq. (24), super-resolution images can be reconstructed using a modulator that is similar to the one given in either Eq. (13) or Eq. (19):

$${R}_{c}^{{R}_{sub}} ( α \vec{r} ; t ) = {R}_{c}^{R} ( α \vec{r} ; t ) - \text{?} ( α \vec{r} ; t ) = \text{?} {PSF}_{c}^{R} ( α \vec{r} - α {\vec{r}}^{′} ; t - {t}^{′} ) [ 1 - m ( α \vec{r} - α {\vec{r}}^{′} ) ] ( {\vec{r}}^{′} ; {t}^{′} ) d {\vec{r}}^{′} {dt}^{′} - {C}_{c}^{R} ( α \vec{r} ; t ) = \{ PS \text{?} ( α \vec{r} ; t ) [ 1 - m ( α \vec{r} ) ] \} \text{?} f ( \vec{r} ; t ) + {C}_{c}^{R} ( α \vec{r} ; t ) \qquad ( 28 )$$

$$\text{?} \text{indicates text missing or illegible when filed}$$

Eq. (28) can be implemented as follows. Taking two images with the camera, one with (see Eq. (25)) and another without (see Eq. (24)) the modulator m(αr̅″−αr̅), which has a small size compared to the PSF and is placed in the object plane at position r̅″=(x″, y″). Then, subtract the first image from the second image to get a pixel (at αr̅) of the super-resolution image after setting r̅″=r̅=(x, y) (see Eq. (28)) and incoherently superposing the resulting temporal signal over about a half period of the imaging wave. To increase the SNR, instead of setting r̅″=r̅, the subtracted image at a given r̅″.

$$( 29 )$$

$${R}_{c}^{{R}_{sub}} ( α \vec{r} ; α {\vec{r}}^{″} ; t ) = {PSF}_{c}^{R} ( α \vec{r} ; t ) \text{?} \{ f ( \vec{r} ; t ) [ 1 - m ( α {\vec{r}}^{″} - α \vec{r} ) ] \} - {C}_{c}^{R} ( α \vec{r} ; α {\vec{r}}^{″} ; t )$$

$$\text{?} \text{indicates text missing or illegible when filed}$$

can be integrated over αr̅ that represents the aperture of the receiver array. Moving the modulator over the object in the object plane by changing r̅″ and repeating the process above, a super-resolution image that is a filtered version of f(r̅;t) (due to convolution [symbol] with the PSF) can be reconstructed. If the modulator changes its position in the z (axial) direction while moving, Eqs. (28) or (29) can still be used as long as the magnitude of the PSF does not change significantly (see the explanations above). To increase the imaging speed, as is in the ULM or PAML, multiple randomly-distributed modulators can be used to get multiple pixel values of the super-resolution image at once as long as the diffraction-limited images of these modulators do not overlap with each other on the receiver aperture. Accumulating multiple frames of such images, the final super-resolution image can be obtained. Note that if the receiver array also is used as a transmitter to illuminate the object with a plane wave, the camera can be viewed as a pulse-echo imaging system where Eqs. (4) and (6), instead of Eqs. (9) and (10) (or Eqs. (24), (25), and (27)), can be used to reconstruct super-resolution images.

An interesting application of using multiple modulators with the camera in FIG. 1 (right) is to image objects such as proteins with an apparatus that is similar to a scaled-down electrophoresis. Embedding the objects in a thin gel or a scaffold that is placed in the object plane within the depth of focus of the camera and letting the objects be illuminated from the opposite side of the receiver array, a nanoscale super-resolution image of the objects can be reconstructed using Eqs. (28) or (29) by taking multiple images at a high frame rate while sparsely-distributed, uniformly-sized, and opaque nanoparticles (used as modulators) are moving randomly through the gel or scaffold under an electrical (for charged nanoparticles) or magnetic (for magnetic nanoparticles) force.

The advantages of using the camera in FIG. 1 (right) as compared to the imaging system in FIG. 1 (left) is that the diffraction-limited image of the object can be viewed directly, which helps to locate the region of interest for super-resolution imaging. Also, using the localization technique for microbubble (in ULM) or fluorescent light (in PALM), the center position(s) of the diffraction-limited image(s) of the modulator(s) (such as nanoparticle(s)) on the receiver array can be accurately determined with the camera. In addition, using the camera, there is no need to scan a focused beam point-by-point along with the modulator to form an image, simplifying the imaging system.

### 5) Optical Imaging Systems

In an optical imaging system, intensity of the waves is usually measured. Thus, in some implementations where coherent processing (summation or subtraction) is needed, the phase of the optical signals needs to be recovered by techniques such as holographic, iterative, and neuro network methods for the PSF-modulation method to work. However, in an optical protein (or other substance) super-resolution imaging using the camera in FIG. 1 (right) and multiple sparsely-populated moving modulators mentioned above (the sparsity of the modulators is to ensure that each modulator can be treated individually as in the ULM or PALM), a continuous coherent subtraction can be accomplished by an interferometer method to get images in Eq. (28) or (29). In the subtraction process, the modulators move and the delay time between the two arms of the optical signals is adjusted so that there is no overlap of the diffraction-limited images of each modulator before and after it moves and thus the center or the averaged value in the area of the subtracted image of the modulator can be determined. Accumulating multiple frames of images in which the centers or the averaged values in the areas of the subtracted images of the modulators are obtained, super-resolution images can be reconstructed. Because of a limited coherent length of the optical wave, the speed of the modulators must be high and thus a high-speed camera is needed to snap the subtracted images. Due to the use of a high-speed camera and fast-moving modulators, dynamics of the objects (such as protein dynamics) can be studied at both high temporal and spatial resolutions.

Although in principle, one needs to know the phase of optical signals for a coherent subtraction, in some cases, the coherent subtraction to reconstruct super-resolution images can be implemented approximately using the light intensity directly. Assuming that the light signals S=Sₜ+s_{N} (intensity I=|S|²) and Sₘ=Sₜ+sₘ (intensity Iₘ=|Sₘ|²) at a spatial position are received respectively by a point detector before and after introducing a modulator that modifies s_{N} to sₘ (see FIG. 1), where

$${S}_{1} = {\sum }_{i = 1}^{N - 1} {s}_{i} ,$$

sᵢ are component signals within a diffraction-limited resolution cell of an object to be imaged, i=1,2,3, . . . , N, the subscript “m” means “modulation”, and N is an integer. Because I_{sub}=I−Iₘ=s_{N}s*_{N}−sₘs*ₘ+(s*_{N}−s*ₘ)Sₜ+(s_{N}−sₘ)S*ᵢ, where the subscript “sub” means “subtraction” and the superscript “*” means “conjugate”, if the phase of sᵢ can be ignored (i.e., the relative phases among sᵢ do not change significantly, for example, the object is thin), then I_{sub}=s_{N}²−sₘs*ₘ+(2s_{N}−sₘ−sₘ*)Sₜ. sₘ=s_{N}, i.e., the modulator is transparent, I_{sub}=0, which is expected. If sₘ=0, i.e., the modulator blocks s_{N} completely, I_{sub}=s_{N}²+2s_{N}Sₜ=(s_{N}+2Sₜ)s_{N}. If |S_{N}|∩2|Sₜ| (this is the case for a modulator of a small size) and Sₜ is approximately a constant from one spatial position to another, I_{sub}≈(2Sₜ)s_{N} is proportional to the signal s_{N} blocked by the modulator and thus a super-resolution image of the object can be reconstructed using Eq. (28) or (29). If sₘ=s_{N}e^{iϕ}^{₀}, i.e., the modulator causes a pure phase modulation with a constant phase shift 0<ϕ₀≤2π, then I_{sub}=2[1−cos(ϕ₀)]Sᵢs_{N}. It is clear that in this case, if Sₜ is approximately a constant from one spatial position to another, I_{sub} is proportional to s_{N} and thus super-resolution images of the object also can be reconstructed. Apparently, as ϕ₀→0, I_{sub}→0. The phase modulation to reconstruct super-resolution images is similar to that given in FIGS. 8 and 9, and in the example above “Phase Modulation with a 1D Array”. Notice that the phase modulation can be accomplished by using either a physical particle or shear wave as a modulator. If sₘ=m₀s_{N}e^{iϕ}^{₀}, where 0≤m₀≤1 is a constant, i.e., the modulator may cause both amplitude and phase modulations, then I_{sub}=(1−m₀²)s_{N}+2[1−m₀ cos(ϕ₀)]Sₜs_{N}, which gives pure amplitude and phase modulations respectively when m₀=0 and m₀=1 as given above. If (1−m₀²)s_{N}² can be ignored and Sₜ is approximately a constant, I_{sub}≈2[1−m₀ cos(ϕ₀)]Sₜs_{N} can be used to reconstruct super-resolution images. Again, multiple sparsely populated modulators can be used to speed up the image reconstruction if all modulators have a similar size, shape, opacity m₀, and phase ϕ₀.

Other applications in optics include the wide-field lensless in-line digital holographic imaging system. In such a system, a narrowband point light source from a far distance (a few centimeters) is used to illuminate a thin layer of object such as cells grown on a thin glass petri dish and a Charge-Coupled Device (CCD) or Complementary Metal-Oxide-Semiconductor (CMOS) sensor array that is placed in parallel with and at about a few hundreds of micrometers behind the object plane is used to record the interference pattern. Both amplitude and phase images of the object can be reconstructed approximately by backpropagating the angular spectrum of the recorded holographic interference pattern to the object plane under the assumption that the waves scattered from the object is much weaker than the incident wave. If nanoparticles such as magnetic nanoparticles are introduced to the fluid media where the object such as live cells are located, super-resolution images of the cells can be reconstructed at a nanoscale resolution in a way similar to obtaining super-resolution images using the camera in FIG. 1 (right) above. The magnetic nanoparticles can be moved randomly by a changing force of an external magnetic or electromagnetic field, and the CCD or CMOS receiver array is used to take pictures of the resulting interference patterns continuously for image reconstruction. (Notice that replacing the optical wave with ultrasound and choosing appropriate parameters, super-resolution in-line acoustical holographic images can be reconstructed using a narrowband plane-wave illumination. Unlike optics, both the amplitude and phase of the waves on the receiver array can be obtained in ultrasound and thus images can be reconstructed without the twin-image artifacts by backpropagating the angular spectrum of the received signals to the object plane.)

Another possible application of the PSF-modulation method is optical coherence tomography (OCT) that is similar to an ultrasound B-mode imaging system to get super-resolution images with a deeper penetration if the phase of the signals can be obtained and proper modulators can be found.

Also, if a fluorescent light could be used as a modulator, nanoscale imaging would be possible by directly using either STED or PALM.

### 6) Other LSI Imaging Systems

Since, in principle, Eqs. (4), (6), (9), and (10) work for any LSI system to get super-resolution images, the PSF-modulation method should work for various imaging systems such as magnetic resonance imaging (MRI) if the modulated PSF has a higher spatial frequency. Also, for nondestructive evaluation (NDE) of materials and other areas of science and engineering, the PSF-modulation method can be used for super-resolution imaging on some surfaces that are difficult to be inspected by sensors or near-field imaging techniques due to conditions such as high temperature, limited space access, and hazardous environment that may damage sensors. As mentioned before, to speed up imaging, multiple modulators can be used as long as their diffraction-limited images do not overlap and the modulators are identical.

The PSF-modulation method also can be applied to scanning acoustical microscopy (SAM) or other similar imaging systems for super-resolution imaging (see FIG. 1 (left)). In such imaging systems, a modulator (such as a microbubble, a small particle, a particle that by itself emits waves, and a small hole or particle embedded in a thin sheet of material that is larger than the focal spot of the transducer) is fixed at the center of the focal area of the transducer and an object is scanned in the object plane as in FIGS. 3, 5-8. The transducer can be used either in a pulse-echo or receiver-only mode (in the receive-only mode, the object can be illuminated from the opposite side of the transducer). Also, the modulator can be placed either on the top or bottom surface of the object (or even inside the object). To fix the position of the modulator relative to the transducer, the modulator can be held in position by an external force, confined in a microchannel, or embedded in a thin sheet of material. If a microchannel is used, it can be placed with the object while the modulator moves through the microchannel to keep the relative position of the modulator and the transducer unchanged to reconstruct a line of super-resolution image. Translating the microchannel in the direction that is perpendicular to the microchannel, super-resolution images can be obtained line by line. If multiple parallel microchannels are used, the translation of the microchannel is not necessary. If a modulator embedded in a thin sheet of wave-absorbing material is used, where the modulator can simply be a small hole or another material that allows the waves to penetrate (or to reflect/scatter) to implement the modulation function m′(r̅)=1−m(r̅) (see Eqs. (13), (15), (18), (19), (20), and (21)), the object can be slid under (when the modulator is transparent) or above (when the modulator is a reflector/scatterer) the sheet of the material to reconstruct super-resolution images in the pulse-echo imaging system without needing a subtraction (the object can be a thin slice of specimen). In a transmission imaging system, if the modulator is a small hole on a thin sheet of wave-absorbing/blocking material, or if a wave-emitting modulator is used, super-resolution images also can be reconstructed without subtraction. If the camera system in FIG. 1 (right) is used, multiple sparsely-populated modulators can be used to speed up the image reconstruction as mentioned before. The major advantages of super-resolution imaging with m′(r̅) above are that the dynamic range of the imaging system does not have to be very large and the motion artifacts can be reduced.

In terms of the wave source/filed imaging such as the photoacoustic imaging, it is possible to reconstruct super-resolution images using the PSF-modulation method by injecting small physical modulators into the body or producing shear waves remotely for phase modulation. Notice that the injected modulators can change both the absorption of the light near the locations of the modulators and the ultrasound waves produced by the heating of the light to contribute to the contrast of the reconstructed super-resolution images.

In underwater acoustics, fishes or other substances moving randomly could also be used as modulators to get super-resolution images of the seabed/riverbed terrain (two-way), the sinking ships/objects (two-way), noise pattern emitted from submarines/underwater vehicles (one-way), and other underwater objects if the moving fishes or other substances are sparsely populated and are close to the objects or the wave source/field to be imaged. Since the sizes of the fishes may be different and the shape of each fish may change in the direction of the impinging waves, compensation for such changes is needed for the reconstruction of super-resolution images.

### PSF-Weighted Super-Resolution Imaging

In this subsection, the theory developed above is extended to simplify the imaging system by keeping both the transducer and object to be imaged stationary during imaging.

Assuming in FIG. 1 (left) that both the transducer and the object f(r̅) to be imaged are stationary in space and the PSF of an LSI and LTI pulse-echo imaging system is PSF^{PE} (r̅;t), the signal received by the transducer is given by (see Eq. (4)):

$${R}_{w}^{PE} ( t ) = {\int }_{\vec{r}} {PSF}^{PE} ( \vec{r} ; t ) f ( \vec{r} ) d \vec{r} \qquad ( 30 )$$

where the subscript “w” means “weighted”. Adding a modulator and m(r̅) then moving it in the space, an image can be formed (see Eq. (6)):

$${R}_{w}^{{PE}_{m}} ( \vec{r} ; t ) = \text{?} [ {PSF}^{PE} ( {\vec{r}}^{′} ; t ) f ( {\vec{r}}^{′} ) ] m ( \vec{r} - {\vec{r}}^{′} ) d {\vec{r}}^{′} + {C}_{w}^{PE} ( \vec{r} , t ) = [ {PSF}^{PE} ( \vec{r} ; t ) f ( \vec{r} ) ] \text{?} m ( \vec{r} ) + {C}_{w}^{PE} ( \vec{r} , t ) \qquad ( 31 )$$

$$\text{?} \text{indicates text missing or illegible when filed}$$

where C_{w}^{PE}(r̅,t) is given by (see Eq. (7)):

$${C}_{w}^{PE} ( \vec{r} , t ) = \text{?} {PSF}^{PE} ( {\vec{r}}^{′} ; t ) {γ}_{m}^{PE} ( \vec{r} - {\vec{r}}^{′} ) d {\vec{r}}^{′} = {PSF}^{PE} ( \vec{r} ; t ) \text{?} {γ}_{m}^{PE} ( \vec{r} ) \qquad ( 32 )$$

$$\text{?} \text{indicates text missing or illegible when filed}$$

and γₘ^{PE}(r̅) was explained above under Eq. (7). Subtracting Eq. (31) from Eq. (30) gives (see Eq. (14)):

$$( 33 )$$

$${R}_{w}^{{PE}_{sub}} ( \vec{r} ; t ) = {R}_{w}^{PE} ( t ) - {R}_{2}^{{PE}_{m}} ( \vec{r} ; t ) = [ {PSF}^{PE} ( \vec{r} ; t ) f ( \vec{r} ) ] {*}_{\vec{r}} [ 1 - m ( \vec{r} ) ] - {C}_{w}^{PE} ( \vec{r} ; t )$$

From Eq. (33), 4D (3D in space plus 1D in time) PSF-weighted super-resolution images of the function PSF^{PE} (r̅;t)f(r̅) at any given time t can be reconstructed if the maximum spatial frequency of the function [1−m(r̅)] is higher than that of the point spread function PSF^{PE} (r̅;t) and C_{w}^{PE}(r̅;t) is a constant at any given time t. In a plane-wave pulse-echo imaging system, PSF^{PE}(r̅;t) is a constant at a given distance z and time t (assuming that the plane wave propagates in the z direction), PSF^{PE}(r̅;t)f(r̅)=f(r̅) and thus a super-resolution C-mode image of f(r̅) can be reconstructed. In fact the wave produced by a focused disc transducer at its focal distance can be approximated with a plane wave near the z axis and thus f(r̅) can be reconstructed if the image field of view is small compared to the focal size. In the case of plane wave, C_{w}^{PE} (r̅;t) is a constant at any given time t and thus it can be removed from the reconstructed images. If the modulator also moves in the z direction while getting the C-mode image, such motion can be compensated using the method given in the Theoretical Preliminaries above.

Similarly, assuming that f(r̅;t) represents a spatial field of a wave source at any given time t, 4D PSF-weighted super-resolution images of the wave field can be reconstructed using the signals received by a receiver (one-way imaging). Keeping the wave source and the receiver stationary in space, the received signal is given by (see Eq. (9)):

$$( 34 )$$

$${R}_{w}^{R} ( t ) = \text{?} {PSF}^{R} ( {\vec{r}}^{′} ; t - {t}^{′} ) f ( {\vec{r}}^{′} ; {t}^{′} ) d {\vec{r}}^{′} {dt}^{′} = \text{?} f [ {PSF}^{R} ( {\vec{r}}^{′} ; t ) \text{?} f ( {\vec{r}}^{′} ; t ) ] d {\vec{r}}^{′}$$

$$\text{?} \text{indicates text missing or illegible when filed}$$

Adding a modulator m(r̅) and then moving it in space, an image is obtained as follows (see Eq. (10)):

$${R}_{w}^{{R}_{m}} ( \vec{r} ; t ) \text{?} [ {PSF}^{R} ( {\vec{r}}^{′} ; t - {t}^{′} ) f ( {\vec{r}}^{′} ; {t}^{′} ) ] m ( \vec{r} - {\vec{r}}^{′} ) d {\vec{r}}^{′} {dt}^{′} + {C}_{w}^{R} ( \vec{r} , t ) = [ {PSF}^{R} ( \vec{r} ; t ) \text{?} f ( \vec{r} ; t ) ] \text{?} m ( \vec{r} ) + {C}_{w}^{R} ( \vec{r} , t ) \qquad ( 35 )$$

$$\text{?} \text{indicates text missing or illegible when filed}$$

where C_{w}^{R}(r̅;t) is given by (see Eq. (11)):

$${C}_{w}^{R} ( \vec{r} , t ) = \text{?} {PSF}^{R} ( {\vec{r}}^{′} ; t - {t}^{′} ) f ( {\vec{r}}^{′} ; {t}^{′} ) ] {γ}_{m}^{R} ( \vec{r} - {\vec{r}}^{′} ) d {\vec{r}}^{′} {dt}^{′} = [ {PSF}^{R} ( \vec{r} ; t ) \text{?} f ( \vec{r} ; t ) ] \text{?} {γ}_{m}^{R} ( \vec{r} ) \qquad ( 36 )$$

$$\text{?} \text{indicates text missing or illegible when filed}$$

Comparing Eq. (36) with Eq. (35), it is clear that γₘ^{R}(r̅) is a part of m(r̅), as was explained above around Eq. (11). Subtracting Eq. (35) from Eq. (34) gives (see Eq. (17)):

$$( 37 )$$

$${R}_{w}^{{R}_{sub}} ( \vec{r} ; t ) = {R}_{w}^{R} ( t ) - {R}_{w}^{{R}_{m}} ( \vec{r} ; t ) = [ {PSF}^{R} ( \vec{r} ; t ) \text{?} f ( \vec{r} ; t ) ] \text{?} [ 1 - m ( \vec{r} ) ] - {C}_{w}^{R} ( \vec{r} , t )$$

$$\text{?} \text{indicates text missing or illegible when filed}$$

Similar to the case of pulse-echo imaging system, PSF^{R}(r̅;t)*, f(r̅;t) at any given time t can be reconstructed. Using a receiver of a plane-wave response (or a focused wave in the focal area), at a given distance z, PSF^{R}(r̅;t) will only be a function of time t when the plane wave vector is in the z direction. In this case, PSF^{R}(r̅;t)*, f(r̅;t)=PSF^{R}(z;t)*, f(r̅;t) and a super-resolution C-mode image of PSF^{R}(z;t)*, f(r̅;t) can be reconstructed at a fixed z and time t, which is a filtered version of f(r̅;t). Also, using a modulator that is a wave emitter such as the quantum dot, PSF-weighted super-resolution imaging at a nanoscale resolution (a few nanometers) is possible without a subtraction. If the modulator changes its position in the z direction during the C-mode imaging, Eq. (37) can still be used as long as the magnitude of the PSF does not change significantly (see explanations above in the Theoretical Preliminaries).

Compared to the PSF-modulation method (except for the camera in FIG. 1, right), the major advantages of the PSF-weighted super-resolution imaging are that only the modulator needs to be moved in space (or randomly produced one by one) and only one reference signal in either Eq. (3) or Eq. (34) is needed, which simplifies the imaging system. The disadvantages are that the reconstructed images may be weighted by the PSF as in Eqs. (33) and (37), it is difficult to use multiple modulators moving randomly to speed up the imaging speed (unlike the camera in FIG. 1 (right), the signals from the multiple modulators will be mixed), and the field of view of the images may be limited when a focused wave is used or the SNR is lowered when a plane wave is used.

### Conclusion

Methods (PSF modulation and PSF-weighted) and systems for 4D super-resolution imaging of a passive object or a wave source/field have been developed by modulating the PSF of an LSI and LTI imaging system. Theories of the methods have been presented, and computer simulations and experiments have been conducted. Although in theory the spatial resolution of the reconstructed images is unlimited, the resolution is limited by the SNR in practice. The modulator can be created remotely or can be a physical object manipulated remotely. The methods can be applied to areas such as acoustics, ultrasound, optics, and electromagnetics. With a proper selection of a modulator and an imaging system, nanoscale imaging is possible with the methods and systems.

### Example II—Remote Super-Resolution Mapping of Wave Fields

Mapping wave field in space has many applications such as optimizing design of radio antennas, improving and developing ultrasound transducers, and planning and monitoring the treatment of tumors using high-intensity focused ultrasound (HIFU). Currently, there are methods that can map wave fields remotely or locally. However, there are limitations with these methods. For example, when mapping the wave fields remotely, the spatial resolution is limited due to a poor diffraction-limited resolution of the receiver, especially when the f-number of the receiver is large. To map the wave fields locally, the receiver is either subject to damage in hazardous environments (corrosive media, high temperature, and high wave intensity, etc.) or difficult to be placed inside an object. To address these limitations, in this example, the PSF-modulation super-resolution imaging method described in Example I was applied to map pulse ultrasound wave fields remotely at a high spatial resolution, overcoming the diffraction limit of a focused receiver. For example, to map a pulse ultrasound field of a full-width-at-half-maximum (FWHM) beam width of 1.24 mm at the focal distance of a transmitter, the FWHM beam widths of the super-resolution mapping of the pulse wave field with a spherical glass modulator of 0.7-mm diameter at two receiver angles (00 and 45°) were about 1.13 mm and 1.22 mm respectively, which were close to the theoretical value of 1.24 mm and were much smaller than the diffraction-limited resolution (1.81 mm) of the receiver. Without using the super-resolution method to remotely map the same pulse wave field, the FWHM beam width was about 2.06 mm. For comparison, the FWHM beam width obtained with a broadband (1-20 MHz) and 0.6-mm diameter polyvinylidene fluoride (PVDF) needle hydrophone was about 1.41 mm. In addition to the focused pulse ultrasound wave field, a pulse Bessel beam near the transducer surface was mapped remotely with the super-resolution method, which revealed high spatial frequency components of the beam.

Mapping of wave fields in space has many applications in both science and engineering. For example, mapping of electromagnetic waves can help in circuit design, antenna optimization, and understanding of the interactions between materials and the electromagnetic waves. In ultrasound, there are also many applications in mapping of wave fields. These include mapping high-intensity focused ultrasound (HIFU) beam for targeted therapy, and planning and monitoring of tumor treatment; mapping ultrasound transducer radiation patterns to improve transducer designs and characterizations, and optimize ultrasound beams for medical imaging, and nondestructive evaluation (NDE) of materials.

To map a wave field, a sensor of a small size can be placed in the field point by point in space. Small sensor size can reduce the spatial average effects of the sensor aperture and thus increase the spatial resolution of the mapped wave field. However, small sensors are usually delicate, fragile, and less sensitive. In the case of ultrasound, a small Polyvinylidene fluoride (PVDF) hydrophone is usually used to map ultrasound wave field. Such a hydrophone can be damaged at high ultrasound intensity, high temperature, or in corrosive media. It also has a small capacitance and thus has high output impedance, which makes it difficult to drive a long cable. In addition, its sensitivity is usually lower than that of a larger focused transducer.

For mapping ultrasound wave fields of a higher intensity, lead zirconate titanate (PZT) transducers that are more robust than the PVDF hydrophones can be used. However, such transducers also have a limitation in the power that they can handle before nonlinearity and thermal effects start to impact their performance. Alternatively, ultrasound wave fields of a range of intensities can be mapped by optical fibers that are based on Fresnel reflection from the tip surface of the fiber, two-beam interferometer to detect phase change between the measurement and reference beams, or Fabry-Perot interferometer that increases its sensitivity by multiple reflections within two parallel mirrors on the fiber tip, etc. Some of the optical fiber methods can map the ultrasound wave fields at a very high intensity. However, optical fiber systems are much more expensive than those using either a PVDF hydrophone or a PZT transducer.

To avoid damaging delicate sensors such as PVDF hydrophones at a high ultrasound intensity or in a hazardous environment, a small scattering object such as the tip of an optical fiber has been used to scatter ultrasound waves that are then received by a larger transducer to map or characterize the ultrasound wave fields. However, such method cannot be used when there are other scattering objects such as biological soft tissues in the wave fields to be mapped, or, when part of the ultrasound waves from the wave source can reach the receiver directly.

All of the methods above are difficult to measure ultrasound wave field inside objects such as biological soft tissues since it is difficult to place a PDVF hydrophone, a PZT transducer, or an optical fiber at various spatial points inside the objects. To overcome such difficulties, a large focused ultrasound transducer can be placed remotely outside the objects and then the focal point of the transducer can be scanned from one spatial position to another to map the ultrasound wave fields inside the objects. However, there are a few problems with this approach: Firstly, due to refraction, reflection, scattering, and attenuation of ultrasound waves inside some objects, it may be difficult to know the positions of the focal point of the receiver. Secondly, the scattering coefficient inside the objects may change from one spatial position to another, which can cause object-dependent errors when mapping the ultrasound wave fields inside the objects. Thirdly, the focused receiver has a diffraction limited resolution that is usually much larger than one-half of a wavelength of the ultrasound wave, especially when the f-number of the receiver (focal length divided by the diameter of the aperture of the receiver) is large. Fourthly, in uniform media such as water, if no waves propagate in the direction of the receiver, the wave fields cannot be mapped. Even if some waves can reach the receiver, the mapped wave fields will be dependent on the position of the receiver and thus may be inaccurate.

To increase the spatial resolution and avoid the errors caused by a nonuniform scattering coefficient of objects such as biological soft tissues and the position-dependent errors of the receiver when mapping the ultrasound wave fields remotely, the point-spread function (PSF) modulation super-resolution imaging method can be used. In this method, two measurements of the waves with and without a small modulator introduced at a spatial point can be made (the modulator can be a wave absorber, a scatterer, and/or a phase shifter). Then, one measurement is subtracted from another to obtain a difference caused by the modulator to obtain a super-resolution mapping of the wave fields at that spatial point. Scanning the receiver along with the modulator from one spatial position to another, the entire wave fields in space can be mapped at a spatial resolution determined by the size of the modulator. As the size of the modulator is reduced, the spatial resolution will increase. In theory, there is no limit on the spatial resolution, however in practice, the image resolution is limited by the signal-to-noise ratio (SNR) of the measurement system. Since the modulators can be small and of a uniform size and a uniform property in terms of absorption, scattering, and phase-shift, they can be injected into some objects such as biological soft tissues where there may be channels or a network of blood vessels, to allow an accurate mapping of ultrasound wave fields remotely inside the objects. If the modulator positions inside the objects can be accurately determined by a plane-wave pulse-echo imaging method or other particle localization methods, there will be no distortions to the shape of the mapped ultrasound wave fields. Using multiple modulators can speed up the wave field mapping process if the images of the modulators can be treated individually.

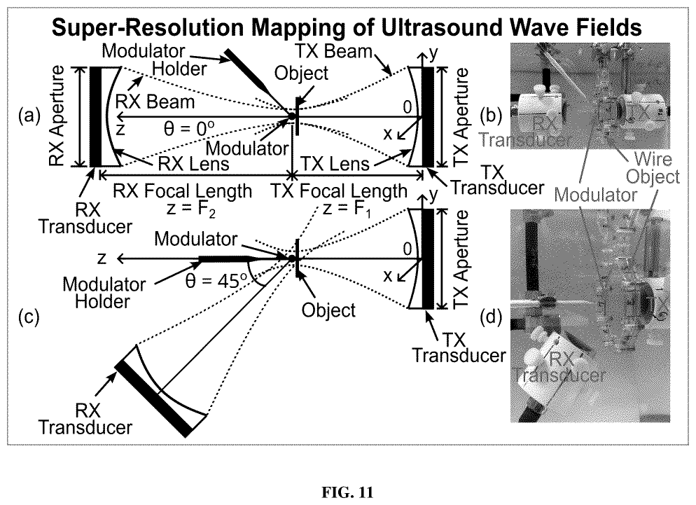

In this example, the PSF-modulation super-resolution imaging method was used to experimentally map pulse ultrasound wave fields remotely (FIG. 11) at a spatial resolution that is higher than the diffraction-limited resolution of a receiver (super-resolution) to demonstrate the efficacy of the method. The modulator used was a small spherical glass bead, and the pulse ultrasound wave fields were produced by a focused transducer and a Bessel transducer.

### Theoretical Preliminaries

Assuming that f(r̅;t) represents a spatial wave field (a distribution of the wave in space r̅ in a media, for example, the acoustical waves produced by light or electromagnetic heating in photoacoustic imaging, waves transmitted through objects such as biological soft tissue, the waves used to illuminate and then scattered or reflected from the object, and waves produced in a uniform media such as water, see the ultrasound waves produced by the TX transducer in FIG. 11) of a wave source at any given time t, an image of the spatial wave field can be reconstructed in a “one way” process (as opposed to a “two-way” process in pulse-echo ultrasound imaging):

$${R}^{R} ( \vec{r} ; t ) = \text{?} {Φ}^{R} ( \vec{r} - {\vec{r}}^{′} ; t - {t}^{′} ) f ( {\vec{r}}^{′} ; {t}^{′} ) d {\vec{r}}^{′} {dt}^{′} = {Φ}^{R} ( \vec{r} ; t ) \text{?} f ( \vec{r} ; t ) , \qquad ( 38 )$$

$$\text{?} \text{indicates text missing or illegible when filed}$$

where Φ^{R}(r̅;t) is a spatial-temporal response of a wave receiver (see the RX transducer in FIG. 11), r̅′ is an integration variable over the space, t′ is an integration variable over the time, represents a convolution with respect to both r̅ and t, and the superscript “R” represents “receive”. Here it is assumed that the imaging system is a linear shift-invariant (LSI) and linear time-invariant (LTI) system (notice that many practical imaging systems in various areas of science and engineering such as ultrasound and optics can be described or approximately described by an LSI and LTI system and thus it can be represented with the convolution in Eq. (38).

If f(r̅;t) is a point spatial wave field of an infinitely short time duration, i.e., f(r̅;t)=δ(r̅;t), where δ(r̅;t) is the Dirac-Delta function, from Eq. (38), one obtains the PSF of the imaging system:

$${PSF}^{R} ( \vec{r} ; t ) \text{?} {Φ}^{R} ( \vec{r} - {\vec{r}}^{′} ; t - {t}^{′} ) δ ( {\vec{r}}^{′} ; {t}^{′} ) d {\vec{r}}^{′} {dt}^{′} = {Φ}^{R} ( \vec{r} ; t ) . \qquad ( 39 )$$

$$\text{?} \text{indicates text missing or illegible when filed}$$

Using Eq. (39), Eq. (38) can be written as:

$${R}^{R} ( \vec{r} ; t ) = {PSF}^{R} ( \vec{r} ; t ) \text{?} f ( \vec{r} ; t ) . \qquad ( 40 )$$

$$\text{?} \text{indicates text missing or illegible when filed}$$

Taking a spatial Fourier transform on both sides of Eq. (40) in terms of r̅, one obtains:

$${\tilde{R}}^{R} ( \vec{k} ; t ) = \text{?} {R}^{} ( \vec{k} ; t - {t}^{′} ) \tilde{f} ( \vec{k} ; {t}^{′} ) {dt}^{′} = {R}^{} ( \vec{k} ; t ) \text{?} \tilde{f} ( \vec{k} ; t ) , \qquad ( 41 )$$

$$\text{?} \text{indicates text missing or illegible when filed}$$

where \tilde{R}^{R}(k̅;t), [symbol] ^{R} (k̅;t), and \tilde{f}(k̅;t) are the spatial Fourier transform of R^{R}(r̅;t), PSF^{R}(r̅;t), and f(r̅;t), respectively, k̅=(kₓ, k_{y}, k_{z}) is a vector wave number, and [symbol] represents a convolution with respect to t. From Eq. (41), it is clear that the maximum spatial frequency of the image R^{R}(r̅;t) is limited by that of PSF^{R}(r̅;t) due to the wave diffraction or other limitations such as a large pitch size of a camera sensor or transducer array. The limited maximum spatial frequency of the PSF due to wave diffraction is a fundamental limit to the spatial resolution of an imaging system to image the wave field f(r̅;t).

To increase the spatial bandwidth of the imaging system, the PSF function can be multiplied by a complex modulation function m(r̅) (the physical meaning of m(r̅) is to introduce a disturbance to an existing PSF of the imaging system by amplitude, phase, or both). The resulting image is given by:

$${R}^{{R}_{m}} ( \vec{r} ; t ) = [ {PSF}^{R} ( \vec{r} ; t ) m ( \vec{r} ) ] \text{?} f ( \vec{r} ; t ) + {C}^{R} ( \vec{r} ; t ) , \qquad ( 42 )$$

$$\text{?} \text{indicates text missing or illegible when filed}$$

where the subscript “m” of superscript “R” means “modulation” and

$${C}^{R} ( \vec{r} ; t ) = \text{?} [ {PSF}^{R} ( {\vec{r}}^{′} ; {t}^{′} ) {γ}_{m}^{R} ( {\vec{r}}^{′} ) ] f ( \vec{r} - {\vec{r}}^{′} ; t - {t}^{′} ) d {\vec{r}}^{′} {dt}^{′} = [ {PSF}^{R} ( \vec{r} ; t ) {γ}_{m}^{R} ( \vec{r} ) ] \text{?} f ( \vec{r} ; t ) , \qquad ( 43 )$$

$$\text{?} \text{indicates text missing or illegible when filed}$$

where γₘ^{R}(r̅) represents the scattering or reflection coefficient of the modulator m(r̅). From Eqs. (42) and (43), it is clear that γₘ^{R}(r̅) can be viewed as a part of the modulator. Takin a spatial Fourier transform on both sides of Eq. (42) gives:

$${\tilde{R}}^{{R}_{m}} ( \vec{k} ; t ) = [ {R}^{} ( \vec{k} ; t ) \text{?} \tilde{m} ( \vec{k} ) ] \text{?} \tilde{f} ( \vec{k} ; t ) + {\tilde{C}}^{R} ( \vec{k} ; t ) , \qquad ( 44 )$$

$$\text{?} \text{indicates text missing or illegible when filed}$$

where \tilde{R}^{R}^{ₘ}(k̅;t), [symbol] ^{R} (k̅;t), \tilde{m}(k̅), \tilde{f}(k̅;t), and \tilde{C}^{R}(k̅;t) are the spatial Fourier transform of R^{R}^{ₘ}(r̅;t), PSF^{R}(r̅;t), m(r̅), f(r̅;t), and C^{R}(r̅;t) respectively, and [symbol] represents a convolution with respect to k̅ Because the convolution with respect to k̅ in Eq. (44) is performed in the spatial frequency domain, the maximum spatial frequency of the modulated PSF in Eq. (42), PSF^{R}^{ₘ}(r̅;t)=PSF^{R}(r̅;t)m(r̅), of the imaging system is increased, making it feasible to reconstruct super-resolution images with methods that are suitable for specific applications in different areas of science and engineering.

In this example, Eqs. (40) and (42) are used to reconstruct super-resolution images of broadband pulse ultrasound wave fields.

### Methods

### Pulse Wave Field of a Focused Transducer

To apply the super-resolution theory given above to map a focused pulse ultrasound wave field remotely in water, experiments were conducted (see FIG. 11). In the experiments, the pulse wave field was produced by a 25.4-mm diameter, 2.25-MHz center frequency, and broadband (about 61%−6 dB relative pulse-echo bandwidth) PZT transducer (V304, Panametrics, MA, USA). The transducer was electrically driven by a 1-cycle 2.25-MHz sine signal and was focused with a home-made plexiglass lens at about 33.5 mm (f-number of about 1.32). The speed of sound of the water was about 1500 m/s and thus the wavelength of the ultrasound pulse at the center frequency was about 0.67 mm. The one-way full-width-at-half maximum (FWHM) resolution or beam width of the transmitter is given by:

$${PR}_{FWHM} = 1.41 λ {F}_{1} / D = 1.24 mm , \qquad ( 45 )$$

where “R_{FWHM}” represents one-way FWHM resolution of a planar aperture weighting (prefix “P”), λ=c/f is the wavelength, c is the speed of sound, f is the center frequency, F₁ is the focal length of the transmitter, and D is the diameter of the transducer.

To map the pulse ultrasound wave field remotely, another PZT transducer that has the same parameters but of a different focal length F₂ of about 49 mm (f-number of about 1.93) was used as a receiver. The one-way FWHM diffraction-limited resolution of the receiver is given by:

$${PR}_{FWHM} = 1.41 λ {F}_{2} / D = 1.81 mm , \qquad ( 46 )$$

It is clear that the spatial resolution of the receiver is poor when mapping the wave field that only has a FWHM beam width of about 1.244 mm at the focal distance F₁ of the transmitter.

Notice that the beam width of the receiver in Eq. (46) can be used to determine the spatial resolution of an LSI imaging system in Eq. (40). From Eq. (39), it is clear that the spatial-temporal response of the receiver, Φ^{R}(r̅;t), is the best PSF of the LSI imaging system. Assuming that f(r̅;t) in Eq. (40) is a geometrical point in space (a spatial Delta function), the image R^{R}(r̅;t) of the point will be the PSF itself. If f(r̅;t) consists of two geometrical points that are placed closely with each other, the two points would be indistinguishable in their image unless the distance between the two points is greater than the beam width (the PSF width) given in Eq. (46), which is a diffraction-limited resolution of the receiver or the imaging system. Using the diffraction-limited PSF to map the wave field with Eq. (40), one can establish a baseline to determine if a method that uses the same receiver to map the same wave field has overcome the diffraction limit (i.e., achieving super-resolution). If the beam width of the mapped wave field is smaller than the baseline beam width that is at least the PSF width in Eq. (46) due to the convolution in Eq. (40), the method breaks the diffraction limit and thus has achieved a super-resolution.

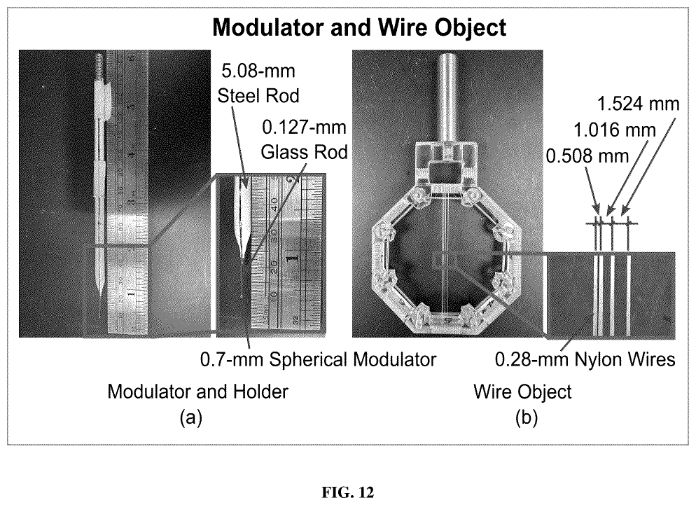

To increase the spatial resolution beyond the diffraction limit of the receiver when mapping the pulse ultrasound wave field, the PSF-modulation super-resolution imaging method was used. To implement the method experimentally, a small glass bead (see FIG. 12, (a)) of a diameter of about 0.7 mm was attached to one end of a glass rod of about 0.127 mm in diameter and about 10 mm in length, and the other end of the glass rod was glued to the tip of a tapered steel bar of about 5.08 mm in diameter (FIG. 12, (a)). The glass bead was then fixed and placed at the focal point of the receiver for a super-resolution mapping of the ultrasound pulse wave field in the following steps. Assuming that the modulator causes an amplitude modulation by completely blocking the incident ultrasound wave field in the space that the modulator occupies, the modulator can be described as follows (see FIG. 11):

$$m ( \vec{r} ) = \{ \begin{matrix}0 , & \vert \vec{r} - {\vec{r}}_{{F}_{1}} \vert \leq a \\ 1 , & Otherwise\end{matrix} , \qquad ( 47 )$$

where r̅_{F}_{₁}=(x, 0, F₁), F₁ is the focal distance of the transmitter (see FIG. 11), and α is the radius of the modulator. Inserting Eq. (47) in Eq. (42), and then subtracting the result from Eq. (40), a super-resolution mapping of the pulse ultrasound wave field can be obtained if the diameter of the modulator is smaller than the diffraction-limited resolution of the receiver given in Eq. (46):

$${R}^{{R}_{sub}} ( \vec{r} ; t ) = {R}^{R} ( \vec{r} ; t ) - {R}^{{R}_{m}} ( \vec{r} ; t ) = {PSF}^{{R}_{sub}} ( \vec{r} ; t ) \text{?} f ( \vec{r} ; t ) - {C}^{R} ( \vec{r} , t ) , \qquad ( 48 )$$

$$where$$

$${PSF}^{{R}_{sub}} ( \vec{r} ; t ) = {PSF}^{R} ( \vec{r} ; t ) [ 1 - m ( \vec{r} ) ] = \{ \begin{matrix}{PSF}^{R} ( \vec{r} ; t ) , & \vert \vec{r} - {\vec{r}}_{{F}_{1}} \vert \leq a \\ 0 , & Otherwise\end{matrix} \qquad ( 49 )$$

$$\text{?} \text{indicates text missing or illegible when filed}$$

and where the subscript “sub” on the superscript “R” means “subtracted”, and C^{R}(r̅;t) is due to the scattering or reflections from the modulator m(r̅) and is given by Eq. (43) above. From Eq. (49), it is clear that α→0, the resulting point-spread function PSF^{R}^{_{zub}}(r̅;t) will behave like a spatial Delta function. In this case, according to Eq. (48), the wave field, f(r̅;t), can be reconstructed at an infinitely high spatial resolution. Notice that for an infinitely small modulator (α→0), the wave scattered fro the modulator will be 0 (i.e., C^{R}(r̅;t)→0 in Eq. (43)). If α>0, as was the case in the experiments, the spatial resolution of the mapping of the wave field f(r̅;t) will be determined by the diameter of the modulator, and the wave scattered from the modulator C^{R}(r̅;t) will not be zero. However, for a given modulator and receiver, the term PSF^{R}(r̅;t)γₘ^{R}(r̅) from Eq. (43) is fixed, which means that C^{R}(r̅;t) depends only on f(r̅;t).

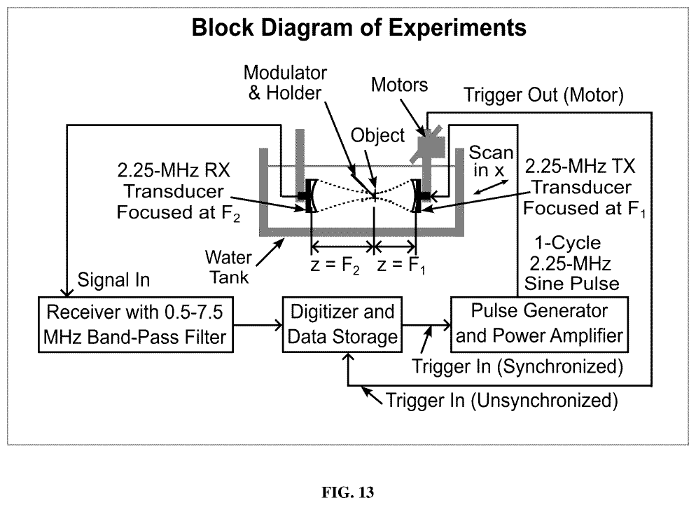

To implement Eq. (48) experimentally, a block diagram in FIG. 13 was used. A pulse ultrasound wave field was produced in water by the focused transmitter (TX transducer on the right-hand side of the water tank with a focal length of F₁) of the parameters given above. The wave field at the focal distance of the transmitter was received by a focused receiver with a focal length of F₂ (the receiver or the RX transducer on the left-hand side of the water tank). To map the wave field at the focal distance of the transmitter, the transmitter was moved (scanned) along the x axis in multiple equal-distance steps with a step size of 0.125 mm across the center of the transmitter focus (notice that the TX transducer is axially symmetric and thus scanning along the x axis is enough to map the wave filed; also, the motion between the transmitter and receiver is relative and thus one could scan the receiver instead of the transmitter). At each step, an unsynchronized trigger signal was produced from the motor unit and sent to the digitizer unit that produced another trigger signal synchronized to the clock of the digitizer. The synchronized trigger was used to trigger the pulse generator (function generator, HP8116A, Hewlett-Packard Company, CA, USA) to produce a 1-cycle 2.25-MHz electrical sine signal that was amplified by a power amplifier (ENI2100L, Electronics and Innovation, Ltd., NY, USA) to drive the transmitter to produce an ultrasound signal. The ultrasound signal was received to produce an electrical signal that was amplified, filtered by a 0.5-7.5 MHz band-pass filter, digitized at 50 MS/s sampling rate and 12-bit resolution for 512 samples, and then stored on a hard disk. To obtain a super-resolution mapping of the pulse ultrasound wave field at the focal distance of the transmitter, the 0.7-mm diameter modulator mentioned above was placed at the focal point of the receiver. The mapped wave field with the modulator was then subtracted from that without the modulator using Eq. (48) for a super-resolution mapping of the wave field. Notice that the receiver can be placed at different angles as shown in FIG. 11.

To show the versatility of the method for a super-resolution mapping of the pulse ultrasound wave field, an object (see FIG. 12, (b)) consisting of 4 nylon wires of diameter of about 0.28 mm with wire spacing of 0.508 mm, 1.016 mm, and 1.524 mm, respectively, was placed at the focus of the transmitter to disturb the wave field to produce higher spatial frequency components in the wave field (notice that in addition to object in FIG. 12, (b), other objects such as biological soft tissues can be used). Super-resolution mapping of the wave field with the wire object can be obtained using the same method as that without the object. In the experiment, the second of the four wires from the left in the wire object (see FIG. 12, (b)) was aligned with the center of the transmit focus.

If the object is a biological soft tissue, multiple small modulators can be injected into the tissue through existing channels or a network of blood vessels for super-resolution mapping of the wave field inside the tissue. With multiple small modulators, the speed for the super-resolution wave field mapping can be increase if the diffraction-limited image of each modulator can be isolated, i.e., the modulators are sparse and thus each modulator can be treated individually (the images of the modulators can be obtained by an array transducer to perform a plane-wave pulse-echo imaging or by other particle localization methods). As mentioned above, the ability of remotely mapping ultrasound wave fields inside biological soft tissues will be helpful in planning and monitoring of HIFU treatments of tumors (for example, in hyperthermia and histotripsy).

### Pulse Wave Field of a Bessel Transducer

The method for super-resolution mapping of the focused pulse ultrasound wave field above can be extended to map a pulse Bessel beam. In the experiment, the focused transmitter in FIG. 11 was replaced with a custom 10-ring, 50-mm diameter, 2.5-MHz center frequency, and 1-3 ceramic/polymer composite broadband (about 72%−6 dB relative one-way bandwidth) Bessel transducer that had a scaling parameter α=1202.45 m⁻¹ of the Bessel function J₀ (αr), where r is the radial distance from the transducer axis. The Bessel transducer was electrically driven by a 1-cycle 2.5-MHz sine signal. The 2.25-MHz receiver (RX transducer) and the modulator in FIG. 11 were not changed. The pulse Bessel beam was mapped at 0.5 mm away from the surface of the transducer.

### Results

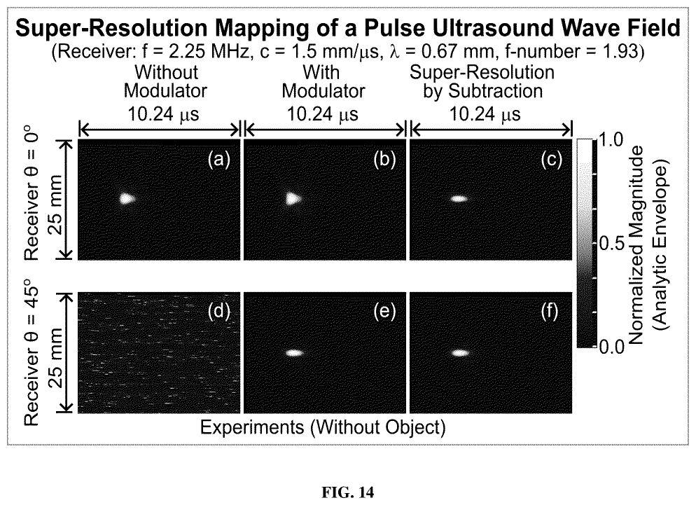

FIG. 14, (a), (see Eq. (40)) and FIG. 14, (b), (see Eq. (42)) are the pulse ultrasound wave fields mapped experimentally without and with the modulator respectively using the setup in FIG. 11, (a), where the axial axis of the RX transducer was in parallel with that of the TX transducer (θ=0°) and the object was removed. Subtracting the radio-frequency (RF) signals of the image in FIG. 14(b) from that in FIG. 14, (a) resulted in a super-resolution mapping of the wave field in FIG. 14, (c) (see Eq. (48)).

To show the flexibility of the super-resolution wave field mapping method, the RX transducer was rotated by an arbitrary angle, say, θ=45° as shown in FIG. 11, (c) and (d). The results are shown in FIG. 14, (d), (e), and (f) that are corresponding to FIG. 14, (a), (b), and (c), respectively. FIG. 14, (d), contains mainly noise since without a modulator, little ultrasound wave can reach the RX transducer at such a large angle (i.e., R^{R}(r̅;t) in Eq. (40) is almost 0) due to the directivity of the focused wave. With a modulator, the scattered wave can be received by the RX transducer and the wave field can be mapped (see FIG. 14, (e), that can be described by R^{R}^{ₘ}(r̅;t) of Eq. (42)). This is similar to previous studies where a small scatterer (such as the tip of an optical fiber) was used to map ultrasound wave fields at a larger receiver angle close to θ=90°. Although the methods in those studies can map ultrasound wave fields at a high spatial resolution, as mentioned before, they do not work if there are other scattering objects such as biological soft tissues near the scatterer, or, if part of the transmit wave can reach the receiver directly as in FIG. 11, (a).

The horizontal and vertical dimensions of the images in FIG. 14 represent the time duration (10.24 μs) and the spatial distance (25 mm) along the x axis respectively. The images in FIG. 14 are analytic envelopes of the RF pulse signals and were normalized to their respective maxima.

The FWHM beam widths of the super-resolution pulse ultrasound wave fields in FIG. 14, (c) and (f), mapped at the focal distance of the transmitter were about 1.13 mm and 1.22 mm, respectively, which were close to 1.24 mm calculated from the theory in Eq. (45). The small differences of these beam widths from the theory may be due to an error of the estimated focal distance (33.5 mm) of the transmitter and the fact that for a small spherical object, waves scatter stronger at higher temporal frequencies than those at lower frequencies. The small difference between the beam widths of FIG. 14, (c) and (f), may be caused by the asymmetry of the modulator (the glass bead was attached to a glass rod) and a misalignment of the modulator relative to the focal distance of both the RX and TX transducers. Without using the super-resolution wave field mapping method (see FIG. 14, (a)), the beam width was much larger (about 2.06 mm) than the theoretical value (1.24 mm), which was due to the large diffraction-limited beam width of the receiver (1.81 mm from Eq. (46)).

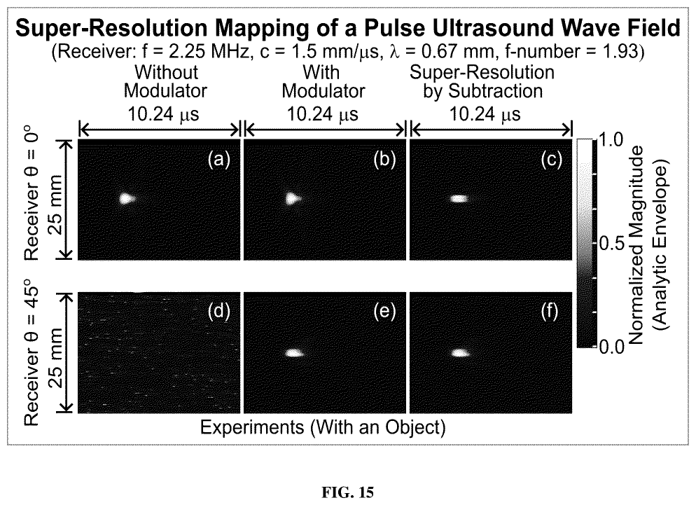

From the discussion above, it is clear that the super-resolution wave field mapping method is applicable to any LSI and LTI systems where the convolution in Eq. (38) is valid. To show the flexibility of the super-resolution wave field mapping method, the wire object in FIG. 14, (b), was placed at the focal distance of the TX transducer (see FIG. 11) to disturb the pulse ultrasound wave field f(r̅;t) in Eq. (38). The third wire from the left of the wire object was approximately aligned with the focal point of the TX transducer. The wire object was fixed and scanned with the TX transducer to map the pulse ultrasound wave field. The results are shown in FIG. 15, which is the same as FIG. 14, except that the wire object was added. Compared to FIG. 14, it is seen that high spatial frequency components were produced in the pulse wave field due to the wire object (see FIG. 15, (c) and (d)). These high spatial frequency components were not seen in FIG. 15, (a), where the modulator was not used and the high spatial frequency components were filtered out due to spatial averaging by the receiver that has a poor diffraction-limited resolution (1.81 mm in Eq. (46)).

Notice that in addition to the object in FIG. 14, (b), other objects such as biological soft tissues can be placed in the wave field. In this case, the wave field inside the object can be mapped accurately at a high spatial resolution using one or more small modulators if the weak scattering condition of the object is assumed, i.e., multiple scattering, reflection, refraction, and attenuation of the objects can be ignored or compensated (i.e., the LSI and LTI condition is satisfied). Since the modulators can be small, they can be introduced noninvasively into some objects such as biological soft tissues through existing channels or blood vessel network, which may be difficult to do with conventional wave field mapping methods where a small hydrophone, sensor, or optical fiber is used. The flexibility of the super-resolution wave field mapping method can help to map the HIFU beams inside the tissues for tumor targeting and treatment monitoring at a higher spatial resolution if the positions of the modulators inside the objects can be determined through plane-wave pulse-echo imaging or other particle localization methods.

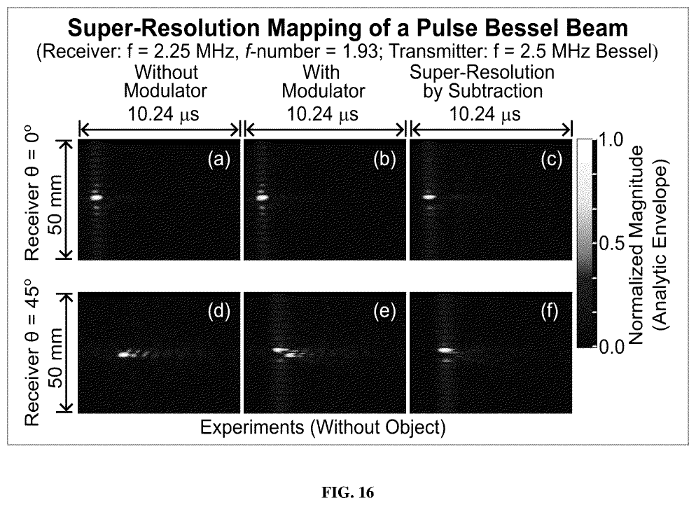

Another example is to experimentally map a pulse Bessel beam using the super-resolution wave field mapping method. In the experiment, a pulse Bessel beam was produced by a 10-ring, 50-mm diameter, 2.5-MHz center frequency, and broadband Bessel transducer that was driven electrically by a 1-cycle sine signal. The pulse Bessel beam was mapped at about 0.5 mm away from the surface of the transducer (notice that the center wavelength of the pulse Bessel beam in water was about 0.6 mm). The TX transducer and the object in FIG. 11 were replaced with the Bessel transducer that was placed near the focal distance of the RX transducer. The results are in FIG. 16, which is the same as FIG. 14 except that the Bessel transducer was used and the dimension along the x-axis was 50 mm. From FIG. 16, (c) and (f) (super-resolution), the high spatial frequency components of the pulse Bessel beam near the surface of the Bessel transducer can be clearly seen. In comparison, FIG. 16, (a) and (d), where no modulator was used, do not have these high spatial frequency components. FIG. 16, (d), shows a part of the incident waves received by the RX transducer at θ=45° (see FIG. 11, (c)).

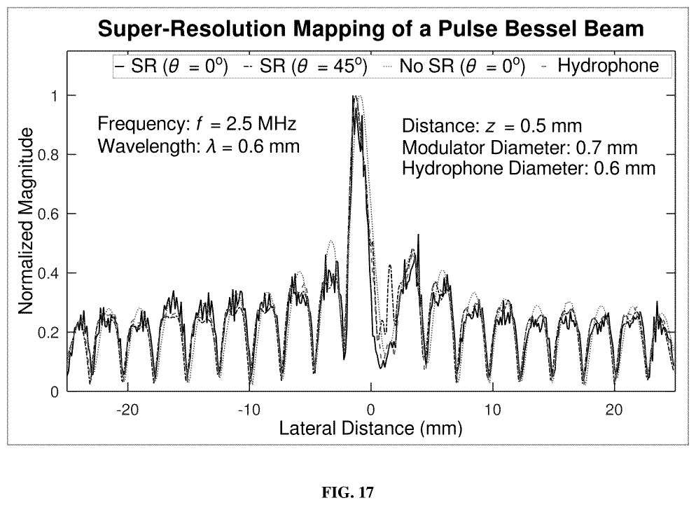

FIG. 17 shows a line plot of the Bessel pulses in FIG. 16 across the center of the Bessel transducer along the x axis (see FIG. 11). The vertical and the horizontal axes of FIG. 17 are the normalized maxima and the lateral distance (along x axis), respectively. The maxima were obtained by finding the maximum value along each row over 400 rows of a panel in FIG. 16. These maxima represent the maximum sidelobes of the mapped pulse Bessel beams. The dotted (pink), solid (black), and dash-dotted (blue) lines in FIG. 17 were obtained from FIG. 16, (a), (c), and (f), respectively. It is clear from FIG. 17 that FIG. 16, (c) and (f), contain high spatial frequency components and FIG. 16, (a), is a lack of such components. Thus, the super-resolution wave field mapping method is effective in revealing spatial details of a wave field.

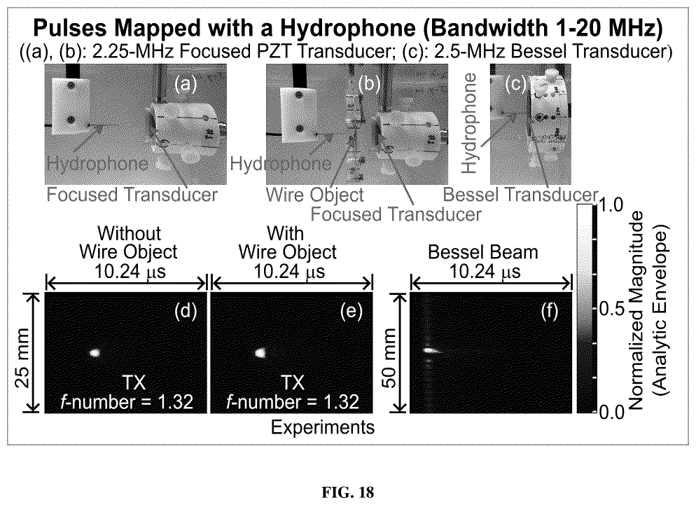

For comparison, a PVDF needle hydrophone of 1-20 MHz bandwidth and 0.6 mm diameter of active element (TNU001A, NTT Systems, Inc., Seattle, Washington, USA) was used to map the pulse ultrasound wave fields experimentally. In the experiments, the RX transducer in FIG. 11, (a), was replaced with the hydrophone to map the pulse ultrasound wave field at the focal distance of the TX transducer with (FIG. 18, (b)) and without (FIG. 18, (a)) the wire object in FIG. 12, (b). The hydrophone also was placed at about 0.5 mm away from the surface of the Bessel transducer to map the pulse Bessel beam (see FIG. 18, (c)). The resulting focused pulse ultrasound wave fields with and without the wire object is shown in FIG. 18, (e) and (d), respectively, and the resulting pulse Bessel beam mapped using FIG. 18, (c), is given in FIG. 18, (f). A line plot of FIG. 18, (f), is shown as the green dashed line in FIG. 17. Compare the line plot of FIG. 18, (f), with those obtained from FIG. 16, (c) and (f), it is clear that they all contain the high spatial frequency components, as opposed to that (the smooth pink dotted line) obtained from FIG. 16, (a). Compare FIG. 18, (d), (e), and (f), with FIG. 14, (c), FIG. 15, (c), and FIG. 16, (c), respectively. They are similar except that the pulse lengths in FIG. 18, (d), (e), (f) are shorter. This is because the hydrophone used has a much wider bandwidth (1-20 MHz) than the RX transducer used in FIG. 14, (c), FIG. 15, (c), and FIG. 16, (c). The beam width of the pulse wave field in FIG. 18, (d) was about 1.41 mm, which is larger than the theoretical value of 1.24 mm due to the size of the active element of the hydrophone.

### DISCUSSION

The results of the super-resolution wave field mapping method show that the method is effective in achieving a high spatial resolution when mapping the wave fields. The method also works whether a part of the transmit wave can reach the receiver or not (see FIGS. 14-15 with θ=0° and 45°). In addition, the method works when there is an object placed in the wave field to be mapped (see FIG. 15), which allows the method to map the wave field inside an object such as biological soft tissue under the conditions mentioned above. As the size of the modulator decreases, the spatial resolution of the mapped wave field will increase.

Despite the spatial resolution can be increased by the super-resolution wave field mapping method, the highest spatial resolution that can be achieved is limited by the signal-to-noise ratio of the experiment system. Also, the dynamic range of the system will affect the highest achievable spatial resolution. If the received waves come only from those scattered from the modulator, less dynamic range is needed since no subtraction is necessary for super-resolution mapping of the wave fields (see FIG. 11, (c) and FIG. 14, (d), (e), (f)). The quantitative value of the mapped wave field with the super-resolution method not only depends on the geometry (shape, size, focal length) and the sensitivity of the receiver, but also depends on the size and shape of the modulator. If the size of the modulator becomes much smaller as compared to the minimum wavelength of the wave field, the modulator will be close to a point scatterer, absorber, or phase shifter. In this case, the shape of the modulator will not have much effect. However, as the size of the modulator increases, the effects of the shape and orientation of the modulator may be significant. Thus, to quantitatively map a wave field, the factors of the modulator should be taken into consideration. However, if the modulator is small and has a fixed shape, size, and material prosperity, its effects on the wave field will be small and constant, and thus can be compensated when mapping the wave field. If the modulator is spherically symmetric, i.e., a sphere, the compensation on the shape and orientation of the modulator is not necessarily due to the symmetry even if the size of the modulator is not small compared to the wavelength. This in fact is another advantage of the PSF-modulation super-resolution imaging method to map the wave field over the conventional method that uses a needle hydrophone since it would be very difficult to make a spherically symmetric hydrophone of the size of a needle hydrophone (usually 0.6 mm or smaller) and also take care of all electronic connections and wiring.

In many cases such as HIFU, the ultrasound wave field is highly distorted in terms of time. This means that the wave field to be mapped may have high temporal frequency components (harmonics). In this case, to quantitatively map the wave field, not only the frequency response of the receiver needs to be considered, but also the frequency-dependent property of the modulator needs to be taken into account. When a small modulator is used, it can be viewed as a high-pass filter to the impinging wave since the modulator will scatter waves more strongly at a higher temporal frequency. Thus, a compensation for the frequency dependency of the modulator is needed to obtain a quantitative wave field mapping.

In this example, a small glass bead was used as a modulator. However, the modulator can be made of any type of material such as metals, plastics, ceramics, wave absorbers, magnetic particles, and so on, depending on applications. The modulation to the wave field can be amplitude, absorption, phase shift, and a combination of them, and a choice of the modulation also depends on applications.

As can be seen from FIG. 11, the super-resolution wave field mapping method allows the receiver to be placed remotely from the wave field to be mapped while reducing the spatial averaging effect due to a poor diffraction-limited spatial resolution of the receiver, especially when the receiver has a large f-number. Placing the receiver remotely is advantageous when it is not practical to place the receiver directly in the wave field to be mapped. For example, it could be difficult to insert a receiver into an object to map the ultrasound wave field inside the object, while it would be easier to inject small modulators (particles) into some objects such as biological soft tissues where there may be channels or a network of blood vessels. Also, a receiver such as a delicate PVDF hydrophone can be damaged if it is placed in the media or objects within which the environment is corrosive, has a high temperature, or has high wave intensity. In these cases, super-resolution mapping of wave fields can be used by choosing suitable modulators.

### Conclusion

The PSF-modulation super-resolution imaging method was successfully applied to map pulse ultrasound wave fields remotely at a high spatial resolution. The theoretical background of the method was given and experiments were conducted. In the experiments, pulse ultrasound wave fields were produced by a broadband focused PZT transducer and a 1-3 ceramic/polymer composite broadband Bessel transducer, driven electrically by a 1-cycle sine signal. The PZT transducer had a 2.25-MHz center frequency, about 61%−6 dB relative pulse-echo bandwidth, 25.4-mm diameter, and an f-number of about 1.32. The Bessel transducer had a 2.5-MHz center frequency, about 72%−6 dB relative one-way bandwidth, 50-mm diameter, and 10 annular rings. Another focused PZT transducer of the same parameters above but with an f-number of about 1.93 was used as a receiver to map the pulse ultrasound wave fields remotely. A modulator made of a glass bead of 0.7-mm diameter was used to achieve a super-resolution in mapping the pulse ultrasound wave fields. Different orientations of the receiver (θ=0° and 45° relative to the axial axes of the transmit transducers) were used in the experiments. A wire object was used to disturb the pulse ultrasound wave fields to be mapped to show versatility of the method. In addition, a broadband (1-20 MHz) PVDF needle hydrophone was used to map the pulse ultrasound wave fields for comparison. The results show that the super-resolution wave field mapping method can achieve a high spatial resolution when mapping pulse ultrasound wave fields remotely, overcoming the diffraction limit of the receiver and opening up a possibility of mapping wave fields inside some objects such as biological soft tissues.

### Example III—Enhancing X-Ray Spatial Resolution in Medical Diagnostic Imaging

According to the World Health Organization (WHO), there are more than 3.6-billion medical diagnostic radiology examinations worldwide each year, and a vast majority of them are performed with X-ray based imaging systems. High-resolution X-ray diagnostic imaging systems enable the detection of minute abnormalities such as microfractures, early-stage tumors, fine vascular structures, dental cavities, and root fractures, increasing the accuracy of diagnoses and improving treatment outcomes. However, the image spatial resolution of the current X-ray radiographic imaging systems is limited by a number of factors, including the focal spot size of the X-ray tube, the pitch size of the imaging detector, and the X-ray scattering from tissues to be imaged. Although reducing the size of the focal spot and the pitch of the imaging detector can increase image spatial resolution, there are physical limits to these factors. For example, at a given X-ray tube output, the focal spot size cannot be too small to avoid overheating that may damage the anode of the X-ray tube and a reduction of detector pixel size will lower the sensitivity of the detection system overall, and increase noise and cost. Coded apertures have been used to increase image resolution. However, this approach also has issues, for example, resolution improvement is limited, objects need to be thin, coding mask is bulky and difficult to make, image is sensitive to mask alignment, image reconstruction algorithms are complicated and may produce artifacts, and equipment cost is higher. Thus, there is a critical need to find a new method that can increase image spatial resolution of all existing X-ray radiographic imaging systems.

To address the issues above, small modulators can be used to modify the point spread function (PSF) of the imaging system to increase image spatial resolution using the PSF-modulation super-resolution imaging method described above. The modulators (of rectangular, spherical, or other shapes) can be made of a dense material of a high X-ray attenuation and be placed on the top, bottom, or inside the cavities of the object to be imaged to reduce the effects of penumbra and tissue scattering. Distributions of the modulators can be random or periodical with the distance between any two modulators to be larger than the size of the resolution cell of the imaging system (i.e., the modulators are sparsely distributed). High-resolution images can be reconstructed by subtracting between the low-resolution images obtained with and without the modulators, localizing the centers of the modulators with the subtracted image, integrating the subtracted image over the resolution cells of individual modulators, and then moving the modulators and repeating the process a number of times. Because of the flexibility of placing the small modulators, it is possible to introduce the modulators into the cavities of objects such as human body to get a closer and detailed examination of diseased tissues. This opens up new applications in the method in various imaging systems such as X-ray CT, nuclear medicine imaging, and magnetic resonance imaging (MRI), etc., in addition to the X-ray radiography.

X-ray radiographic imaging is most widely used among the more than 3.6-billion medical diagnostic radiology examinations worldwide each year, however, the image spatial resolution of current X-ray radiographic imaging systems is limited due to many factors such as focal spot size of the X-ray source and the pixel size of the detector. Although there are methods that can improve image resolution, such as reducing the focal spot size, decreasing pixel size of the detector, and using coded apertures, there are limitations. This example describes a method to overcome these limitations and significantly increase the spatial resolution of the imaging systems using small modulators that can be placed either inside or outside of an object such as human body, helping early and more accurate medical diagnoses of diseases and improving patient treatment outcome, and opening up applications of the method in various imaging systems such as X-ray CT, nuclear medicine imaging, magnetic resonance imaging (MRI), ultrasound, and optics, etc., in addition to the X-ray radiography.

To address the issues above, small modulators can be used to modify the point spread function (PSF) of X-ray imaging systems to increase image spatial resolution using the PSF-modulation super-resolution imaging method described above. The modulators (of rectangular, spherical, or other shapes) can be made of a dense material of a high X-ray attenuation. Unlike the coded apertures where the coding mask is usually bulky and is placed between the object and the detector, the small modulators can be placed on top, bottom, or inside the cavities of the object, which reduces the effects of penumbra and tissue scattering because the modulators are closer to the features such as diseased tissues to be imaged. In addition, the modulators can be arranged randomly or periodically where the distance between any two modulators is larger than the resolution cell of the imaging system, i.e., the modulators are sparsely distributed. Subtracting images obtained with and without the modulators, localizing the centers of the modulators with the subtracted image, and assigning the values integrated over the resolution cells of the modulators to the localized centers, multiple pixels of a high-resolution image can be obtained. Moving the modulators and repeating the process above, the final image is reconstructed. Since the method is flexible in terms of the modulators, one non-limiting example involves arranging rectangular modulators into a periodical panel for convenience.

### Evaluating Parameters Via Computer Simulations for High-Resolution X-Ray Radiography

Computer simulations can be run to optimize the parameters of the modulators and imaging such as, but not limited to: X-ray opacity; width, height, and length of each modulator; space between the modulators; total scanning area; scanning step size; signal integration area of each modulator; and the effects of noise on reconstructed images. As a non-limiting example, a GE Discovery RF180 X-ray radiographic imaging system can be used to run the simulations, and typical exam conditions, such as the source to object and the object to detector distances, can be used.

### Designing Modulator Arrays and Performing Experiments on Phantoms

Modulators with the optimized parameters obtained from the simulations can be designed and constructed to obtain high-resolution X-ray images of resolution phantoms. The phantoms can be placed at different layer of water phantoms to emulate tissue features that may be at different depth inside the human body. A multi-axis mechanical motion system with a microcontroller and associate electronics can be constructed. Images can be reconstructed for different distances between the modulators and object, the object and the detector, and the source and the detector. Because the modulators can be small and be placed either outside or inside the cavities of objects to be imaged, the high-resolution imaging method is flexible and thus can be applied to other imaging systems such as X-ray CT, nuclear medicine imaging, magnetic resonance imaging (MRI), ultrasound, and optics, etc. This will help early and more accurate medical diagnoses and improve patient treatment outcome.

### Significance

High-resolution X-ray radiography will increase the accuracy of medical diagnoses by allowing physicians to view more details of diseased tissues such as small tumors, micro fractures of the bone, and micro calcifications. However, the spatial resolution of current X-ray radiography is limited by various factors such as focal spot size of the X-ray tube, the pixel size of the detector, and scattered radiation, etc., in addition to motion blurring, quantum noise, detector quantum efficiency (DQE), and beam hardening. Although the image spatial resolution can be increased by reducing the focal spot size of X-ray tube and decreasing the pixel size of detector, there are practical limitations. For a given X-ray tube output, small focal spot size concentrates electron energy in a small area, which can lead to excessive heating to damage the X-ray tube. Detectors of a small pixel size will be less sensitive, have increased noise, and can be expensive. Coded apertures have been used to increase image spatial resolution. However, there are a number of issues with this approach. For example, image resolution improvement is limited, objects need to be thin, coding mask is bulky and difficult to make, image quality is sensitive to mask alignment, image reconstruction algorithms are complicated and may produce artifacts, and equipment cost is increased. Thus, there is a need for a new method that can address these issues for existing X-ray radiographic imaging systems.

The method described herein is based on the rigorous mathematical formulation of the PSF-modulation super-resolution imaging method, where small modulators are used to modify the PSF of the imaging system to produce high spatial frequency components for high-resolution imaging. Unlike the coded apertures that uses a bulky coding mask placed between the object to be imaged and the detector, the small modulators can be placed either randomly or periodically outside or inside the cavities of objects such as human body. Since the modulators can be close to the features such as diseased tissues, the effects of penumbra and tissue scattering can be reduced and images of a very high spatial resolution can be reconstructed. In addition to applications in the X-ray radiography, the method also is applicable to other imaging modalities such as X-ray CT, nuclear medicine imaging, magnetic resonance imaging (MRI), ultrasound, and optics, etc., helping early and more accurate medical diagnoses and improving patient treatment outcome.

### Results

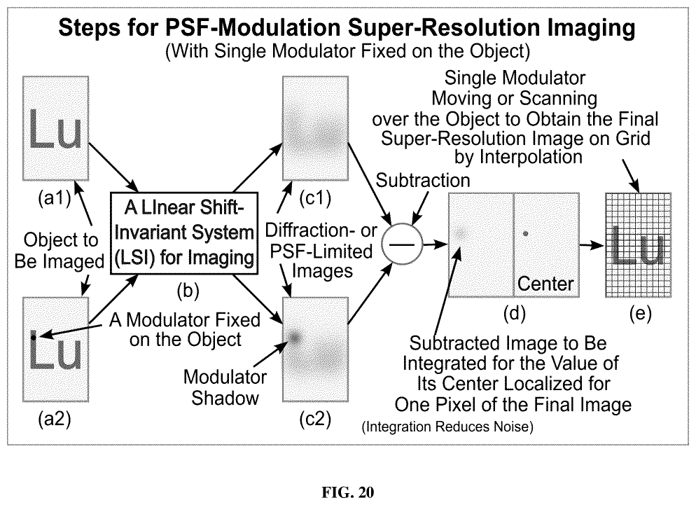

The principle of the PSF-modulation super-resolution imaging method is generally applicable to any linear shift-invariant (LSI) imaging systems. An LSI imaging system means that the image of an object shifted in the field of view will be the same as the original one except that the object is also shifted in the image. The PSF-modulation super-resolution imaging method can work in two ways as shown in FIGS. 20-22.

FIG. 20 shows how the general PSF-modulation super-resolution imaging method works. For an object in FIG. 20, (a1), a diffraction- or PSF-limited (a wide PSF caused by various factors such as X-ray source, detector, and scattering, etc.) image (FIG. 20, (c1)) of the object is obtained using an LSI imaging system in FIG. 20, (b). To increase the image resolution beyond the diffraction limit, i.e., super-resolution, a small modulator can be placed on the object as in FIG. 20, (a2). The image of the object along with the modulator is shown in FIG. 20, (c2). Subtracting the image in FIG. 20, (c2) from that in FIG. 20, (c1), one obtains the difference image in FIG. 20, (d). Localizing the center of the difference image (if the position of the modulator is unknown), and then assigning to the center with the value of an integration of the image in FIG. 20, (d) (the integration process reduces noise), one obtains a pixel of the super-resolution image in FIG. 20, (e). Placing the modulator in FIG. 20, (a2) on different positions of the object and then repeating the process above, one obtains all pixels of the super-resolution image in FIG. 20, (e). If the positions of the modulator are not on a rectangular grid of the super-resolution image in FIG. 20, (e), an interpolation can be used to obtain the final super-resolution image on the rectangular grid.

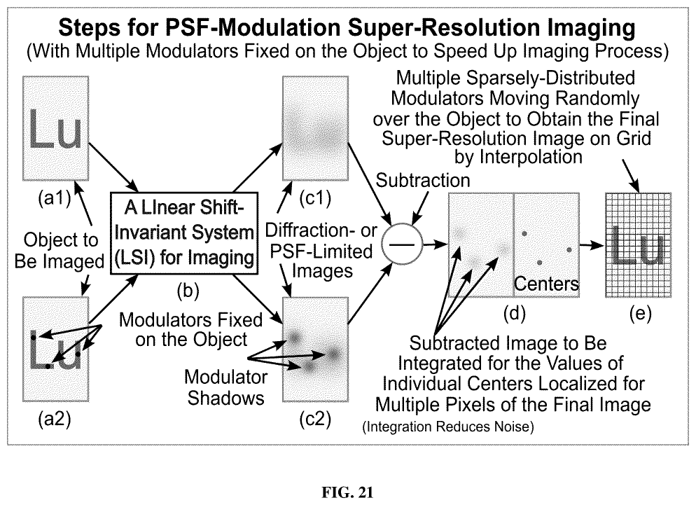

To speed up the imaging process, multiple sparsely populated modulators can be used (an example of three modulators is given in FIG. 21). Since multiple modulators are sparsely populated, their centers can be localized individually to obtain multiple pixels of the super-resolution image at once using the imaging process of single modulator in FIG. 20.

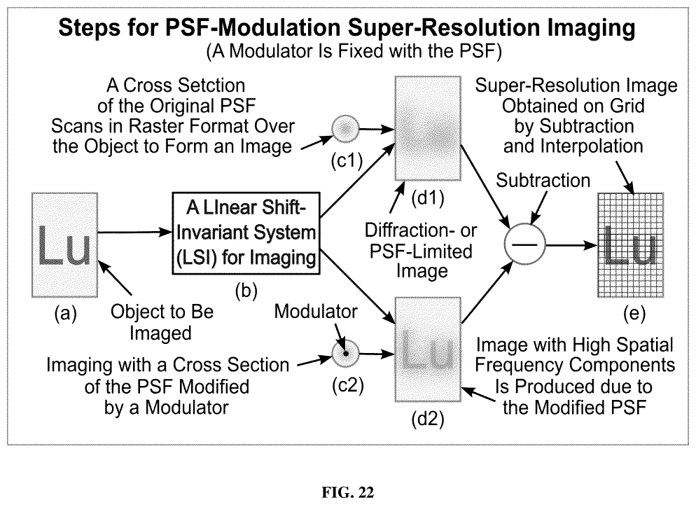

Another approach to implement the universal PSF-modulation super-resolution imaging method is to fix the modulator with the PSF (FIG. 22), instead of fixing the modulator on the object during imaging as in FIGS. 20-21. In this approach, a small modulator (FIG. 22, (c2)) is placed at the center of the PSF to modify the original PSF in FIG. 22, (c1). The modified PSF in FIG. 22, (c2), is then scanned over the object in FIG. 22, (a), in a raster format to obtain an image point by point (FIG. 22, (d2)). Subtracting FIG. 22, (d2), from FIG. 22, (d1), that is obtained with the original PSF, one obtains a super-resolution image in FIG. 22, (e). Comparing FIG. 22, (d1), with FIG. 22, (e), it is clear that the image resolution in FIG. 22, (e), is increased significantly.

From the imaging processes above (FIGS. 20-22), it is clear that, in theory, there is no limit to the image resolution that can be achieved with the universal PSF-modulation super-resolution imaging method since the image resolution is determined by the size of the modulator instead of the original PSF. In practice, the image resolution is limited by the noise of the imaging system. Also, the choice of the modulator is flexible and the modulator can be used to modify the amplitude, phase, or both amplitude and phase of the PSF, depending on applications.

FIG. 5 shows computer simulation and experiment results of an implementation (see FIG. 22) of the universal PSF-modulation super-resolution imaging method. An “L”-shaped object in FIG. 5, (a) (corresponding to the object in FIG. 22, (a)) was imaged with an LSI imaging system at its diffraction-limited resolution (see FIG. 22, (b)). FIG. 5, (e), is a photo of the object in FIG. 5, (a) (see the cross section of the small pins on an epoxy base). Using the original PSF (see FIG. 22, (c1)) and the PSF modified by a 0.5-mm modulator (see FIG. 22, (c2)), images without and with a modulator were obtained in FIG. 5, (c) (see FIG. 22, (d1)) and FIG. 5, (b) (see FIG. 22, (d2)), respectively, via computer simulations. Subtracting FIG. 5, (b) from FIG. 5, (c), a super-resolution imaging in FIG. 5, (d) was obtained (see FIG. 22, (e)). FIG. 5, (f)-(h), was obtained from experiments, and these are corresponding to FIG. 5, (b)-(d), respectively. From FIG. 5, it is seen that the universal PSF-modulation super-resolution imaging method can significantly increase image spatial resolution.

Since the PSF-modulation super-resolution imaging method is universal, it can be applied to various disciplines of science, engineering, and medicine. For example, the method has been used to map a wave field in space at a super-resolution.

### Approach

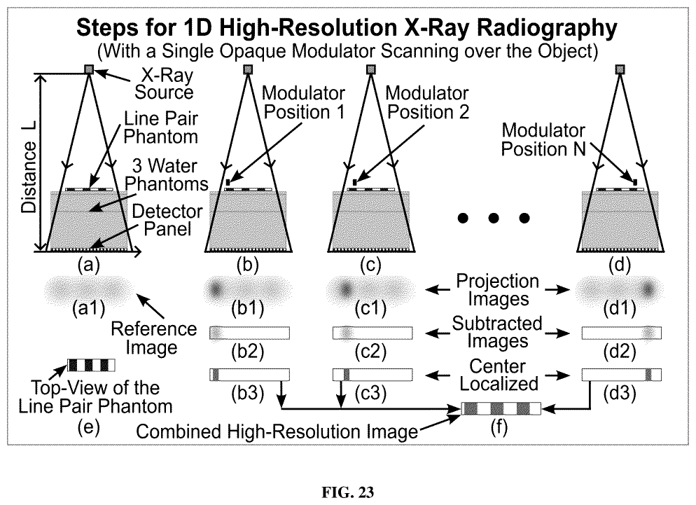

Although the small modulators in FIGS. 20-22 can be of various shapes and can be randomly distributed, for simplicity and example purposes, rectangular modulators can be used and arranged into periodical layers or grid. Also, the approach in FIGS. 20-21 can be used. For a one-dimensional (1D) object such as X-ray line-pair phantoms, the steps shown in FIG. 23 can be used to obtain a high-resolution image. In the imaging, a commercial clinical X-ray radiographic imaging system (such as GE Discovery RF180 system) of about 3.4 line pairs per mm (lp/mm) resolution can be used (FIG. 23, (a), also see FIG. 20, (b)). Typical tube voltage (about 70 keV), current (about 32 mA), exposure duration (about 0.128 s), source focal spot size (0.6 mm), and a source-detector distance L of about 2 m can be used as a starting point. A commercial 2400×2880-pixel flat-panel detector of 0.148-mm pitch and a commercial line-pair (lp) phantom of up to 20 lp/mm will be used (see FIG. 23, (e), also see FIG. 20, (a1)). An experiment can be performed in the following steps: First, obtain a reference projection image (FIG. 23, (a1), also see FIG. 20, (c1)) of the lp phantom without a modulator. Second, obtain projection images in FIG. 23, (b1), FIG. 23, (c1), and FIG. 23, (d1) (also see FIG. 20, (c2)) by scanning a small high-density modulator such as lead (about 25 μm wide and 1.5 mm long in FIG. 23, (b), also see FIG. 20, (a2)) that can block the X-ray from Positions 1 to N respectively, where N is an integer. Third, subtract images in FIG. 23, (b1), FIG. 23, (c1), and FIG. 23, (d1), from the reference projection image in FIG. 23, (a1), to obtained images in FIG. 23, (b2), FIG. 23, (c2), and FIG. 23, (d2) (also see FIG. 20, (d)), respectively. Fourth, since the center positions of the images in FIG. 23, (b2), FIG. 23, (c2), and FIG. 23, (d2), are corresponding to the positions of the modulator, which are known, the integration values of the images in FIG. 23, (b2), FIG. 23, (c2), and FIG. 23, (d2), can be assigned to these center positions to obtain partially reconstructed high-resolution images in FIG. 23, (b3), FIG. 23, (c3), and FIG. 23, (d3), respectively. Lastly, combine images in FIG. 23, (b3), FIG. 23 (c3), and FIG. 23, (d3), to obtain the final high-resolution X-ray radiographic image in FIG. 23, (f) (also see FIG. 20, (e)). Because the width of the modulator is about 25 μm, the image resolution is expected to be about 25 μm, which is 20 lp/mm. To mimic the presence of soft tissue of human body, three water phantoms of different thickness (10, 40, and 80 mm, see FIG. 23) can be used. With the water phantoms of different thickness, the changes of image resolution with the distance between the lp phantom and the modulator can be evaluated to mimic tumors at different depths in the body.

Since the subtracted images in FIG. 23, (b2), FIG. 23, (c2), and FIG. 23, (d2), only occupy a small portion of the detector array (or the resolution cell of the imaging system), multiple modulators can be used simultaneously as in FIG. 21 to reduce the number of translation steps and thus speed up the imaging process as long as the subtracted images in FIG. 23, (b2), FIG. 23, (c2), and FIG. 23, (d2), do not overlap. Because the width of the modulator is about 25 μm and the native resolution of the GE imaging system is about 3.4 lp/mm, the minimum distance between adjacent modulators should be at least 0.148 mm (0.5 mm can be used to start with, as a non-limiting example).

If the object is two-dimensional (2D), a lead modulator of 25 μm×25 μm×1.5 mm can be used (FIG. 20). In this case, the modulator can scan over the object in a 2D raster format to obtain a 2D high-resolution X-ray radiographic image. Similarly, to speed up the imaging process, an array of modulators forming in a 2D grid with at least 0.148-mm pitch between the modulators may be used (FIG. 21).

### Optimizing Parameters Via Computer Simulations for High-Resolution X-Ray Radiography

Computer simulations of the imaging system can be developed by a computer program to optimize both the modulator and imaging parameters. The parameters mentioned above for FIG. 23 can be used as a starting point. Using the commercial clinical X-ray imaging system, GE Discovery RF180 as an example, the focal spot size can be set to 0.6×0.7 mm² and the pitch size of the detector can be set to 0.148 mm in the simulation.

### D and 2D Modulator Arrays and Imaging Parameters

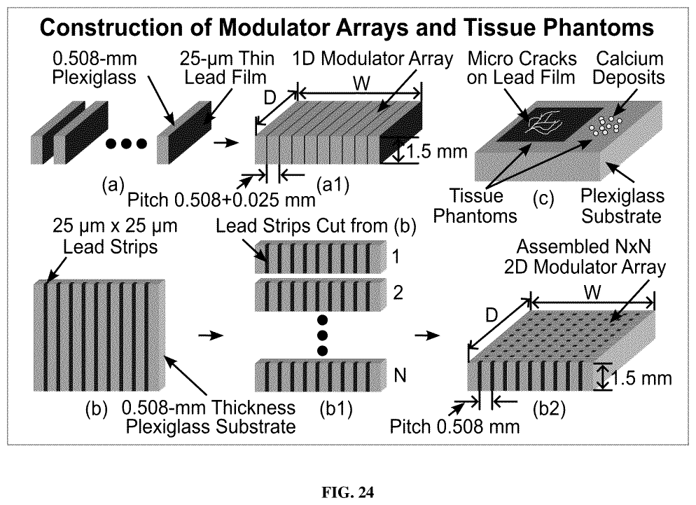

As mentioned above, to get high-resolution images, at each scanning step, images obtained with and without the modulators are subtracted and the resulting image is integrated over the resolution cell of the imaging system to simultaneously obtain multiple pixels of the high-resolution images (FIG. 21). Thus, both 1D and 2D images can be simulated, where the 1D and 2D arrays of X-ray opaque modulators can be used (see examples in FIG. 24). The dimensions (width, height, and length) of the modulators, the distance (pitch) between the modulators of the modulator arrays, the scanning step size, total scanning area, and signal integration area of each modulator can be optimized using the simulation program.

The change of image resolution with the distance between the X-ray source and the detector, the distance between the object and the detector, and the distance between the modulator and the object can also be evaluated. The modulators can be placed outside of the object, i.e., they can be placed either on the top of the object or on the bottom near the detector so that the modulators are close to the features (resolution phantoms) to be imaged. The image resolution will increase as the distance between the modulators and the object is decreased since the effects of the penumbra and scattering are reduced.

The computer simulations can maximize the image resolution while minimizing the number of scanning steps required to reduce the X-ray exposure and minimizing the noise. If only a small area in the object is of interest, a smaller modulator array can be used to zoom in the area and a collimator can be adjusted to restrict the X-ray beam to match the size of the modulator array to reduce the X-ray exposure.

### Focused Modulator Arrays

Because the X-ray beam is not in parallel unless the distance between the source to the detector is infinite, the rectangular modulators should be focused towards the X-ray source, especially for a larger modulator array that can cover a larger area. Thus, the computer simulations will also study the effects of shifting of the focus of the modulator array away from the X-ray source due to the scanning of the modulators.

Since the total scanning distance is small (a little larger than the resolution cell of the imaging system, which is about 0.148 mm or 3.4 lp/mm in the GE system above), the shift of focal spot of the modulator array should be small. If the distance between the X-ray source and detector is large enough, the modulators can be made in parallel with each other in the array, which will simplify the construction of the array. If the assumption of parallel X-ray beam is not satisfied, parallel modulator array can still be used by reducing the size of the modulator array to image a smaller area of the object (such as small tumors or microcracks of the bone) at a time and placing the modulator array near the center of the X-ray beam.

### Image Processing and Image Reconstruction

A computer program can be developed to read the raw image data from the GE system before the data obtained from the detector are automatically processed by the imaging system. The raw data will have a 16-bit digitization resolution and thus will provide a higher dynamic range, as opposed to the processed data which may not only be 12-bit but also have a random change between images due to automatic image processing, causing errors in subtracted images. An image reconstruction program can be developed to process the data. This program can include image subtraction and integration, as well as image processing techniques to reduce noise.

### X-Ray Blocking Modulator Arrays and Phantom Experiments

Using the optimized parameters obtained from the computer simulations, modulator arrays for experiments can be designed to get high-resolution images on X-ray line-pair and tissue-mimicking phantoms.

For imaging of a 1D commercial lp phantom, a 1D modulator array can be made by placing a thin lead or lead alloy sheet on a plexiglass substrate as shown in FIG. 24, (a). A 1D modulator array is easier to make. The dimensions of the 1D modulator array in FIG. 24, (a1) can be used as a starting point for the construction of the array. The width W and depth D of the modulator array depend on the size of object to be imaged. The pitch of the array and the thickness of the plexiglass substrate can be reduced to minimize the number of steps needed to get high-resolution images. The height (about 1.5 mm) of the modulator array in FIG. 24, (a1) is chosen to completely block the X-ray. The minimum pitch of the 1D modulator array should be larger than the resolution cell of the imaging system, which is about 0.148 mm or 3.4 lp/mm in the GE system above.

The moving (scanning) step size of the modulator array should not exceed the size (25 μm in FIG. 24, (a), for example) of the modulator to satisfy the Nyquist sampling rate (twice the maximum spatial frequency of about 20 lp/mm for 25-μm modulators). The total moving distance will be equal to the pitch of the modulator array (0.508+0.025 mm in FIG. 24, (a1) for example), but could be reduced to a minimum of 0.148 mm to reduce the number of scanning steps to minimize the X-ray exposure. The maximum image resolution that can be achieved will be the size of the modulator (the thickness of the lead or lead alloy film, about 25 μm or 20 lp/mm in FIG. 24, (a1)). Reducing the size of the modulator to further increase the image resolution is possible but the signal-to-noise ratio (SNR) will be reduced in addition to having an increased number of the moving steps or X-ray exposure. To make a 25 μm lead film, a 0.127-mm lead film that is commercially available will be used and compressed to the desired thickness of about 25 μm with a rolling machine (lead is soft and thus it will not be hard to be compressed).

For 2D imaging, a 2D modulator array in FIG. 24 may be used. The construction of a 2D array is similar to that of the 1D array except that lead rods, instead of films, are used. The 2D array can be constructed by depositing lead rods on a plexiglass substrate using a similar process of making the commercial line pair phantoms.

### Precision Motion System and its Control Electronics and Software

As mentioned above, to get a high-resolution X-ray radiographic image, the object should be scanned mechanically by a modulator array. Thus, a two-axis motion system can be developed using commercial linear sliders. The system can be driven by 0.9 o/step stepping motors and led screws of about 4 mm/revolution. This translates to a maximum motion resolution of about 10 m. The motion system will be controlled by a microcontroller to be programmed using the C language. Associated electronics will also be developed to drive and control the motion systems for the 1D and 2D imaging experiments with 1D and 2D modulator arrays respectively.

### Experiments and Results

In the experiments, a reference image can be taken with the GE clinical imaging system above and with a plexiglass plate that has the same thickness as the modulator array but does not include the lead modulators (blank plexiglass). A few reference images can be taken for image processing to reduce noise of the reference image. After replacing the blank plexiglass plate with a modulator array, one image can be taken at each scanning step as the modulator array scans over the object. The raw data of these images can be saved and then read by the software developed to reconstruct high-resolution images. To emulate the effects of X-ray scattering from soft tissues of human body, all the images will be obtained with three commercial water phantoms (10 mm, 40 mm, and 80 mm in thickness) that have a combined thickness of 130 mm. Using three different water phantoms allows for placing the lp or other phantoms to be imaged at different distances from the modulator array to evaluate how image resolution changes with the distance. The change of image resolution with the distance between the X-ray source and detector, the distance between the modulator array and the detector, in addition to the position of the modulator array (above the object or below the object near the detector), can also be evaluated.

In addition to commercial line-pair phantoms, phantoms that mimic micro cracks in the bone and microcalcifications in soft tissues can also be used (see FIG. 24, (c)). The phantoms in FIG. 24, (c), can be made with a lead sheet and small calcium particles. The method described herein will increase image resolution and will reduce scattering noise since subtraction of images may remove such noise, increasing image contrast.

### Conclusions

X-ray radiographic imaging accounts for the majority of more than 3.6-billions of medical diagnostic radiology examinations world wide each year and high-resolution radiographic imaging is critical to improve medical diagnoses. Although only rectangular modulators and periodical arrays of modulators are described in this example, there are many other possible choices of the shape of the modulators. Furthermore, the modulators can be randomly distributed and placed inside the object so that the modulators are close to the features to be imaged, reducing the effects of penumbra and tissue scattering. The method can also be applied to various other imaging modalities, such as, but not limited to, X-ray CT, nuclear medicine imaging, MRI, ultrasound, and optics.

### Example IV—Mobile Microscope and Bench-Top Microscope

Mobile microscopy, with its portability and multimodal capabilities, holds immense significance across healthcare, environmental monitoring, and research. It equips healthcare providers to deliver rapid diagnostics in remote areas, detecting conditions like sickle cell disease, cervical cancer, and pathogens. In environmental monitoring, it aids in on-site analysis of water quality, air pollutants, and pathogens, bolstering environmental safety. Researchers benefit from its field-ready flexibility, contributing to advancements across disciplines. Moreover, it's becoming a key tool in education. By bridging geographical and resource gaps, mobile microscopy makes critical information and analysis tools accessible where needed most, offering invaluable insights. However, mobile microscopy grapples with resolution limitations due to its compact optics, hindering its applicability in high-resolution imaging. To address this, the universal imaging technique based on point spread function (PSF) modulation described above can be utilized. By introducing a modulator that produces higher spatial frequencies in the PSF, super-resolution imaging becomes achievable, impacting mobile microscopy across various platforms, including smartphones, and extending to holography and traditional laboratory microscopes.

Although mobile microscopy holds significant importance in various fields, including healthcare, environmental monitoring, and research, due to its portability and accessibility and multimodality, which can provide a magnitude of information, its image resolution is poorer than conventional bright-field bench-top laboratory microscopes. The simple but universal super-resolution imaging technique described above can be applied to mobile microscopes to increase their spatial resolution beyond the diffraction limit of the imaging system. This allows for a low-cost, super-resolution mobile microscope with its resolution exceeding the expensive conventional bench-top laboratory microscopes. A super-resolution bench-top laboratory microscope can be developed with this method to benefit healthcare, and environmental monitoring, in addition to the advancement of biology, biochemistry, and medical sciences.

Mobile microscopy is a game-changer with its accessibility, portability, and versatility, offering a wealth of information across multiple modalities such as fluorescence, brightfield, and holography. Its impact spans critical applications in healthcare, enabling rapid disease diagnosis and treatment even in resource-limited areas, such as detecting sickle cells and cervical cancer. In environmental monitoring, mobile microscopy facilitates on-site analysis of water quality, air pollutants, and pathogens, enhancing environmental safety and public health. It empowers researchers with real-time observations and data collection in the field, driving scientific advancements. Furthermore, mobile microscopy is making educational strides. Despite these advantages, mobile microscopy does face limitations in resolution due to its compact optics. The technique based on point spread function (PSF) modulation can be used to enhance the resolution of mobile microscopes, making high-quality imaging accessible in real-world applications, including fluorescence, brightfield, and holography, revolutionizing the way we explore and interact with our environment. This method also can easily be extended beyond the mobile microscopes to other imaging methods such as the conventional bench-top laboratory microscopes to advance biomedical research.

### Imaging Beyond the Diffraction Limit

A mobile super-resolution imaging system comprising a custom designed mobile microscope equipped a light source, optical filters, and other optical components can be custom designed. The mobile microscope can incorporate electromagnetic agitators to manipulate the movement of magnetic nanoparticles introduced onto the sample under observation. The core concept of super-resolution hinges on the modulation of the point-spread-function (PSF) of the existing imaging system using ferromagnetic nanoparticles characterized by extremely high spatial frequencies. This technique allows for the retrieval of high-frequency information, effectively surpassing the conventional diffraction limit of around 100-200 nanometers. The magnetic nanoparticles can be optimized to ensure their detectability with high signal-to-noise ratio (SNR). The method can also be applied to conventional bench-top brightfield laboratory microscope to advance biomedical research. The imaging of phantoms and resolution test targets can be conducted to quantify the maximum achievable resolution.

### Experiments on Live Cells and Tissue Samples

The mobile super-resolution imaging system can undergo testing on living cells and tissues, with experiments focusing on cancer cells to investigate processes related to cell death. The system can capture high-resolution images of cell death induced by established antagonists in order to identify associated morphological characteristics. Lastly, the system can be employed to image tissues, allowing for the quantification of the highest possible achievable resolution in these complex, light scattering samples. The method will also be applied to the conventional bench-top brightfield laboratory microscope to exam both the cells and tissue samples. This technology can be applied in the examination of biopsy tissues for cancer diagnostics. Consequently, the microscopes can be used in a wide array of applications, spanning from fundamental scientific research to disease diagnosis and therapy, particularly cancers.

### Significance

Mobile microscopy holds significant importance in various fields, including healthcare, environmental monitoring, and research, due to its portability and accessibility and multimodality, which can provide a magnitude of information. Some of the commonly used modalities include fluorescence, transmission (brightfield), and interferometry (holography) based imaging. It empowers healthcare providers to bring diagnostic tools to remote or under-served areas, enabling rapid disease detection (e.g., sickle cells, cervical cancer, pathogens) and treatment in resource-limited settings. In environmental monitoring, mobile microscopy allows for on-site analysis of water quality, air pollutants, and pathogens, aiding in timely responses to environmental hazards, helping to ensure environmental safety and public health. Furthermore, mobile microscopes are gaining prominence for educational activities as well. Overall, mobile microscopy bridges geographical and resource gaps, making critical information and analysis tools readily available where they are needed most. Its versatility and mobility make it an invaluable tool.

Mobile microscopy, while offering portability and accessibility, faces certain limitations in terms of image spatial resolution. The compact and portable nature of these devices often necessitates smaller and simpler optics, which can result in lower optical resolution compared to bench-top laboratory microscopes. In most mobile microscopes, the resolution is limited to ˜1 micron. Consequently, the ability to visualize fine details in samples can be compromised. The reduced resolution severely limits their applicability for many research or diagnostic tasks that require high-resolution imaging of complex structures. These drawbacks are the primary reason that the conventional mobile microscopes are not typically used for most cell-biological applications.

Conventional super-resolution imaging techniques include STED (Stimulated Emission Depletion), PALM (Photoactivated Localization Microscopy), and STORM (Stochastic Optical Reconstruction Microscopy), use sophisticated approaches to surpass the diffraction limit of traditional light microscopy. By precisely controlling the activation and detection of fluorescent molecules, they achieve resolutions far beyond what was previously thought possible. Although these technologies have revolutionized microscopy by breaking the diffraction limit and allowing the visualization of structures and details at the nanoscale, they are very expensive and require bulky/complicated setup, making it almost impossible to implement on portable microscopes. Other less expensive commonly used techniques include pixel super-resolution, which involves enhancing the image resolution digitally by utilizing a sequence of sub-pixel shifted low-resolution images, and utilizing structured illumination, which overcomes the limitation of numerical aperture by employing a patterned light stripe to shift the object's frequency in Fourier space, improving resolution through angle rotation and phase shifting. However, all the aforementioned techniques require costly equipment, such as precision stages, for accurate movement, which makes them relatively bulky and costly. Computational approaches such as deconvolution and neural network can be used to improve the resolution, however they also have limitations. Most importantly, the parameters need to be optimized or the network retrained, depending on the sample.

This example describes a universal imaging technique for improving the resolution of mobile microscopes, based on the modulation of the point spread function (PSF) using nanoparticles. This method is simple and, unlike STED and PALM, does not require fluorescence. In the method, the PSF of a linear shift-invariant (LSI) imaging system is modulated with a modulator that has higher spatial frequency components than those of the original PSF. Because the modulated PSF contains higher spatial frequencies, super-resolution images of object using the modulated PSF can be obtained. This super-resolution technique can be applied to the mobile microscopy, particularly developed using smartphones, operating in brightfield mode first, and then extended to a bench-top brightfield laboratory microscope. This technique can also be easily extended to any other types of mobile microscopes, even the lensless digital holographic microscopes.

The creation of a groundbreaking portable mobile microscope, the first of its kind to achieve sub-200 nm resolution through Point Spread Function (PSF) modulation, is described. This device is poised to become the most cost-effective super-resolution mobile microscope ever developed, and its portability and user-friendly design will make it suitable for point-of-care or point-of-use applications. The super-resolution technique has been used with a mobile microscope, as described below, and can be extended to a conventional bench-top brightfield laboratory microscope that can be used for studying cell structures such as cell membrane at a very high image resolution.

### Preliminary Results

### Development of Portable Microscopes

Mobile microscopes using smartphones, individual CMOS imaging chips with on-board processors can be developed. They encompass modalities such as digital holography, fluorescence and brightfield, for applications ranging from detection of pathogens (viruses and bacteria), nano/micro-particles, exosomes, cancer cells and cotton fibers amongst others.

### Implementation of the Super-Resolution Approach on Ultrasound Imaging

Super-resolution imaging on ultrasound using the PSF modulation method was performed experimentally in water for both pulse echo and wave source/field imaging. The result of a pulse-echo (two-way) imaging shows that the image reconstructed has a super-resolution (0.65 mm) as compared to the diffraction limit (2.65 mm) using a 0.5-mm diameter modulator at 1.483-mm wavelength, and the signal-to-noise ratio (SNR) of the image was about 31 dB. If the minimal SNR of a “visible” image is 3, the resolution can be further increased to about 0.19 mm by decreasing the size of the modulator. Another experiment shows that a wave source was imaged (one-way) at about 30-dB SNR using the same modulator size and wavelength above. The image clearly separated two 0.5-mm (about ⅓ of the wavelength) spaced lines, which gives a 7.26-fold higher resolution than that of the diffraction limit (3.63 mm) (see FIG. 7).

### Approach

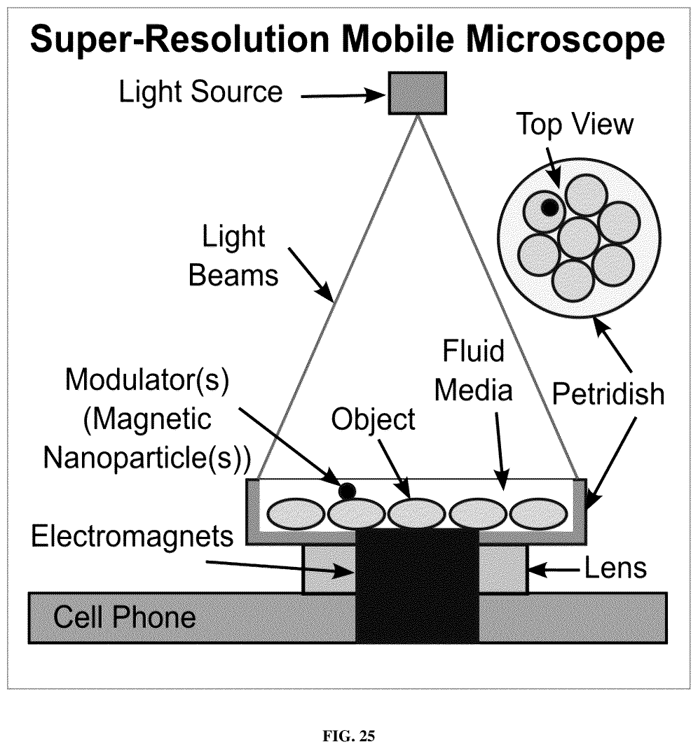

FIGS. 25-27 gave an intuitive graphical illustration of how the PSF-modulation super-resolution imaging works. FIG. 25 shows a mobile imaging system based on a cell phone, which is similar to an inverted bench-top brightfield microscope. A light source such as a light emission diode (LED) is used to illuminate objects such as cells immersed in the fluid media of a petridish. The light transmitted through the object is collected and focused with a lens system, and then sensed by the CMOS chip in a cell phone. To obtain super-resolution images, small modulator(s) can be introduced into the fluid media and placed on the top surface of the object. To move the modulator(s) along the surface of the object, two or three electromagnets can be used. The top view of the petridish also is on the top-right corner in the figure.

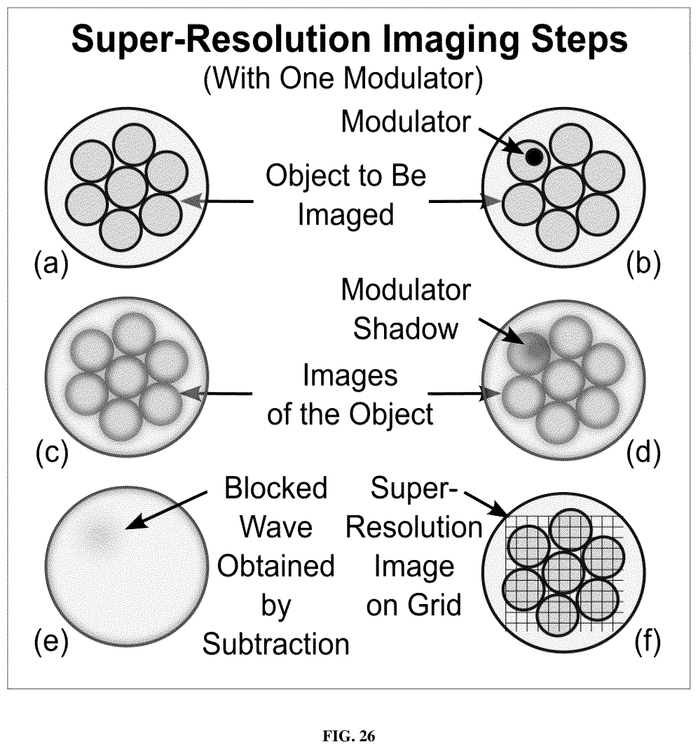

FIG. 26 shows how the super-resolution images are reconstructed using the universal PSF-modulation method and nanoparticles without fluorescence as in STED and PALM. The theoretical development and other details of the method can be found in Example I above. The steps are as follows: (1) Take a reference image (FIG. 26, (c)) of the object in FIG. 26, (a) at a conventional diffraction-limited resolution of the imaging system shown in FIG. 25, (2) Add a small modulator (see FIG. 26, (b)) that is opaque to the illuminating light to the fluid media and place the modulator on top of the object. Then take another image at the diffraction-limited resolution (see FIG. 26, (d)) (other options of the modulator to cause both amplitude and phase modulations of the light are possible). (3) Subtracting image FIG. 26, (d), from the reference image FIG. 26, (c), one obtains the image in FIG. 26, (e), that is a diffraction pattern of the part of the object that is blocked by the modulator. Localizing the center of the diffraction pattern and then assign the integration value of the light intensity within the diffraction-limited resolution cell of the imaging system to the center, one obtains a pixel of the super-resolution image in FIG. 26, (f). (4) Moving the modulator remotely by external devices such as electromagnets to the next spatial position on the object and repeating Step (3) above, another pixel of the super-resolution image can be obtained. Repeating Steps (3) and (4) above over the entire surface of the object, a super-resolution image can be obtained (FIG. 26, (f)) without needing fluorescent agents that are required for STED and PALM. If the modulator does not move to the exact positions on the image grid in FIG. 26, (f), super-resolution images on the grid can be obtained with interpolations. The maximum image resolution is determined by the size of the modulator. Theoretically, as the size of the modulator approaches to zero, the image resolution will be unlimited.

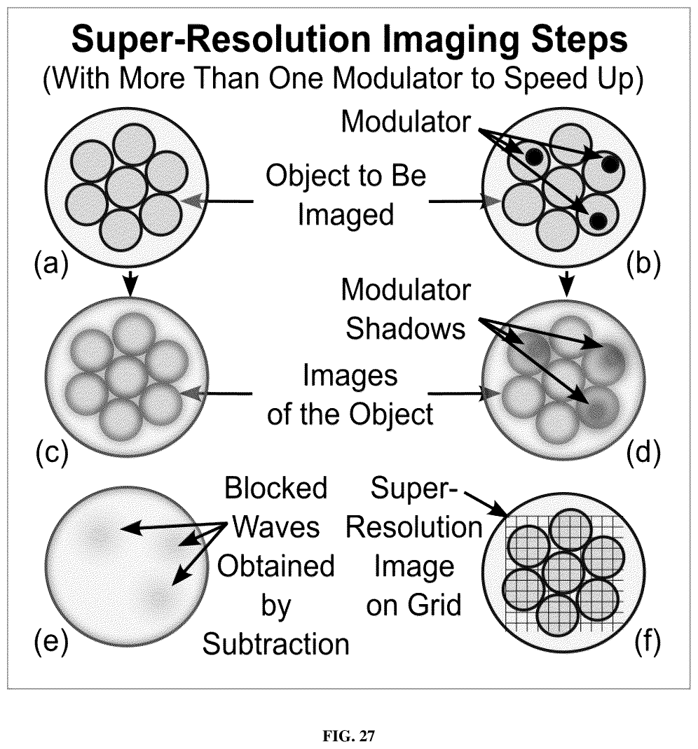

Although super-resolution images can be reconstructed using a single modulator as illustrated in FIG. 26, the imaging speed is low since the image is reconstructed pixel by pixel. To increase the imaging speed, more than one modulator can be used. An example using three modulators is given in FIG. 27. In this case, three pixels of the super-resolution image can be reconstructed simultaneously with only one image subtraction as long as the diffraction-limited images of the three modulators do not overlap, as shown in FIG. 27, (e). In this example, a very large number of randomly and sparsely distributed modulators for super-resolution imaging is used. To increase image resolution by 5-fold, about 25 images are needed to reconstruct one frame of super-resolution image. If the image frame rate of the cell phone is 30 frames/s, a super-resolution image can be reconstructed within one second. If a high-speed camera is used, a very high image frame rate can be achieved.

The method described in this example can also be applied to a conventional bench-top microscope that can be used for advanced biomedical research.

### Imaging Beyond the Diffraction Limit

In order to achieve resolution beyond the diffraction limit, the PSF is modulated as described above. To this end, magnetic nanoparticles can be used to modulate the PSF in order to produce higher spatial frequency components to reconstruct images. This can be achieved by constructing a smartphone microscope with magnetic modulating capabilities and custom designed magnetic nanoparticles.

### Development of a Portable Super-Resolution Mobile Microscope

A cost-effective handheld smartphone-based microscope can be developed for brightfield imaging, as shown in FIG. 25. The smartphone attachment can be 3D printed and contain the necessary optical components and a plate for the sample holder. An LED can be used to illuminate the sample for brightfield imaging. Electromagnets can be incorporated on sides of the sample holder. These electromagnets can be used to move the magnetic particles that modulate the point spread function.

### Optimization of Magnetic Nanoparticles

A variety of commercially available super-paramagnetic nanoparticles of different sizes can be utilized for the purpose of modulating the PSF. However, in case of low SNR or issues such as uncontrolled aggregation, these nanoparticles can be coated using polymers such as silica, polyacrylamide, or PLGA in order to precisely control the size of individual nanoparticles, as well as reduce nonspecific aggregation which may result in irregular size distribution. A polyethylene glycol coating may further be used to increase their biocompatibility. Secondly, in order to increase their optical absorption (i.e., significantly enhance their contrast), highly absorbing molecular dyes (e.g., Coomassie blue) may be incorporated into the polymer matrix of the nanoparticles. The size and uniformity of the nanoparticles may be thoroughly tested using dynamic light scattering and transmission electron microscopy, for example. The surface charge can be measured using zeta potential measurement. The extinction coefficient can be quantified using a spectrophotometer.

### Reconstruction of Super-Resolution Images

The presence of a magnetic nanoparticle on the object will temporarily block the transmitted light from the region where it is located. The depth of the blocked light depends on the size of the nanoparticles due to light diffraction by the nanoparticles. This phenomenon may encode depth information into the final super-resolution images in a way similar to that of a scanning electron microscope. The method to obtain the super-resolution images is the same as is described in the above examples (and shown in FIGS. 26-27). The motion of the nanoparticles can be adjusted to ensure that the diffraction-limited images of the nanoparticles on the CMOS sensor do not overlap and thus multiple nanoparticles can be treated individually in image processing, as is in ULM and PALM. The images acquired by the CMOS sensor array can be recorded and a C program can be developed on a Linux operating system to identify the locations of the nanoparticles and do the subtractions. After accumulating multiple subtracted images, the final super-resolution image with enough pixel density on a rectangular grid will be reconstructed (see FIG. 27, (f)).

The resolution of the imaging system can be tested using a transmission resolution target. The test targets along with the magnetic nanoparticles (in solution) with a specific size can be placed in the petridish to replace the object in FIG. 25. The electromagnets can be used to move the magnetic nanoparticles to produce enough pixels of the super-resolution images. Different concentrations of the nanoparticles can be tested so that their diffraction-limited images will not overlap on the receiver array, i.e., the nanoparticles are sparsely distributed and can be treated individually as in ULM and PALM. The motion speed of the nanoparticles can be synchronized to the image frame rate of the microscope and will be adjustable. Initially, for stationary objects, a low imaging speed can be used. After gaining experiences, the motion speed of the nanoparticles can be increased for fast imaging of dynamic objects. In order to push the boundaries of minimum achievable resolution, a wide variety of sizes of nanoparticles from 20 nm to 0.5 microns can be tested.

### Extending the Method to the Conventional Bench-Top Laboratory Brightfield Microscope

The PSF modulation method described in this example in the context of a mobile microscope can be easily extended to the conventional bench-top laboratory microscope since both the mobile and bench-top microscopes share the same optical principles. This is significant since much biomedical research is conducted using conventional bench-top laboratory microscopes but their image resolution is limited by the diffraction-limit.

### Problems and Alternate Strategy

The signal-to-noise ratio (SNR) of the PSF modulation method mainly depends on two factors, the transparency and the size of the nanoparticles. Here, nanoparticles that can block as much light (and/or change as much phase) as possible can be used. If the size of opaque nanoparticles is as large as the diffraction-limited resolution cell of the imaging system, the SNR will not be reduced since the subtraction of two images will result in the original image as if there were no nanoparticles were used. In this case, the image resolution will not be increased either. If the size of the nanoparticles becomes smaller, the image resolution will increase and the diffraction by the nanoparticles will become more prominent, and thus the difference between the two images will also become smaller, which reduces the SNR. Thus, the ultimate limit of spatial resolution achievable with the PSF-modulation method is the SNR. If a low SNR is observed, a hemispherical lens can be used to focus the light in the mobile microscope. Furthermore, the nanoparticles can be coated to produce core-shell polymer nanoparticles using metals such as gold.

### Outcome

A resolution improvement by a factor of 5 to 10 folds is possible if 200 nm to 100 nm particles are used, given about 72-dB dynamic range of a 12-bit analog-to-digital (A/D) converter of each element of the COMS sensor (for a 10-fold improvement in image resolution, in theory, a dynamic range of at least 40 dB of the A/D is needed, but in practice, it should be about 60 dB to give us a final reconstructed image of an SNR of about 20 dB). Such an improvement on the image resolution allows one to view more clearly the cell structures where the nanoparticles can reach and moved randomly by external electromagnetic forces. The reconstructed super-resolution images may include the depth information as is seen in the scanning electron microscope.

### Experiments on Live Cells and Tissue Samples

High-resolution imaging of cells is important for a comprehensive understanding of cellular structures and functions. These images provide detailed insights into subcellular organelles, molecular interactions, and cellular processes. High-resolution cell imaging is important for advancing our knowledge of diseases, enabling early diagnosis, and facilitating the development of targeted therapies. It also plays an important role in fields such as cell biology and regenerative medicine, where precise visualization of cellular details is important for research and development. Imaging tissues at high resolution is also important for a variety of applications, most notably for clearly distinguishing between cancer and non-cancer tissues in biopsy samples, amongst others.

### Cell Imaging

Live cancer cells plated on the bottom of a glass petridish can be imaged using the mobile microscope in brightfield mode by adding nanoparticles of ideal size. The rest of the experimental and image reconstruction steps can be the same as described above. Furthermore, structural changes in the cells can be introduced by adding low concentration of hydrogen peroxide. It has been previously shown that low concentration of hydrogen peroxide can cause apoptosis. The onset of apoptosis is marked by formation of small blebs and cell shrinkage. This technique can be utilized to monitor the apoptotic process in real time.

### Tissue Sample Imaging

The feasibility of using the PSF modulation technology on tissues can be tested by imaging thinly sliced fixed mammalian tissues. These tissue samples can be acquired commercially or a microtome can be used to cut porcine tissues very finely and mount them on glass. Brightfield imaging of these tissues can be acquired at very high resolution.

Comparison with Conventional Microscopy

The results of the low-cost portable mobile microscope can be validated using confocal microscopes with 100× objective. In order to validate the achievable resolution during live cell imaging, the cells can be imaged alternately using the mobile microscope and the confocal microscope in quick succession. The position of the alignment on both microscopes can be marked so that the same region of interest can be found more easily.

In addition to the mobile microscope, the super-resolution imaging method can be applied to a conventional bench-top brightfield microscope to image both cells and tissue samples. In this case, the comparison between images obtained with and without the super-resolution imaging method is relatively straightforward since the same microscope can be used for comparison and the object to be imaged does not need to be removed during the comparison.

In case of reduced contrast from the modulating nanoparticles, larger magnetic nanoparticles can be used. If this does not result in a good SNR, an alternate commercially available cell stain can be used.

Super-resolution images of the endocytosis process can be obtained. Similarly, high resolution images of tissues using both mobile and bench-top microscopes can be obtained.

The PSF modulation method allows for the capability to capture super-resolution images of live cells and various biospecimens through an affordable mobile microscope and through a bench-top microscope. This advancement renders the technology applicable across diverse domains, encompassing disease diagnostics, drug discovery, therapy monitoring, environmental surveillance, educational endeavors, and advanced biomedical research.

### Example V—Summary of Universal PSF-Modulation Super-Resolution Imaging Method

A point-spread-function (PSF) modulation super-resolution imaging method was developed. This method is based on the linear system theory, i.e., linear time-invariant (LTI) and linear shift-invariant (LSI) imaging systems. Thus, in principle, the method is universally applicable in various areas of science, engineering, and medicine where many systems are or can be approximately modeled as an LTI and LSI system.

For an object in FIG. 20, (a1), a diffraction-limited (a wide PSF due to wave diffraction) or PSF-limited (a wide PSF caused by various factors such as source, detector, and scattering, etc.) blurry image (FIG. 20, (c1)) of the object can be obtained using an LSI imaging system in FIG. 20, (b). To increase the image resolution beyond the diffraction limit, i.e., super-resolution, a small modulator can be placed on the object as in FIG. 20, (a2). The image of the object along with the modulator using the LSI imaging system in FIG. 20, (b), is shown in FIG. 20, (c2). Subtracting the image in FIG. 20, (c2), from that in FIG. 20, (c1), one obtains the difference image in FIG. 20, (d). Localizing the center of the difference image and then assigning to the center with the value of an integration of the image in FIG. 20, (d) (the integration process reduces noise), one obtains a pixel of the super-resolution image in FIG. 20(e). Placing the modulator in FIG. 20, (a2) to different positions on the object and then repeating the process above, one obtains all pixels of the super-resolution image in FIG. 20, (e). If the positions of the modulator are not on a rectangular grid of the super-resolution image in FIG. 20, (e), an interpolation can be used to obtain the final super-resolution image.

As one can see, the imaging speed with a single modulator is slow, which is a disadvantage for dynamic objects. To speed up the imaging process, multiple sparsely populated modulators can be used (an example of three modulators is given in FIG. 21. Since multiple modulators are sparsely populated, their centers can be localized individually to get multiple pixels of the super-resolution image at once using the imaging process of single modulator in FIG. 20.

Another approach to implement the universal PSF-modulation super-resolution imaging method is to fix the modulator with the PSF (FIG. 22), instead of fixing the modulator on the object during imaging (FIGS. 20-21). In this approach, a small modulator (FIG. 22, (c2)) is placed at the center of the PSF to modify the original PSF in FIG. 22, (c1). The modified PSF in FIG. 22, (c2), is then scanned over the object in FIG. 22, (a), in a raster format to obtain an image point by point (FIG. 22, (d2). Subtracting FIG. 22, (d2), from the image in FIG. 22, (d1), that is obtained with the original PSF, one obtains a super-resolution image in FIG. 22, (e). Comparing FIG. 22, (d1) with FIG. 22, (e), it is clear that with a conventional imaging method one obtains a blurry diffraction- or PSF-limited image. Notice that to reduce motion artifacts, the subtraction does not need to wait until the entire images in both FIG. 22, (d1), and FIG. 22, (d2), are obtained, it can be performed pixel by pixel, as explained in Example I above.

Unlike the PALM, ULM, and STED, the PSF-modulation super-resolution imaging method obtains an image of the object, instead of getting an image of the fluorescent molecules or microbubbles. Cells and blood vessels can be fuzzy in the images generated by PAML, ULM, or STED.

From the imaging processes above (FIGS. 20-22), it is clear that, in theory, there is no limit in the image resolution that can be achieved with the universal PSF-modulation super-resolution imaging method since the image resolution is determined by the size of the modulator instead of the original PSF. In practice, the image resolution is limited by the noise of the imaging system as explained in detail above. Also, the choice of the modulator is flexible in various applications. For example, the modulator can be used to modulate the amplitude, phase, or both amplitude and phase of the PSF.

Since the PSF-modulation super-resolution imaging method is universal, it can be applied to various disciplines of science, engineering, and medicine, including electromagnetic areas. For example, if the object in FIGS. 20-22 is an underground tunnel system and the modulators are drug dealers, weapons, or other substances, super-resolution underground radar imaging can be obtained. If the modulators are underground moles, one could build a radar system to image their tunnels in super-resolution. If one would like to map electromagnetic waves remotely in the free space at a high spatial resolution to improve an antenna design, one could use the PSF-modulation super-resolution imaging method, as described in the above examples. As mentioned above, the PSF-modulation super-resolution imaging method is applicable to any LSI systems for electromagnetic or other imaging.

Certain embodiments of the systems and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the systems and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A method for obtaining a super-resolution image of an object that is either a passive physical object or a wave object, the method comprising:
capturing a first image of an object with an imaging system without modulating a point spread function (PSF) of the imaging system unless all signals captured for the first image are zero;
capturing a second image of the object with the imaging system while the PSF of the imaging system is modulated relative to the first image through amplitude modulation, phase modulation, or both amplitude and phase modulations;
subtracting elements of the second image from elements of the first image to obtain one or more pixels of a third image of the object by localizing a center of a modulator from the subtracted image if the modulator positions are not already known, and obtaining values of the pixels of the third image with or without an integration of the subtracted image over a PSF-defined resolution cell of the imaging system corresponding to the position of the modulator, wherein the third image has a higher resolution than the first image, the second image, or both the first and second images; and
moving the modulator over, around, or inside the object to different positions, and repeating the capturing and subtracting steps after each movement to obtain all pixels of the third image of the object.

2. The method of claim 1, wherein the imaging system is a linear shift-invariant (LSI) system or an approximate LSI system, wherein the imaging system may or may not involve a wave.

3. The method of claim 1, wherein the imaging system is a photographic camera, a cellular phone camera, a laboratory microscope, a mobile microscope, a holographic imaging system, an in-line lens-less digital holographic imaging system, a capsule endoscopic camera, an endoscope, an optical coherence tomography (OCT), an optical wave mapping system, an acoustical imaging system, an ultrasound imaging system, an acoustical camera, a photoacoustic imaging system, an imaging system based on electromagnetic wave heating, a thermal imaging system, an acoustical or ultrasound wave mapping system, a non-destructive evaluation (NDE) imaging system, a sonar system, an X-ray radiography system, an X-ray fluoroscopy system, an X-ray CT system, a nuclear medicine imaging system, a gamma camera, a single-photon emission computerized tomography (SPECT) system, a positron emission tomography (PET) system, a magnetic resonance imaging (MRI) system, a terahertz imaging system, a radar system, a lidar system, an electromagnetic wave mapping system, a scanning electron microscope, a transmission electron microscope, or a PSF-weighted imaging system.

4. The method or the system of claim 1, wherein the third image is a two-dimensional (2D), three-dimensional (3D), or four-dimensional (4D) image, wherein the fourth dimension is time.

5. The method of claim 1, comprising multiplying the PSF with a modulation function that has a wider bandwidth or a higher spatial frequency than the PSF.

6. The method of claim 5, wherein the modulator is a shear wave, a phase shifter, a physical particle, or a small object.

7. The method of claim 5, wherein the modulator comprises a shear wave, a phase shifter, a metal bead, a lead bead, a tungsten bead, a gold bead, a glass bead, an encapsulated iodine bead, a polymer bead, a magnetic particle, a nanoparticle, a nanoparticle with a polymer coating, a perfluorocarbon (PFC) nanodroplet, a microbubble, a nanobubble, a quantum dot, a gas vesicle that produces a bursting sound, a fluorophore that produces a fluorescent light, a spatial light modulator (SLM), a diffractive optical element (DOE), a molecule, an atom, an ion, an electron, a semiconductor P-N junction, or a particle or small object, wherein the modulator is configured to move by a mechanical force, electrical force, magnetic force, electromagnetic force, or a radiation force.

8. The method of claim 5, wherein multiple modulators are sparsely distributed with a distance between any two modulators larger than the PSF-defined resolution cell of the imaging system.

9. A method of producing a super-resolution image using a pulse-echo system, the method comprising:
using a transducer, a sound wave source, a mechanical wave source, an electromagnetic antenna, an optical pulse source, or an optical wave source of a short optical coherence length to produce and send a first beam toward an object;
receiving the beam through the transducer, electromagnetic antenna, or an optical detector, where a reference beam may or may not be used, providing a first set of data regarding the object;
using the transducer, sound wave source, mechanical wave source, electromagnetic antenna, optical pulse source, or optical wave source of a short optical coherence length to produce and send a second beam toward the object, and the second beam is modified by a modulator;
receiving the second beam through the transducer, electromagnetic antenna, or optical detector, where the reference beam may or may not be used, providing a second set of data regarding the object, and the received second beam also is modified by the modulator;
subtracting the second set of data from the first set of data to produce a pixel of a super-resolution image; and
moving (scanning) the first beam and the second beam along with the modulator point-by-point over, around, or inside the object to different position(s), and repeating the process above after each movement to obtain a 2D, 3D, or 4D super-resolution image of the object.

10. The method of claim 9, wherein the modulator produces amplitude modulation, phase modulation, or both phase and amplitude modulations to the point spread function (PSF).

11. The method of claim 9, wherein the modulator is a shear wave, a phase shifter, a physical particle, a microbubble, a nanobubble, or a small object.

12. The method or the system of claim 9, wherein the pulse-echo system is an acoustical imaging system, ultrasound imaging system, a non-destructive evaluation (NDE) imaging system, a sonar system, a terahertz imaging system, a radar system, a lidar system, or an optical coherence tomography (OCT).

13. The method of claim 9, wherein the transducer, sound wave source, mechanical wave source, electromagnetic antenna, the optical pulse source, optical wave source of a short optical coherence length, or optical detector comprises multiple elements.

14. The method of claim 9, wherein the beams and the modulator are moved, scanned, or steered electronically, electromagnetically, magnetically, mechanically, or by a radiation force.

15. A system for obtaining a super-resolution image of a wave field, the system comprising:
a transducer, a sound wave source, a mechanical wave source, an electromagnetic wave source, or an optical wave source configured to emit waves or configured to illuminate an object;
a wave receiver configured to produce a first signal by collecting the waves emitted, and/or the waves scattered or reflected from the object unless the signal obtained is zero; and
a point spread function (PSF) modulator configured to modulate a PSF of the wave receiver to produce a second signal;
wherein subtracting the second signal from the first signal can produce a pixel of a super-resolution image of the emitted wave, and/or the scattered or reflected waves of the object; and
wherein moving or scanning the beam of the wave receiver along with the modulator point-by-point over, around, or inside the object, or inside the wave emitted, and repeating the process after each movement can produce a 2D, 3D, or 4D super-resolution image of the emitted wave, and/or the scattered or reflected waves of the object.

16. The method of claim 15, wherein the modulator produces amplitude modulation, phase modulation, or both phase and amplitude modulations to the point spread function (PSF).

17. The method of claim 15, wherein the modulator is a phase shifter, a physical particle, a microbubble, a nanobubble, or a small object.

18. The method of claim 15, wherein the system is an ultrasound wave generator, a scanning ultrasound imaging system, an acoustical wave generator, a scanning acoustic wave imaging system, a photoacoustic imaging system, an imaging system based on electromagnetic wave heating, a thermal imaging system, an electromagnetic wave generator, a scanning electromagnetic wave imaging system, an optical wave generator, a scanning optical imaging system, or a scanning electron microscope.

19. The method of claim 15, wherein the wave source and/or wave receiver comprises single or multiple elements.

20. The method of claim 15, wherein the receiver beam and the modulator are configured to be moved, scanned, or steered electronically, electromagnetically, magnetically, mechanically, or by a radiation force.
